(19) United States
(12) Patent Application Publication
(10) Pub. No.: US 2005/0090978 A1
(43) Pub. Date: Apr. 28, 2005

(54) Control and communication system and method

(75) Inventors: Zsigmond Bathory, Budapest (HU); Laszlo Repasi-Nagy, Budapest (HU)

Correspondence Address: SYNNESTVEDT & LECHNER, LLP, 2600 ARAMARK TOWER, 1101 MARKET STREET, PHILADELPHIA, PA, 191072950, US

(73) Assignee: RDS-X FEJLESZTESI ES TANACSADO KFT., Budapest (HU)

(21) Appl. No.: 10/499,775

(22) PCT Filed: Dec. 17, 2002
(86) PCT No.: PCT/HU02/00148

(30) Foreign Application Priority Data
Dec. 21, 2001 (HU) P 0105405
Feb. 8, 2002 (HU) P 02000470

(51) Int. Cl. G01C 21/26

(52) U.S. Cl. 701/213; 701/3

(57) ABSTRACT

The invention relates to a control and communication system and method for objects, the system comprising an object space-information database in an object centre of the object, the database storing an object plan for the object, wherein the control of the object is adjusted to the object plan, a regional control centre having a regional space-information database storing a regional plan, and a main control centre having a central space-information database storing a central plan. The central plan approved by the regional control centres is prepared by the main control centre, the regional plans are updated at the regional control centres on the basis of the central plan, and the object plans are updated at the object centres on the basis of the regional plans.

### TECHNICAL FIELD

The present invention relates to a control and IT (information technology) communication system, permitting the coordinated, efficient, dynamic and automatic control and tracking of objects assigned to regions, in addition to satisfying diverse IT requirements of the objects. Furthermore, the invention is also a method for achieving the objectives above to implement control.

### BACKGROUND ART

The control and IT communication support of air, water and land (road and railway) transport as well as of the objects used as independent systems in numerous walks of life raise new problems as a result of a substantial increase in traffic and due to a significant growth in the control and IT communication requirements of the above mentioned objects. An important area of development is small and large aircraft aviation, in which field a further growth can be predicted, as well as the provision of control and IT communication services for intelligent households. The air traffic control of small and large aircraft is currently based on radar control and on the simultaneous co-operation of associated support systems, as well as on radio messages sent by pilots. However, small aircraft fly mostly over undulating terrain at an altitude and in a speed range not detected by radars, and a significant number of intercontinental flights by large aircraft are outside the radar control range. Another disadvantage is that the existing radars are uncertain in detecting vehicles that fly at a low speed, and furthermore that reports from pilots are often random in time. In addition, with such a concept of control, monitoring and IT communication, it is very difficult to provide protection against eventual terrorist attacks.

Under the current conditions of air traffic control, following distances between aircraft are necessarily long, and landings and takeoffs, as a result of the time factor and due to the lack of real time monitoring and control, are critical. In the vicinity of airports, aircraft do not have a dynamic and automatic external check and monitoring (e.g. the positions of landing flaps, landing gears etc.). Similar problems arise in shipping, for example in port areas, and also in land traffic, e.g. railway transport control.

In U.S. Ser. No. 2001/0020216 A1 a device is disclosed that can be applied in traffic control using satellite based position determination, where position determination is made more accurate by an inertial transmitter. The disadvantages of this solution are that an inertial transmitter is very expensive, the relevant co-ordinate data are only known by the air crew and furthermore that each aircraft must have two of these units to ensure operational safety. Another unfavourable feature is that it does not use current, but earlier satellite data which do not provide an up-to-date and accurate result for example at landing. Precision is also heavily influenced by inertial accelerations caused by wind gusts hitting the aircraft.

A position determining system for navigating road vehicles is disclosed in U.S. Pat. No. 5,905,451. This device is based on a static co-ordinate database, which is not updated on an ongoing basis, and furthermore in this device, the road vehicles system is not built into an integrated IT network. Due to these reasons, this solution is not suitable for implementing an aircraft traffic control system.

A computerized system for automated air-traffic control is disclosed in U.S. Pat. No. 4,706,198. The system contains a master control unit and a plurality of regional control units linked to the master control unit. Aircrafts flying in a region are in communication contact with the respective regional control unit. The drawback of this known system is the lack of provisions for a dynamic plan co-ordination, approval and updating.

Currently, no universal control system is known that would be capable of real time, automatic and long-term monitoring as well as a reliable control of objects for example aircraft and/or water and/or land vehicles by complex technical and human diagnostic supervision. For example, the prior art traffic control devices were only able to provide spatial data within a narrow traffic zone, with subsequent data processing. Although the photogrammetric determination of the spatial co-ordinates of vehicles as objects already exists, it is not possible to assess them in real time and to integrate them into a traffic control system. No on-board technical and human health diagnostic device is known that can be integrated into a traffic control system for aircraft and/or water vehicles and/or land vehicles and/or staff and passengers travelling on these vehicles. Operating GSM units above a certain speed and altitude and the application of a comprehensive health information system are currently impossible. Furthermore, there is no control and communication system and process that could perform automatically, efficiently and in a coordinated way any local regional and central control and communication tasks generally arising in connection with objects, for example with the vehicles above and furthermore for example in connection with production and processing units, (parts of) buildings, business units or even persons.

### DISCLOSURE OF INVENTION

It is an object of the invention to provide a system and a method for control and communication, by which the deficiencies of the prior art monitoring systems can be eliminated, and the requirements emerging can be satisfied.

It is also an object of the invention to establish a control and information technology based communication system, which is able to integrate on an IT network level independent objects used in various fields, meeting their emerging IT based communication requirements.

Preferably for example vehicles should be enabled to be tracked in space and time in real time and on an ongoing basis, also in areas not detected by radars and not covered in GSM communication In addition, it is also required to be able to ensure the setting up of databases in connection with the operational and property safety of the objects, and with the information technology and health care requirements of persons participating in the system, and furthermore to ensure the priority access to these databases by the parties involved.

Furthermore, a dynamic route planning of vehicles must be ensured in function of the current and envisaged traffic, meteorological and technical situation, as well as making it possible to forecast dangerous traffic situations also in areas not covered by radars and by auxiliary systems operated in parallel by prognosis-based calculations. In addition, by prognosis-based calculation, the forecasting of technical and human health risks must be ensured. Preferably, passengers and staff are able to use their GSM units through an on-board telephone exchange, while retaining their own telephone numbers, along with the running of an integrated health care IT communication system. Preferably, an integrated traffic control and information technology based communication system of such kind is set up as to help to provide additional (new) information for the air, water and land crew and their control centres, and also for the objects supported.

It is a further object that through the application of a system and method according to the invention, the technical-technological and logistical utilization of airports, naval ports, traffic junctions and vehicles should become more economic, the safety of transport should be enhanced, the specific environmental load should be reduced, and furthermore that the system should be compatible with the existing information technology and traffic monitoring systems. It is a further object to provide a system which is suitable for modifying the route and the traffic parameters of the route, independently from the pilot, in vehicles prepared for this task, with special regard to flying objects.

According to a first aspect, the invention is a control and communication system comprising an object centre assigned to an object, a control centre in communication contact with the object centre, means for implementing communication between the object centre and the control centre and means providing information for controlling the object to the object centre and/or to the control centre, characterised by comprising
an object space-information database in the object centre, the database storing an object plan for the object, wherein the control of the object is adjusted to the object plan,
a regional control centre assigned to a given zone, the regional control centre having a regional space-information database storing a regional plan compiled on the basis of the object plans of the objects assigned to the regional control centre and
a main control centre capable of co-ordinating the regional plans, the main control centre being in connection with as well as organising the operation of the regional control centres, wherein the main control centre has a central space-information database storing a central plan that covers the zones,
wherein, by means of co-ordinating the regional plans forwarded from the regional control centres to the main control centre, a central plan approved by the regional control centres is prepared by the main control centre, the regional plans are updated at the regional control centres on the basis of the central plan, and the object plans are updated at the object centres on the basis of the regional plans.

By means of the system according to the invention, control and communication meeting complex requirements and the expectations mentioned above can be implemented extremely efficiently and safely.

According to a second aspect, the invention is a control and communication method for objects, wherein each object has an object centre comprising an object plan, and wherein the object plans are collected in a control centre and the control is carried out on the basis of a co-ordination of the plans via a communication contact between the objects and the control centre, characterised by comprising the steps of
compiling a regional plan in a regional control centre assigned to a given zone, on the basis of the object plans of the objects assigned to a regional control centre.
preparing a central plan covering the zones at a main control centre by coordinating the regional plans sent by the regional control centres to the main control centre, wherein the main control centre is capable of organising the operation of the regional control centres, said central plan is prepared on the basis of approvals of the regional control centres,
updating the regional plans on the basis of the central plan at the regional control centres, updating the object plans on the basis of the regional plans at the object centres and adjusting the control of the objects to the object plan.

Using the method according to the invention simple and efficient traffic control can be implemented that meets the requirements above.

### BRIEF DESCRIPTION OF DRAWINGS

Hereinafter, the invention will be described by means of preferred embodiments as shown in the drawings, where

FIG. 1 is a schematic structure of a system according to the invention and used in traffic control,

FIG. 2 is a schematic view of the visual detector and identifier unit or visual identifier unit applied in the system in FIG. 1,

FIG. 3 is a block diagram of the visual processing centre applied in the system of FIG. 1,

FIG. 4 is a block diagram of the object centre applied in the system of FIG. 1,

FIG. 5 is a block diagram of the main control centre applied in the system of FIG. 1,

FIG. 6 is a block diagram of the regional control centre applied in the system of FIG. 1,

FIG. 7 is a block diagram of the stewardess monitor applied in the system of FIG. 1, and

FIG. 8 is a block diagram of the medical centre applied in the system of FIG. 1.

### MODES FOR CARRYING OUT THE INVENTION

In the case of the preferred embodiments described by way of example below, the system and method according to the invention are used in traffic control, where the objects to be controlled are vehicles, and the plans to be implemented are traffic plans.

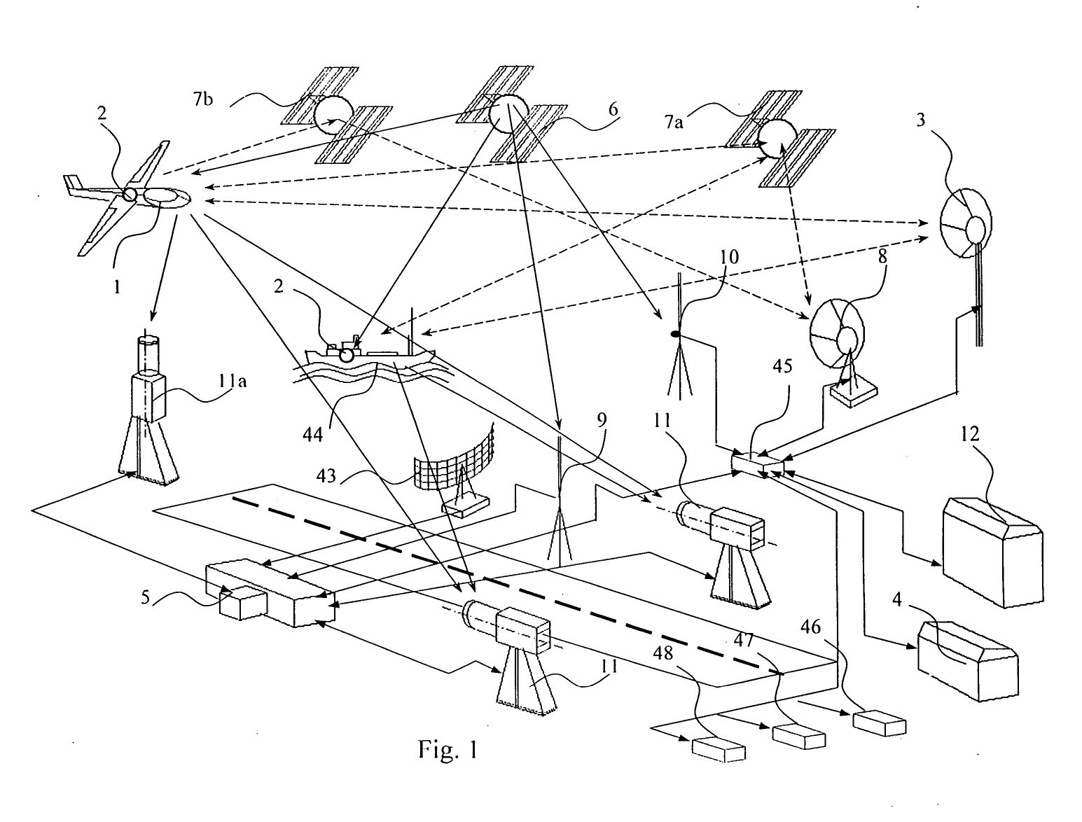

The preferred traffic control system shown by way of example in FIG. 1 performs the control of vehicles having an on-board centre as the object centre 2, for example aircraft object 1 and ship object 44. The system comprises a main control centre 12, regional control centre 4, visual processing centre 5, communication centre 45, radio re-transmitter unit 3, stationary satellite transceiver 8, re-transmitter satellite 7a, spotting satellite 7b, positioning satellite 6, regional signal improving unit 10, visual detector and identifier units II, visual identifier unit 11a, radar unit 43 and centres 46, 47 and 48 which perform various auxiliary functions. The operations of these units will be detailed below.

Visual detector and identifier unit 11 and visual identifier unit 11a

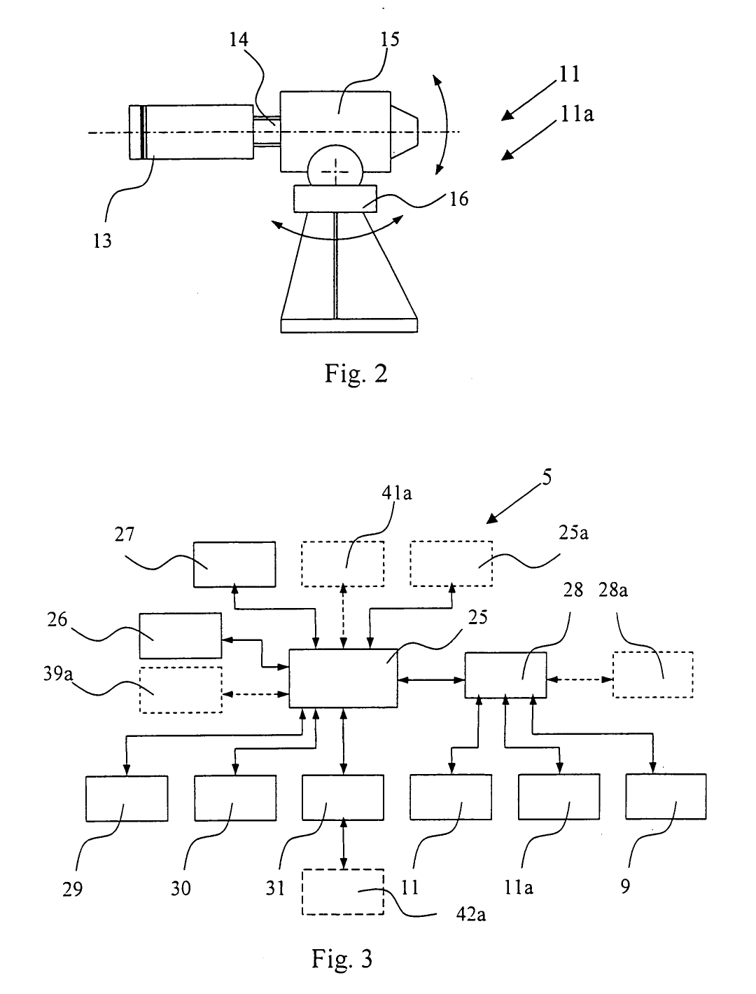

In a railway embodiment, the visual detector and identifier unit 11 shown in FIG. 2 is not part of the traffic control system according to the invention.

The structural design and the functional operations of the components in the visual detector and identifier unit 11 and in the visual identifier unit 11a are the same. The visual detector and identifier unit 11 and the visual identifier unit 11a consist of the following units: objective unit 13, objective control device 14, digital camera 15 and positioning unit 16. The units are located in an air conditioned and waterproof mechanical housing, which allows the operation of the units under all weather conditions. An integral part of the housing is a mechanical unit responsible for keeping clean and removing vapour from the objective unit 13.

The task of the objective unit 13 is to provide optical services for the digital camera 15. The objective unit 13 linked to the visual detector and identifier unit 11 is of high optical accuracy and calibrated in order to make sure that the photogrammetric measuring processes carried out by the photogrammetric unit 39 are accurate.

The tasks of the objective control device 14 comprise the conversion of the regulation command signals issued by the visual tracking unit 30 and/or the operator unit 31 and the 3D virtual studio 42a in the Nistial processing centre 5 to be described later into mechanical signals, and the application of said mechanical signals to the objective unit 13.

The digital camera 15 is an integral part of the visual detector and identifier units 11 and the visual identifier units 11a Its task is the analogue-digital conversion of the image information coming in through the objective unit 13, and to pass the relevant digital image information on to a visual processing unit 25 located in the visual processing centre 5. It is an important requirement for the digital camera 15 that in order to give a high level performance of the objective identification and photogrammetric tasks, it should have a high image resolution, and furthermore that it should have automatic focus for making more accurate the primary regulating signals of the objective control device 14.

It is the task of the positioning unit 16 to convert the positioning regulating command signals issued by the visual tracking unit 30, and the operator unit 31 and the 3D virtual studio 42a into mechanical signals, and to apply said mechanical signals to the positioning mechanisms of the visual detector and identifier units 11 and the visual identifier units 11a.

Visual Processing Centre 5

In a land implementation, the visual processing centre 5 shown in FIG. 3 does not necessarily include the radar interface unit 29 and certain units in its system can be omitted, provided that a minimum configuration is retained. Its task is to integrate the object e.g. airport, naval port, traffic junction intended to be linked with the traffic control system and to make sure that the visual monitoring tasks associated with the relevant object are tackled. The complex implementation of the visual processing centre 5 is not a necessary precondition of integrating the objects, and it is sufficient to implement a minimum configuration of the centre without visual monitoring.

The visual processing centre 5 includes a traffic zone signal improving unit 9, visual detector and identifier unit 11, visual identifier unit 11l , visual processing unit 25, visual identity code generator 25a, signal pre-processing unit 26, diagnostic unit 27, IT centre 28, radar interface unit 29, visual tracking unit 30, operator unit 31 and attached 3D virtual studio 42a and optionally visual radio transceiver 28a, visual photogrammetric unit 39a and visual satellite-based navigation compensator unit 41a.

In the given case, the units listed above are suitable for sending and receiving asynchronous messages, when the relevant object does not wait for the response after sending a message, but performs further operations, and are capable of handling ‘competition’ within the object, i.e. they can receive reports coming from a different object, while working on processing the previous one.

The minimum configuration includes only the visual identity code generator 25a, the IT centre 28, the radar interface unit 29 and the visual processing unit 25.

The task of the traffic zone signal improving unit 9 is to read the database passed on by the positioning satellites 6 within the sight of said unit, and to post the database readings in reports via the information centre 28 to the visual processing unit 25. It is installed at a dedicated geographical point of the relevant airport or naval port. Through the application of this unit, the accuracy of satellite-based position determination is significantly higher than the results provided by an uncompensated coordinated measuring process. The data vectors posted in the reports mentioned above include all the data that ensure differential satellite-based position determination (e.g. the DGPS process). The data are forwarded by the visual processing unit 25 via the information centre 28 to the satellite-based navigation compensator unit 41 operating on a regional level, where they are further processed, and then the IT unit 36 operating on a regional level posts the compensated co-ordinate data vector in a report to the object centre 2 involved. In an optional configuration, the compensation of the above mentioned uncompensated co-ordinate data vectors is performed by the visual satellite-based navigation compensator unit +1a, and then they are transferred through the IT centre 28 to the visual radio transceiver unit 28a, which performs the posting of data vectors in reports to the involved object centre 2. The operation and the design of the units 28a and 41a are identical to those of the units 28 and 41.

The visual detector and identifier unit 11 communicates digital image information to the photogrammetric unit 39 operating on a regional level and furthermore communicates digital image information to the external status monitoring unit 40 operating on a regional level. The visual detector and identifier units 11, in case they also support photogrammetric measurements and 3D intermediation, have a minimum in-pair design, at a geographic point of the traffic junction ensuring good sight.

Under the co-ordination of the visual processing unit 25, the visual detector and identifier unit 11 performs the following tasks:
On the basis of commands from the external status monitoring unit 40, until the time determined by the same, it supplies digital-based image information in a continuous mode via the IT centre 28 to the visual processing unit 25, in which data are further pre-processed and transferred through the IT centre 28 and the IT unit 36 to the regional control unit 35 and to the units under its supervision, and furthermore in an optional case to the operator unit 31 of the visual processing centre 5 and/or to the linked 3D virtual studio 42a. The commands are received by the digital camera 15 as operation mode control command signals.
It performs visual object tracking on the basis of the operation mode determination commands of the external status monitoring unit 40, the co-ordinate data supplied by the object centre 2 involved and compensated by the satellite-based navigation compensator unit 41, as well as the regulation strategy and regulation command signals elaborated by the visual tracking unit 30 after receiving said co-ordinate data. The task of object tracking is performed by the objective control device 14 and the positioning unit 16 via executing the regulation command signals.

When using human control, the parameters determining the relevant task are sent by the operator unit 31 and the attached 3D virtual studio 42a, respectively, via the visual processing unit 25 and the IT centre 28 to the photogrammetric unit 39 and the external status monitoring unit 40, respectively, where the tasks prescribed are carried out.

If necessary, the visual detector and identifier unit 11 provides digital image information to the visual photogrammetric unit 39a.

Optionally, the visual detector and identifier unit 11 performs the following tasks under the co-ordination of the visual processing unit 25:
On the basis of the commands from the operator unit 31 and the attached 3D virtual studio 42a, respectively until the time determined there, in a continuous mode of operation it forwards the digital-based image information through the IT centre 28 to the visual processing unit 25, where the data are further processed and transferred via the IT centre 28 and the IT unit 36 to the regional control unit 35 and the operator unit 31 and the attached 3D virtual studio 42a. The commands reach the digital camera 15 as operation mode control command signals.
It carries out visual object tracking on the basis of the mode of operation mode determination commands of the operator unit 31 and the attached 3D virtual studio 42a as well as the co-ordinate data provided by the object centre 2 involved and compensated by the visual satellite-based navigation compensator unit 41a and furthermore on the basis of the regulation strategy and regulation command signals elaborated by the visual tracking unit 30 after receiving said co-ordinate data. The task of object tracking is performed by the objective control device 14 and the positioning unit 16 via executing the regulation command signals.

If necessary, two visual detector and identifier units 11 can be combined into one single system. In this case, the two units can be located in a common housing, where the positioning unit 16 provides a joint position adjustment in a joint configuration and the objective control devices 14 of the digital cameras 15 installed are fitted with control separately in a parallel way or even jointly. In this set-up, the combined pair, as a stereo digital workstation, is suitable in itself for providing a digital image support function for photogrammetric measurements and 3D broadcasts.

The task of the visual identifier unit 1 la is to communicate digital-based image information under the coordination of the visual processing unit 25 to the external status monitoring unit 40 of the regional control centre 4. The task system of the unit is identical to that of the visual detector and identifier unit 11, but the subsequent image processing tasks of the digital images provided by it are associated with the identification of the objects and with the external status monitoring tasks. In a minimum configuration, the visual processing centre 5 preferably includes also one visual identifier unit 11a. The visual processing unit 25 is the central unit of the visual processing centre 5. Its basic task is supervising the supervision of the work of the units within its system, the co-ordination and organisation of the IT communication among the relevant units, and furthermore the regional level integration of the task systems and IT requirements of the units under its supervision into the task system and IT communication scheme of the regional control centre 4 representing the regional level. The performance of this task is supervised and co-ordinated by the regional control unit 35.

The units working under the supervision of the visual processing unit 25 are software-hardware systems suitable for simultaneous data processing. The operation of the relevant software-hardware systems can be modelled or substituted by a software package prepared for the given task system. It is possible to elaborate a modification, in which the traffic zone signal improving unit 9 and/or the visual processing unit 25 and/or die visual identity code generator 25a and/or the signal pre-processing unit 26 and/or the diagnostic unit 27 and/or the IT centre 28 and/or the visual tracking unit 30 are integrated under the software system of the visual processing unit 25 via the software package which models or substitutes the associated task system.

The visual processing unit 25 performs the preparation and editing of the reports required for work and information transport between the units under its supervision and in connection with the co-operative work and information transport between itself and the regional control unit 35. The information flow between the visual processing unit 25 and the regional control unit 35 is carried out in the form of reports (electronic documents) through the IT centre 28 and die IT unit 36. If necessary, the information flow between the visual processing unit 25 and the object centres 2 is handled in the form of reports (electronic documents) through the visual radio transceiver 28a, the radio transceiver 19 and the satellite radio transceiver 20a. Editing and compiling the relevant document packages are the task of the visual processing unit 25. The distribution of reports is carried out on the basis of the optimal distribution strategy determined by the regional control unit 35. Prior to posting, the visual processing unit 25 applies a data compression and encrypting process in accordance with the type of the database to be posted to the relevant electronic document, and then instructs the visual identity code generator 25a to generate a digital signature associated to the relevant electronic document.

The report of the electronic document belonging to the visual processing centre 5 and the actual database to be posted include among other things the digital signature prepared by the visual identity code generator 25a and the public key associated to the visual processing centre 5 (the public key is the identification code of the relevant visual processing centre 5), the name of compressing processes applied to the similar partial databases of the relevant electronic document's database and the extent of compressing, the name of encrypting process applied to the relevant electronic document, the uniform times of the traffic control system indicating the loading time of partial databases belonging to the similar partial databases of the database, and the compressed and encrypted document.

If necessary, the visual processing unit 25 performs the determination of the primary level light/picture imaging spectrum parameter and magnification parameter vectors of the digital images provided by the visual detector and identifier units 11 and the visual identifier unit 11a, and then said vectors are posted to the signal pre-processing unit 26 which performs the preparation of digital picture imaging. The logical order of the relevant task is identical with the process performed by the regional control unit 35.

If necessary, the visual processing unit 25 generates the dynamic database of the unbalanced co-ordinate data of the object centres 2 in the traffic zone, and then posts it for compensation to the visual satellite-based navigation compensator unit 41a. After compensating the co-ordinate database, the visual satellite-based navigation compensator unit 41a re-writes the compensated database into the above mentioned database. From the uncompensated and/or compensated co-ordinate database, the visual processing unit 25 produces the timeline prognosis of co-ordinate figures in an object centre 2 specific way, and stores it in a mathematically continuous model.

The visual processing unit 25 performs the uniform digital clock signal adjustment of the traffic control system mentioned above. The calibrating clock signal is received from the regional control unit 35 of the regional control centre 4 responsible for the relevant traffic zone, and if necessary, with a No. 1 priority, it is generated by the visual satellite based navigation compensator unit 41a, relying on the measurements of the traffic zone signal improving unit 9. The calibration procedure is carried out in both cases in a continuous operation mode, at discrete times.

The visual identity code generator 25a is a task-specific periphery, the operation of which is co-ordinated by the visual processing unit 25. Its setting up and fitting to the visual processing unit 25 are optional, if the encrypting and coding procedures applied by the visual processing unit 25 are considered to be sufficient. The visual processing unit 25 compiles in substance and prepares the material of the actual report for the co-operative work and information transport between itself and the regional control unit 35. In the next phase, upon the instructions of the visual processing unit 25, the visual identity code generator 25a prepares the digital signature of the compiled and prepared reports. The reports so signed can be considered to be ready, and they can be posted by the IT centre 28. In the above mentioned optional case, when there is no public key, the identification code of the visual processing centre 5 is the code series considered to be authentic by the traffic control system and stored by the visual processing unit 25. In this case, when posting the electronic documents, the above mentioned authentic code series will be attached to the document by the visual processing unit 25.

It is the task of the signal pre-processing unit 26 to prepare the serving of the external status monitoring unit 40 working under the supervision of the regional control unit 35, i.e. to improve the picture quality of the digital image information supplied by the visual detector and identifier units 11 and the visual identifier unit 11a, as well as to characterise the quality of improved digital pictures. The regional level co-ordination of the tasks is carried out by the external status monitoring unit 40. Tie digital image information sent to the unit is provided by the visual detector and identifier units 11 and by the visual identifier unit 11a, while their work is coordinated by the visual tracking unit 30 and the external status monitoring unit 40. If necessary, it is given the task to prepare the serving of the visual photogrammetric unit 39a working under the supervision of the visual processing unit 25 and that of the 3D virtual studio 42a, i.e. to improve the picture quality of the digital image information provided by the visual detector and identifier units 11, as well as to characterise the quality of the improved digital images. The visual processing centre 5 level co-ordination of the tasks is performed by the visual processing unit 25 and the visual tracking unit 30.

In the course of its operation, in the first step, the signal pre-processing unit 26 receives the first level light/picture imaging spectrum and magnification parameter vectors provided by the regional control unit 35, where if necessary the relevant vector is prepared by the visual processing unit 25, and receives furthermore the discrete time digital image information provided by the visual detector and identifier units 11 and the visual identifier unit 11a. In the second step, it subjects the digital pictures supplied by the visual detector and identifier units 11 and the visual identifier unit 11a to a quality test The determined picture quality parameter is attached in a report for the external status monitoring unit 40. In the third step, on the basis of the result of the previous test, the actual light conditions and the prescribed task, it determines the system of picture improving procedures to be applied to the relevant digital images, and their determining parameters, and furthermore, by making use of the first level light/picture imaging spectrum parameter, the light/picture imaging spectrum parameter vector of imaging. Digital images are supplied to the external status monitoring unit 40, the photogrammetric unit 39 and the visual photogrammetric unit 39a in a parallel way, by digital picture databases that have different magnifications and fall into the infra range. The various infra ranges are determined by the light/picture imaging spectrum parameter vector, while the extent of magnifications to be applied to digital images screened for different infra ranges is determined by the magnification vector. In the fourth step, the system of parameters and processes determined in the third step is applied to the received digital images. And finally, in the fifth step, the prepared digital pictures are forwarded to the visual processing unit 25. The visual processing unit 25 passes on the digitally signed image information to the regional control unit 35, which posts it to the external status monitoring unit 40.

When applying the visual photogrammetric unit 39a, and furthermore when human control prevails, the process logic is identical with that of the process described above. In the course of operation, in the first step the signal pre-processing unit 26 receives the first level light/picture imaging spectrum parameter provided by the visual processing unit 25, along with the discrete time digital image information provided by the visual detector and identifier units 11 and the visual identifier unit 1 la. In the second step, it subjects the digital pictures provided by the visual detector and identifier units 11 and the visual identifier unit 11a to a quality test. In the third step, on the basis of the result of the previous test, it determines the system of picture improving processes to be applied to the relevant digital images and their determining parameters, as well as the light/picture imaging spectrum parameter of the applied picture imaging by making use of the first level light/picture imaging spectrum parameter. In the fourth step, a system of parameters and processes determined in the third step is applied for the digital images received. And finally, in the fifth step, the prepared digital images are forwarded to the visual photogrammetric unit 39a and the 3D virtual studio 42a.

It is the task of the diagnostic unit 27 to check and supervise the operation and operational quality of the visual processing centre 5, relying on the diagnostic reports of the regional diagnostic unit 35a and on the parameters set on the platform of the operator unit 31, and based on diagnostic procedures carried out at discrete times on the basis of pre-adjusted parameters. In the case of a basic configuration, the units subjected to a diagnostic process are as follows: the traffic zone signal improving unit 9, the visual detector and identifier unit 11, the visual identifier unit 11a, the visual processing unit 25, the visual identity code generator 25a the signal pre-processing unit 26, the IT centre 28, the radar interface unit 29, and the visual tracking unit 30. The system of diagnostic procedures, diagnostic qualifications and diagnostic reports is identical with the description to follow later on in reference to the on-board diagnostic unit 17a of the object centre 2.

If during the operation of the diagnostic unit 27, the diagnostic result of a unit diagnosed by it is qualified as unsatisfactory, the diagnostic unit 27 performs diagnostic final qualification tests relying on a customised diagnostic strategy made on the basis of the result of diagnostic procedures performed by the diagnostic unit 35a and the diagnostic unit 27, the diagnostic procedure programmed package installed in the system of the relevant diagnostic unit 27 and the computer technology resources available to the relevant diagnostic unit 27. Throughout this specification, under the term “customised” we understand that the given unit or function is designed according to the relevant conditions and needs.

The relevant optional diagnostic test may also be carried out upon the instructions of the regional diagnostic unit 35a, by the diagnostic unit 27.

The tasks of the IT centre 28 comprises the establishing of a regional contact through the IT unit 36 between the visual processing centre 5 and the regional control unit 35, a local contact, if necessary, through the visual radio transceiver 28a between the visual processing centre 5 and the object centres 2, and a direct IT contact between the visual processing unit 25 and the visual detector and identifier unit 11, as well as the visual identifier unit 11a. An IT communication is established on a terrestrial basis between the IT centre 28 and the IT unit 36 and/or an IT contact is established via the visual radio transceiver 28a and/or via the communication centre 45 and the stationary satellite-based transceiver 8. The operation of the IT centre 28 is coordinated by the visual processing unit 25.

The task of the radar interface unit 29 is the supervision of the visual processing centre 5 and the informatic integration of the simultaneously operating radar unit into the traffic control system. The interface unit performs digital conversion of the information provided by the relevant radar unit, if the relevant radar is not prepared for forwarding the information in a digital form, and fits the already digitised information via the visual processing unit 25 to the traffic control system.

The visual tracking unit 30 performs the visual tracking of a given vehicle in the case of using the regional control unit 35 and/or manual control on the basis of a decision taken by the 3D virtual studio 42a. The decision is made in an automatic way in the first described case or on the basis of requests received from the IT network linked to the traffic control system, respectively. In the automatic case and in the case of requests coming from the IT network, the regional control unit 35 informs the actual visual processing centre 5 in a report.

It is among the tasks of the visual tracking unit 30 to co-ordinate the visual tracking of an object identified by the regional control unit 35 and/or the 3D virtual studio 42a and/or the requests received from the IT network, as well as to co-ordinate the digital image sampling of a traffic object, and to co-ordinate the visual object detection process. These tasks are performed by the visual detector and identifier units 11 and the visual identifier units 11a under its supervision. The image information received is further processed in the signal pre-processing unit 26 and in the visual processing unit 25.

The database of the visual tracking unit 30 includes
the regulation technology database of the positioning unit 16 of the visual detector and identifier unit 11 working under the supervision of the visual processing centre 5, and the regulation technology database of the objective control device 14;
the regulation technology database of the positioning unit 16 of the visual detector and identifier unit 11a working under the supervision of the visual processing centre 5 and the regulation technology database of the objective control device 14;
the mathematical model of the digital image sampling strategy of the visual object. (The relevant mathematical model is based on a fuzzy logic. It provides response to the number of image sampling operations to be applied within unit time, to the sequence of light/picture imaging spectra to be applied and to its application period while taking into consideration the relevant light conditions, and the speed of the object to be tracked, as well as the type of the object, if this is known) and
the mathematical model of the strategy concerning the digital image detection process of the visual object. (The relevant mathematical model is based on a fuzzy logic. The relevant task specifically comprises a mathematical model of the digital image sampling strategy of the visual object, and the mathematical models concerning the objective control devices 14 and the positioning units 16 of the visual detector and identifier units 11 and the visual identifier units 11a).

For the object tracking and sampling tasks, the substance of the report provided or produced by the regional control unit 35 and/or the 3D virtual studio 42a and/or the requests coming from the IT network is the following:
Orders to perform the relevant task.
A system of vehicles located in the visual monitoring zone of the relevant visual processing centre 5. i.e. the vehicles assigned to the relevant task.
A system of parameters identified during the first-level modelling of the visual tracking task, in connection with the vehicles assigned to the relevant task.
The actual (compensated) co-ordinate data of the vehicles assigned to the given task and a prognosis of the coordinate data timeline. (In an optional case it is generated by the visual processing unit 25).

The report drawn up by the signal pre-processing unit furthermore includes the image quality parameter determined, which is used as a regulation parameter.

In the course of the visual tracking unit 30 operations associated with object tracking, in the first step on the basis of the requests coming from the regional control unit 35 and/or the 3D virtual studio 42a and/or the IT network, of the reports coming from the signal pre-processing unit 26, of the compensated co-ordinate and speed co-ordinate timeline coming from the regional control unit 35 and the associated co-ordinate prognosis reports, and ,if necessary, of the support by the visual satellite-based navigation compensator unit 41a, and of its own database, it models the regulation technology operation of the regulation technology operation of positioning units 16 carrying out the visual tracking task of the visual detector and identifier units 11 and the visual identifier units 11a assigned to perform the task and models the regulation technology operation of the objective control devices 14 as well. In the second step, on the basis of the given mathematical models, it performs the regulation of units and control devices under its supervision.

In the course of the digital image sampling co-ordination of the visual tracking unit 30, in the first step on the basis of the report received from the regional control unit 35 and from the signal pre-processing unit 26, of the compensated co-ordinate from the regional control unit 35 and the speed co-ordinate timeline as well as the associated co-ordinate prognosis reports, if necessary, of the support by the visual satellite-based navigation compensator unit 41a, and of its own database, it models the regulation technology operation of the regulation technology operation of positioning units 16 carrying out the image sampling task of the visual detector and identifier units 11 and the visual identifier units 11a assigned to perform the task and models the regulation technology operation of the objective control devices 14. In the second step, on the basis of the given mathematical models, it performs the regulation of the units and control devices under its supervision.

In the course of coordinating the visual detection procedure, the visual tracking unit 30, in the first step on the basis of the reports received from the regional control unit 35 and the signal pre-processing unit 26 and of its own database, selects the appropriate one from the relevant models in the database of the visual tracking unit 30 by using a fuzzy logic, and models the regulation technology operation of the positioning units 16 carrying out the image sampling of the visual detector and identifier units 11 assigned to perform the task, and models the regulation technology operation of the objective control devices 14. In the second step, on the basis of the given mathematical models, it performs the regulation of the units and control devices under its supervision. Launching of the detection process can take place on request from the workstation attached to the traffic control system, from the operator unit 31 and from the 3D virtual studio 42a ,or in an automatic way at discrete times, in a quasi-continuous mode of operation.

The task of the visual radio transceiver 28a is to create a radio technology based IT contact through the visual processing unit 25 and/or the IT unit 36, between the regional control unit 35 and/or the object centres 2 in the traffic zone. Its work and the electronic documents to be posted are controlled and forwarded to it by the visual processing unit 25.

The task of the visual photogrammetric unit 39a is to determine, by using a photogrammetric method, the co-ordinate positions of the objects detected by the visual tracking unit 30. Its application is optional, and its operation is logically identical with that of the regional space-information unit 37 on regional level.

During its operation, images digitally prepared by the signal pre-processing unit 26 and associated with the objects detected by the visual tracking unit 30 and the 3D virtual studio 42a are supplied to the given unit. On the basis of the joint activity of the 3D virtual studio 42a and the visual photogrammetric unit 39a, the wanted coordinate vectors are determined in the visual photogrammetric unit 39a , based on a photogrammetric procedure applied there.

The visual satellite-based navigation compensator unit 41a performs primarily the compensating calculation of the uncompensated co-ordinate data supplied by the object centres 2 of the traffic zone belonging to the visual processing centre 5, and secondarily, by making use of the measuring signals of the traffic zone signal improving unit 9, it provides a uniform GPS-based time involving the visual processing centre 5. The existence of the unit is optional, and its operation logic is identical with that of the satellite-based navigation compensator unit 41 on a regional level.

The task of the operator unit 31 is to ensure the manual control and manually controlled IT communication of the visual processing centre 5. The performing of the relevant tasks is ensured by the communication, data processing and/or database handling programmed running in the system of the visual processing unit 25. When the relevant visual processing centre 5 is of temporary installation, a portable computer and its interface serve for handling the given auxiliary tasks. The 3D virtual studio 42a can also be linked to the operator unit 31. This studio is responsible for the 3D presentation of the vehicles in the traffic zone for the operator.

Object Centre 2

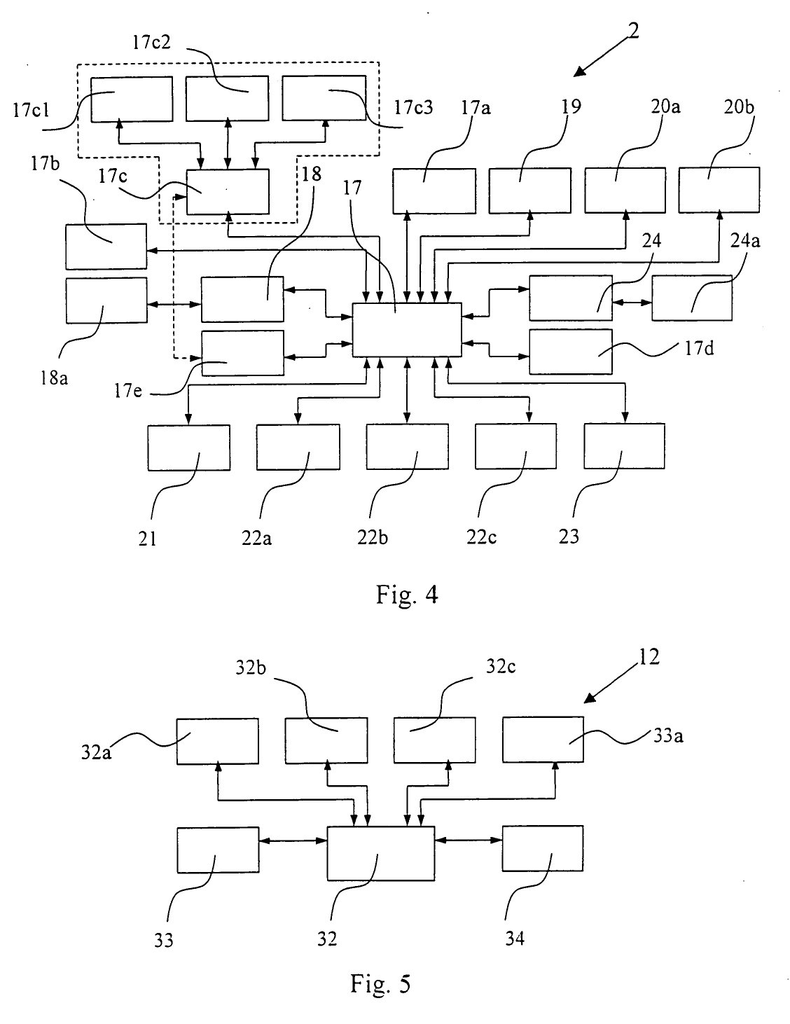

The basic function of the object centre shown in FIG. 4 is to create a wide ranging monitoring and control test opportunity covering aircraft, ships, railway and road vehicles, and furthermore to integrate the relevant vehicles into one IT communication network. Setting up or installing the units in its system can be omitted, with retaining the minimum configuration. The object centres 2 are installed on-board an aircraft, ship and motor vehicle, while in the case of railway implementation they are fitted on the locomotive. When handling transportllogistics problems, they are to be fitted on the transported containers and packages or on the vehicle (e.g. a railway carriage) which transports the relevant consignment An important characteristic is the handling of problems relative to IT communication in connection with transport, logistics the items above. If necessary it is indispensable to establish a link between the object centre 2 of the consignment and the object centre 2 of the container or wagon carrying the consignment. The problems arise from the fact that the container or wagon carrying the consignment shields the GSM and/or GPS communication.

The object centre 2 of minimum configuration suitable for transport and logistics tasks includes the processing unit 17, the satellite-based navigation receiver 18 and the radio transceiver 19.

If necessary, the object centre 2 of the container or wagon carrying the consignment plays the role of a local regional centre. In case the GSM communication and/or GPS communication of the object centre 2 of the consignment is interrupted, it attempts to take up communication automatically by wire or even radio technology, if necessary by bluetooth technology, with the object centre 2 of the consignment-carrier container or wagon playing a master role. In the second step, after establishing the IT contact, the object centre 2 of the consignment issues a report to the master object centre 2 about the identifier code of the consignment, and about the IT communication service supporting the consignment, i.e. it describes what should be reported to whom and when. In the third step, the master object centre 2 issues a report to the regional control unit 35 about the system of object centres 2 taken under its supervision and about having taken over the supervision.

After that the reports and/or instructions sent from the traffic control system for object centre 2 of the consignment taken into the supervision of a master object centre 2 are received from the traffic control system through the master object centre 2 and the reports prepared by the object centre 2 of the consignment and intended to be posted to the regional control unit 35 reach the target station through the master object centre 2, which sends on its co-ordinate data readings as the co-ordinate data of the consignments under its supervision.

If the object centre 2 of the consignment succeeds in establishing an IT contact with the GSM and GPS network (e.g. unloading has taken place), it leaves the supervision of the master object centre 2 (by preparing a withdrawal report for the master object centre 2 and posting it via the IT contact established between them) and executes again the protocol of registering with the traffic control system.

The operation of the system is assisted by a task-specific system programmed installed on the processing unit 17.

The object centre 2 consists of the following units: processing unit 17, on-board diagnostic unit 17a, space-information unit 17b, on-board health care centre 17c, ECG expert subassembly 17c1, foetus monitoring expert subassembly 17c2, EEG expert subassembly 17c3, stewardess monitor 17c, on-board voice generator 17d, satellite-based navigation receiver 18, radio transceiver 19, satellite radio transceiver 20a, satellite coordinate transmitter 20b, identity code generator 21, operator unit 23, on-board telephone exchange 24, vehicle diagnostic unit 22a, autopilot coupling unit 22b, and data acquisition unit 22c of the vehicle.

If necessary, the units listed above are suitable for sending and receiving asynchronous messages, when the relevant object does not wait for the response after sending out a message, but performs further operations, and are also capable of handling competition within the object, i.e. they can receive reports from a different object, while working on processing the previous one.

The object 1 implemented as an aircraft by way of example has its own systems linked to the traffic control system according to the invention, which systems are the diagnostic unit 22a the autopilot, and the data acquisition unit 22c, but the definitions of these systems can naturally be extended to all vehicles as well.

The processing unit 17 is the central unit of the object centre 2. Its task system is the following:
Co-ordinating the activities of the units making up the object centre 2, and organising the IT communication among them.
Maintaining IT communication with the traffic control system, for example the IT centre 28, the IT centre 32b, the IT unit 36 and the processing units 17 of other vehicles, and forwarding the instructions, commands and databases received from there to the object centre 2 unit addressed.
Editing the reports i.e. electronic documents considered as the basic unit of IT communication.

The units working under the supervision of the processing unit 17 are software-hardware systems suitable for parallel data processing. The operations of the relevant software-hardware systems can be modelled or substituted by a software package prepared for the relevant task system. It is possible to elaborate a modification, in which the on-board diagnostic unit 17a and/or the space-information unit 17b and/or the on-board health care centre 17c and its expert subassemblies and/or the on-board voice generator 17d and/or the satellite-based navigation receiver 18 and/or the identity code generator 21 and/or the diagnostic unit 22a and/or the data acquisition unit 22c are integrated under the software system of the processing unit 17 via a software package which models or substitutes the associated task system.

The information flow between the object centre 2 and the IT centre 28, the IT centre 32b, the IT unit 36, the processing unit 17 of the other object centre 2 and the regional control unit 35 of the regional control centre 4 takes place in the form of reports (electronic documents). The processing unit 17 is responsible for editing and compiling the relevant document packages for the regional control unit 35.

Regarding the compiled electronic document, the processing unit 17 performs the following preparation tasks prior to posting:
Breaking down to partial electronic documents as planned by the regional control unit 35, which process if necessary is an element of the optional communication strategy co-ordinated regionally.
The application of a data compressing procedure, to the partial electronic documents.
The application of an encrypting process to the partial electronic documents.
Instruction of the identity code generator 21 to generate a digital signature associated with the partial electronic documents.

The substance of the report associated with the relevant electronic document comprises the following
The digital signature and the public key belonging to the object centre 2.
The identifier of the compressing procedure applied for the relevant electronic document and the extent of compressing.
The identifier of the encrypting procedure applied for the relevant electronic document.
The compressed and encrypted document itself.

The report associated with the relevant electronic documents is transferred by the processing unit 17 to the radios of the object centre 2 for posting, in a way corresponding to the optimal communication strategy compiled by the regional control unit 35.

Such a posted document can be, for example, the electronic document for registration, which is a request from the vehicle associated with the relevant object centre 2 for being integrated into the traffic control system. The electronic document for registration includes a request for integrating the route plan of the relevant vehicle as an object plan into the regional traffic plan as a regional plan (if the given traffic plan has not yet been integrated into the regional traffic plan system, the plan itself is featured; it is automatically requested by the regional control unit 35), the system of databases of the space-information unit 17b waiting for an updating oriented loading, and furthermore information of the traffic control system, primarily the regional control unit 35 and the control device 32, about the resources of the given object centre 2 and about the technical and technological specifics of the related vehicle. These resources and specifics are the following: the system of diagnostic procedures available to the on-board diagnostic unit 17a and the computer capacity, the system of diagnostic procedures available to the diagnostic unit 22a of the vehicle and the computer capacity, the system of data compressing and data encrypting procedures available to the processing centre 17, the substance of the dynamic database in the space-information database of the space-information unit 17b and furthermore the technical-technological data of the radio technology facilities available to the processing centre 17.

Handled by the object centre 2, several complex tasks are resolved. Complexity means that the relevant task is jointly tackled by a given partial group of the units making up the object centre 2. In this case the activity of the processing unit 17 consists in organising the flow of databases and reports necessary for resolving the relevant task and preparing the reports in an appropriate format.

The object centre 2 performs the automatic updating oriented loading of the quasi-dynamic space-information database of the space-information unit 17b, which means the following. The static database of objects hazardous to traffic, of limited and prohibited air spaces and traffic zones, as well as the meteorological maps are in the space-information database of the space-information unit 17b of the on-board object centre 2, and the actual data are in the central database 34 of the main control centre 12. The updating oriented loading procedure is carried out automatically after registering with the traffic control system and following the integration of the route plan, under co-ordination from the regional control unit 35. Therefore, the system of above mentioned objects and plans appears with their actual parameters after that the updating process has been completed.

The updating process is the following.

In the first step the regional control unit 35, after having integrated the given object centre 2 into the traffic control system, requests a report automatically from the processing unit 17 of the object centre 2 about the dynamic maps already installed in the space-information database of the space-information unit 17b of the on-board system and about the database of hazardous objects, limited and prohibited air spaces and traffic zones. In the second step, the space-information unit 17b prepares the desired report, and then the processing unit 17 forwards it to the regional control unit 35 via the radio transceiver 19 and/or the satellite radio transceiver 20a and the IT unit 36. The reports include the parameter vectors unambiguously characterising the related databases. In the third step, the regional space-information unit 37 compiles the report of the requested database, and in the form of a report, the regional control unit 35 informs the relevant vehicle, along the IT access route of the linked object centre 2, while maintaining the optimal communication strategy, about the updated database. In the fourth step, the space-information unit 17b of the addressed vehicle integrates the relevant updated database into its own database. The space-information database of the space-information unit 17b is called an object space-information database.

By means of the operator unit 23, different requests can be addressed to the traffic control system, for example requests for displaying various geographic and flight maps, a request for displaying the current transport situation of an arbitrary traffic zone, a request for displaying the traffic plan system of an arbitrary traffic zone, a request for displaying the current and forecast meteorological situation of an arbitrary geographic area, requests for compiling and retrieving a traffic information database handled in the traffic control system, and a request for displaying the traffic junction of an arbitrary traffic zone, for example airports and naval ports.

The edition of requests for the relevant tasks and the requested databases is carried out by a flight plan and request editing programmed compatible with the traffic control system. The programmed is installed in the processing unit 17. The reports (electronic documents) containing the applications are forwarded by the processing unit 17 to the units that compile the requested databases.

The relevant task can be performed without making any request to the regional control centre 4, even when the above mentioned databases and database handling units are set up independently, regardless of the traffic system. In the given case, the requesting object centre 2 performs direct search through the involved database and database handling units, and furthermore via the units handling the IT communication available to it Applying for, compiling and communicating the databases have the same logic as the approach used in the traffic control system, and editing an application for the relevant tasks and the requested databases is carried out by a flight plan and request editing programmed compatible with the above mentioned database and database handling units.

The autopilot strategy elaboration is also carried out in the object centre 2. The traffic route of the vehicle belonging to the relevant object centre 2 is handled by the space-information unit 17b. There are two types of the above mentioned route: a static traffic route, in which case the traffic control supervision is inactive, and the dynamically planned traffic route, when the traffic control supervision is active, and the given route plan is supplied by the regional space-information unit 37 or the space-information unit 33.

The autopilot strategy elaboration is carried out as follows. In the first step, the procedures performed by the processing unit 17 and to be described later, such as a deviation from the automatic route procedure, the automatic dangerous altitude procedure, the time remaining until the automatic turning points procedure, the automatic landing and takeoff direction procedure, the automatic approach to dangerous or prohibited geographic areas procedure and the automatic dangerous approach to vehicles are carried out in a continuous mode, at discrete times. The regional traffic situation monitoring unit 38 of the regional control centre 4 responsible for the relevant traffic zone—which monitoring unit carries out tests similar to those above, but on a regional level—prepares in a continuous mode at discrete times and posts to the processing unit 17 of the relevant object centre 2 the informative or instructive reports. The results of tests carried out by the regional traffic situation monitoring unit 38 are of a higher accuracy and they are on a regional level, e.g. they take into consideration the actual regional traffic situation as well, and therefore the relevant tests are preferably of a higher priority.

In the second step, if the results identified in the test result of the procedures carried out in the system of the object centre 2 and/or the results identified in the reports reflecting the results of tests carried out by the regional traffic situation monitoring unit 38 show higher than permissible deviations or rise above a critical level, the processing unit 17 launches an autopilot strategy elaboration procedure and displays the actual results on the graphic platform of the operator unit 23.

In the third step, the autopilot strategy elaboration procedure requests the space-information unit 17b to model mathematically the given route modification. The task is carried out by the partial procedure ‘route modification’ of the ‘route modelling’ procedure. If the alarm is given by the regional traffic situation monitoring unit 38, the execution of the relevant procedure is unnecessary because it is with an alarm that the above mentioned unit sends the mathematical model of the route modification corresponding to the type and technical status of the vehicle and prepared by the regional space-information unit 37 together. Now the strategy modelling procedure to be followed by the autopilot and related to the plotted route model is performed, and then the given autopilot strategy is transferred to the regulating system which controls the work of the autopilot. The elaborated autopilot strategy is nothing else than the specifying of regulating functions in relation with the steering devices.

The tasks related to the clock of the object centre 2 are as follows. For the IT communication and for tackling the transport tasks in a planned and high quality way, it is indispensable to have an appropriately accurate timing. With a number one priority, the clock of the object centre 2 is nothing else than the internal clock of the satellite-based navigation receiver 18, which is of very high accuracy and provides a uniform time parameter from the side of the traffic control system, regarding the parties there. In this case, the clock is made accurate in a way known from the prior art through satellite-based measurements. The task is carried out automatically and on a regular basis by the satellite-based navigation receiver 18 of each object centre 2. With a secondary priority, the provision of support in relation to the clock of the object centre 2 is ensured by the regional control unit 35 of the regional control centre 4 which conducts the monitoring of the relevant traffic zone. The digital clock is adjusted automatically when the relevant object centre logs in.

The satellite co-ordinate transmitter 20b can be operated in two different modes. A continuous mode prevails if the traffic control supervision is interrupted due to some technical reasons, and if the quality of IT communication is judged to be of an insufficient grade respectively. In this case, the processing unit 17 of the given object centre 2 sets the operation of the satellite co-ordinate transmitter 20b so far having operated in a quasi-continuous mode to continuous mode. This mode means that the identity code of the object centre 2 or in case the identity code generator 21 is fitted, the public key of the digital signature is broadcast continuously at discrete times by the transmitter. In this case, the traffic control system is continuously in sight of the relevant object centre 2.

The quasi-continuous mode is started automatically by the processing unit 17 after switching on the object centre 2. In this mode, the transmitter broadcasts a series of pulses with a significant time interval, and these pulses include the identity code of the object centre 2. Now the traffic control system is in sight of the relevant object centre 2 at discrete times, and utilises the data as control results.

On the basis of compensated and uncompensated co-ordinate data to be described later and located in the space-information database of the space-information unit 17b, the following parameters can be generated and directed to the graphic display of the operator unit 23 in order to plot a virtual dashboard: the extent and direction of actual overground speed calculated on the basis of differential procedures applied to the timeline of co-ordinate data,—or calculated by adapting a different mathematical procedure,—along with the actual overground altitude, which is forwarded automatically to the processing unit 17 by the ‘hazardous altitude automatic procedure’, and also by a similar procedure conducted by the associated regional traffic situation monitoring unit 38 and the traffic situation monitoring unit 33a, as well as a virtual artificial horizon implemented by a plurality of satellite-based navigation receivers 18 or the satellite-based navigation antenna 18a operating in parallel and fitted on several points of the vehicle.

The diagnostic testing of the IT communication between the object centre 2, the regional control unit 35, and if necessary between the independent databases not making part of the traffic control system and the IT nets made accessible to the relevant object centre 2 and the system of object centres 2 participating in the traffic is carried out by the processing unit 17 from the side of the object centre 2. In the course of this process, it examines the integrity of all digitally signed reports (electronic documents) received from the units listed. It also examines the response IT diagnostic reports returned by the units listed, regarding the electronic documents that test the IT communication and were posted previously in a continuous procedure by it at discrete times. The posting of the diagnostic reports is performed by the processing unit 17 in an automatic and continuous mode, at discrete times. The procedure monitors the substance of the response report, its syntactic and semantic integrity and whether it has been received before the deadline.

The diagnostic testing of the relevant IT communication is also monitored and examined by the units listed above. The procedure carried out by the units listed above is similar to that performed by the processing unit 17.

If, on the basis of the test results, the processing unit 17 judges the IT communication to be unsatisfactory or interrupted, sets the satellite co-ordinate transmitter 20b to continuous mode, sets maximum report density for broadcasting the satellite-based co-ordinate data and launches the procedure for the syntactic and semantic analysis of the instructions identified in the electronic documents and in internal IT communications and to be described later on, as performed by the processing unit 17.

If there is no traffic control supervision, the object centres 2 of the relevant vehicles get automatically in contact with each other and transfer reciprocally their traffic technology databases for the other involved object centres 2. The responsibility for performing the traffic control tasks rests with the group commander appointed on the basis of a certain consideration and in charge of supervising the relevant object centre 2.

When there is a traffic control supervision, the regional control unit 35 and the control device 32 can set up so-called groups for the system of object centres 2 under their supervision. The group consists of the group commander (commander object centre 2) and a system of the subordinate object centres 2.

The task of the group commander on-board centres 17is on the one hand to maintain a continuous and mutual IT contact between the group commanders (and furthermore in case there is a traffic control supervision, to perform the ongoing diagnostic test of the latter) and to organise and to conduct the transport of databases affecting the group commanders on the other hand, to maintain a continuous and mutual IT contact between the subordinate object centres 2 and between the subordinate object centres 2 and themselves (in case there is a traffic control supervision, to perform its ongoing diagnostic testing, which is carried out by both the group commander and the object centres 2 belonging to the group, based on the activities of their processing units 17), as well as to organise it, then in the third place, to compile the relevant databases for the subordinate object centres 2 and to organise their customised transport and in the fourth place, if there is no traffic control supervision, to integrate new object centres 2 into the group system, which present themselves and request to be included under the traffic control supervision.

The integration process is based on an iterative work among the group commanders; in the first step, the object centre 2 requesting admittance gets into IT contact with the object centre 2 of the group commander accessible. In the second step, the group commanders carry out a reconciling and iterative integration protocol, which is performed on the basis of the characteristics of the object centre 2 waiting for integration and according to the IT and computer technology workload of the group commanders. It is also part of the integration protocol during the integration of an object centre 2 into the traffic control system that an integration protocol in connection with the database transports carried out as a standard procedures and with the relevant traffic plan is implemented. As the final result of the integration protocol, the group commander responsible for the relevant object centre 2 is appointed. In the third step, on the one hand the group commander informs the object centre 2 waiting to be integrated about being admitted to his own group, and on the other hand in a customised way, posts it the database that identifies the group, and in the third place, carries out the updating oriented loading of the relevant object centre 2 units is carried out. As a result of the integration process, the groups constitute a dynamic system, thus the composition of the groups, and therefore even the group commander can be changed even several times during the existence of the group.

After this the group commander implements a task system, a protocol procedure system and a monitoring system of the same logic as the system of the subordinated object centres 2, and the system of traffic manager tasks of the regional control centre 4 and its work. The protocol system implemented by the group commander is the following:
on the level of the processing unit 17, planning and implementation of an optimal communication strategy in the group and/or keeping contact with the external IT networks connected (it is indispensable if necessary to set up databases and IT centres that can be directly accessed and handled by the object centres 2), and the diagnostic testing of the IT contact between the object centres 2 in the group and the group commander and/or regulating the density parameter of the co-ordinate reports of the object centres 2 of the group and supplying them to the other group commander object centres 2,
when integrating it into the group on the level of the space-information system 17b, the updating oriented loading of the database of the space-information unit 17b and/or the space-information modelling of the route system of the object centres 2 associated with the group and/or report-like ‘posting’ of the actual traffic situation of the group's traffic zone to the other group commanders and/or performing a group-level integration of the traffic plans involving the group,
on the level of the space-information system 17b, regarding the traffic situation monitoring tasks, on the part of the object centres 2 of the group, performing tie route deviations procedure and/or the approaching of ‘dangerous or prohibited’ geographic zones automatic procedure and/or the automatic estimation of the flight time remaining until the turning points procedure and/or the automatic monitoring test of hazardous approaches and/or the dangerous altitude and its automatic forecast procedure.

In the IT communication network thus established, the object centre 2 of the group commander and the system of the object centres 2 belonging to the group constitute an IT network. In the given network, the computer technology resources of the system of the object centres 2 involved operate as a computer-based task-oriented computer network, where the object centre 2 of the group commander fulfills the functions of a process coordinating server. The local IT networks represented by the object centres 2 of the group commanders, as central IT network level, constitute a local IT network family being in continuous IT contact with each other, and operating in parallel. In the IT network family, the object centres 2 of the group commanders ensure the IT compatibility and transparency between the local networks, which represent autonomous and independent networks in themselves.

In the object centre 2, traffic situation monitoring tasks are also carried out The fulfillment of the tasks is ensured by a system of procedures carried out in association with the set of tasks, in a continuous mode of operation, at discrete times. It is an important circumstance that if the traffic control supervision is active and the relevant vehicle complies with the customised dynamic traffic plan drawn up by the regional control centre 4, dangerous traffic situations are practically impossible to occur.

In the course of preparing the traffic situation monitoring tasks, in the first step, from the database of the space-information unit to be described later on the processing unit 17 reads in the 3D long-term co-ordinate timeline of the vehicle, if there is no traffic control supervision, uses the 3D long-term co-ordinate timelines generated by the space-information unit 17b on the basis of the co-ordinate data supplied by the satellite-based navigation receiver 18, and the dynamic and (if there is no traffic control supervision) the static mathematical model of the traffic route plan. In the second step, from the space-information database of the space-information unit 17b, retrieves the data referring to the actual traffic situation of the relevant region (the identity codes of the aircraft in the regional zone, the static route plan of the aircraft in the regional zone, the actual meteorological map databases, the traffic data of the landing sites, airports and standby airports identified in the route plan of the relevant aircraft, the dynamic route modification system of the aircraft in the given regional zone), to create the long-term 3D co-ordinate timeline forecast of the relevant regional zone, as well as the long-term 3D speed co-ordinate timeline prognosis. In the third step launches the procedures relative to—as described below—route deviation, dangerous altitude, remaining time until the turning points, landing and taking off direction, approaching of dangerous or prohibited geographic zones and dangerous approach are launched.

In the course of the automatic procedure of route deviations, as a first step the processing unit 17 requests the space-information unit 17b to calculate the distance of the actual co-ordinate data as well as co-ordinate and speed data forecasts and the respective dynamic and static traffic route plan concerning the relevant moment of time and timeline.

In the second step, on the basis of the relevant results, it gives instructions to the operator unit 23 to display the extent of the deviation on a graphic platform, and in case the deviations are larger than the threshold rate, it alarms the autopilot through the autopilot coupling unit 22b to minimise the relevant deviation It is an important circumstance that the competence of the object centre 2 extends only over small deviations from the route during the traffic control supervision. If the results plotted in the first step reach a critical level, an informative report is drawn up about this event for the on-board voice generator 17d. The informative report includes the identifier of the danger detection procedure, the value of the relevant parameter and the degree of risk level. On the basis of the parameter vector featuring in the report read in, the on-board voice generator 17d identifies and highlights the text database supporting the fulfillment of the task and reads it in. Then, it notifies the processing unit 17 and requests that a user audio frequency data channel assigned to the relevant task be allocated for itself. After that the processing unit 17 has given its conformation and the requested audio frequency data channel has been allocated, the on-board voice generator 17d performs the audio frequency presentation of the text database.

In the course of the hazardous altitude automatic procedure, which is not required in railway, road and water implementation, in the first step the processing unit 17 requests the space-information unit 17b to determine the distance between the actual co-ordinate date, the co-ordinate and speed data forecasts and their normal projections on the 3D map. In the second step, on the basis of the results, it instructs the operator unit 23 to display the calculated overground distance on its graphic platform, and when a dangerous altitude is reached, the autopilot is alarmed through the autopilot coupling unit 22b to reach a safe altitude, and furthermore if needed it starts up the on-board voice generator 17d in a way already discussed.

In the first step of the automatic procedure for estimating the remaining flight time until reaching the turning points, the processing unit 17 requests the space-information unit 17b to carry out the actual co-ordinate and speed data forecasts and the estimation of the remaining flight time until the next turning point in the respective dynamic (or static) traffic route plan In the second step, on the basis of the results, it instructs the operator unit 23 to display the estimates of the remaining flight time on its graphic platform, and in the case of small deviations in time, it alarms the autopilot through the autopilot coupling unit 22b to minimise the relevant deviation in time, and furthermore if needed it starts up the on-board voice generator 17d in a way already discussed.

As the first step of the automatic control procedure of landing and takeoff direction, the processing unit 17 requests the space-information unit 17b to specify the system of input/output procedures corresponding to the technical-technological characteristics of the given vehicle, and furthermore the space information-mathematical standard model of the vehicle in connection with the task, on the basis of the destination, the standby airports and landing sites, as well as the starting traffic junction space information traffic technology database. The given space-information mathematical standard model is nothing else than the mathematical model of the traffic task specific route plan of the relevant vehicle.

In the second step, on the basis of the results, the processing unit 17 makes a decision whether to apply its own model or the model posted by the traffic control system. If there is traffic control supervision, the space-information model of the dynamically planned traffic route of the traffic control system is of higher priority. Furthermore, instructs the operator unit 23 to display the given model on its graphic platform, and instructs through the autopilot coupling unit 22b the autopilot integrated into the traffic control system to follow the relevant space-information model and if needed it starts up the on-board voice generator 17d in a way already discussed.

When an automatic procedure is to be carried out on approaching a dangerous or prohibited geographic zone, as a first step, at discrete times and on an ongoing basis, the processing unit 17 requests the regional space-information unit 37 to determine the characteristic space-information parameter vector of the dangerous or prohibited geographic zones located in the area of the actual co-ordinate data and the co-ordinate and speed coordinate prognosis. If there is no traffic control supervision, the database located in the database of the space-information unit 17b is applied, which database is updated on registration with the system. In the second step, it instructs the space-information unit 17b to determine the distances and the forecasts for the distances between the relevant objects and the vehicle. In the third step, the operator unit 23 is instructed to display the degree to which the dangerous or prohibited geographic zones are approached, and if necessary, the on-board voice generator 17d is started up in a way already discussed.

As the first step of the procedure to be carried out in the case of dangerous approaches, the processing unit 17, on the basis of the long-term 3D co-ordinate timeline prognosis and long-term 3D speed co-ordinate timeline forecast of the object centres 2 located in the given regional traffic zone, models the momentary distances of the vehicles belonging to the object centres 2 in the given regional traffic zone, as well as the long-term and short-term prognosis of distances from one another. In the second step, on the basis of the data of the first step, starts up automatically the procedures of the processing unit 17 relative to route deviation, dangerous altitude and the approaching of a dangerous or prohibited geographic zone.

In the third step, from the database of the processing unit 17 the space-information unit 17b reads in the space-information database associated with the relevant task, and modelled, calculated and posted by the regional control unit 35 and by itself. Now, the database read in previously is compared—in a mathematical sense a ‘distance’ is calculated—with the space-information database modelled by the procedures started up in the second step. The comparison of the relevant models is carried out by taking into consideration the priority levels and the characteristics of the databases. Next the regional control unit 35 is informed on the results obtained from comparing the models. What to do from then on is decided by the regional control unit 35.

In the fourth step, on the basis of the results, the regional control unit 35 informs and alarms, the given object centre 2 about the results concerning the approaches that could become dangerous or their forecasts. If necessary, in the way already discussed, the on-board voice generator 17d is started up on the basis of the data modelled in the third step. In the case of a dangerous approach or its forecast, it carries out the instructions of the regional control unit 35 or evasion operations are carried out automatically by the procedures applied by the processing unit 17 relative to route deviation, dangerous altitude and approaching a dangerous or prohibited geographic area, with the co-ordination of the regional traffic situation monitoring unit 38. It is an important circumstance that the regional control unit 35 co-ordinating the task can instruct directly the autopilot of the relevant vehicle to follow the dynamic route for avoiding the dangerous approach.

If there is no traffic control supervision, the procedure of approaching a dangerous or prohibited geographic zone and/or a procedure to be carried out in the case of dangerous approaches, handled by the object centres 2 involved, are performed automatically as described above within the organisational framework of the group, relying on the computer technology resources (computer network) of the processing units 17 involved.

The related procedure is the following. In the first step, the processing unit 17 or the space-information unit 17b of the object centre of the group commander models the momentary distances of the vehicles from each other in the given group zone, and the long and short-term forecast of the distances between them, using the long-term 3D co-ordinate timeline forecast involving the traffic zone of the group under its supervision and the long-term 3D speed co-ordinate timeline forecast.

In the second step, on the basis of the data of the first step, the procedures of the processing unit 17 relative to route deviations, approaching dangerous or prohibited zones and dangerous altitude are started up.

In the third step, on the basis of the results, the involved object centres 2 are informed or alarmed, about the results concerning dangerous approaches and their forecasts, and furthermore in the case of a dangerous approach or its forecast, it alarms the processing unit 17 of the associated object centre 2 to carry out the dynamic route planning procedure. It is an important circumstance that it is possible to set up a system, in which the processing unit 17 of the group commander that co-ordinates the task can instruct directly the autopilot of the associated object centre 2 to follow the dynamic route for avoiding the dangerous approach. If the degree of dangerous approach by certain vehicles reaches a critical value, a procedure relative to the specific vehicle is launched to select automatically a provisional landing site as well as to provide automatic guidance. Furthermore, the actual object centre 2 is informed on the results.

The on-board unit 17 includes a database, which is not necessarily required in a railway implementation, unless the railway line is automated. The substance of the database is the following.
A system of input/output procedures supporting the traffic situation monitoring task and corresponding to the technical-technological characteristics of the relevant vehicle.
The technical-technological database of the relevant vehicle. Its task is to support the traffic-related strategic tasks associated with the autopilot.
The technical-technological database of the autopilot associated with the relevant vehicle. Its task is to support the traffic-related strategic tasks associated with the autopilot.
The system of text databases supporting the on-board voice generator 17d. (The text database supporting the on-board diagnostic unit 17a, the text database supporting the traffic situation monitoring tasks of the space-information unit 17b, the text database supporting the work of the diagnostic unit 22a, the text database supporting the work of the on-board health care centre 17c. In the case of the autonomous on-board health care centre 17c, the database is located in the health care diagnostic database of the on-board health care centre 17c).

The database of the processing unit 17 is loaded prior to the installation of the object centre 2, in accordance with the type of the relevant vehicle. In the course of the operations, a further updating oriented loading can be carried out automatically by the regional control unit 35, and in an optional case in an automatic way by the object centre 2 itself, by contacting, in a report, the operators of the databases made accessible by the object centres 2, and the databases and database operators made suitable for this task through various IT contacts. In this case the regional control unit 35 and the object centre 2 of the relevant vehicle are informed on the new database when registering for the first time after installation.

The processing unit 17 of the object centre 2 is prepared for all tasks inherent in the task system of conventional design satellite-based navigation tools. The task system discussed in the case of the object centre 2 only includes a task system which is different from the conventional one and requires an ATMS central manager support.

The on-board health care centre 17c, its subassemblies and the co-ordination of their activity will be described below. The processing unit 17 ensures for the on-board health care centre 17c and its expert subassemblies that the users linked to the relevant expert units are analysed by parallel and independent health care diagnostics processing methods. It is possible to set up a system in which the task system of the on-board health care centre 17c is integrated in the task system of the processing unit 17. In the given configuration there is no need for a separate on-board health care centre 17c, because its task is modelled and ensured by a task-specific procedure and protocol package which are integrated into the task system of the processing unit 17.

Optionally, it is possible to fit health-care diagnostic facilities owned by the user and applying no radio communication procedures and being compatible with the traffic control and IT communication system to the on-board health-care centre 17c. If necessary, the user can decide whether the relevant health-care diagnostic analyses should be carried out by the health care diagnostic device owned by it and/or by the on-board health care-centre 17c and its expert subassemblies. In case the health care diagnostic analyses are carried out or are also carried out by the on-board health care-centre 17c and its expert subassemblies, the diagnostic measurement results are provided in an IT manner by the above mentioned health-care diagnostic device. The health care diagnostic device is fitted and connected to the on-board health-care centre 17c and its expert subassemblies through the protocol described for these units and via an IT connection.

It is possible to elaborate a modification in which the operation of the on-board health-are centre 17c is independent of the operations of the processing unit 17, hence it can be fitted on vehicles even without any regard for the development of the traffic control and IT communication system, and in the area of arbitrary locations and institutions.

The co-ordination of the health-care diagnostic activities of the ECG subassembly 17c1, foetus monitoring expert subassembly 17c2 and the EEG expert subassembly 17c3 is carried out by the user or by the stewardess. The user or, taking over the work of the user, the stewardess can specify the configurations made accessible to them on the data input platform of the stewardess monitor 17e linked to the operator unit 23, or to the processing unit 17 or optionally directly to the on-board health-care centre 17c, and can check the data input on their monitor subassembly. The on-board health-care centre 17cis informed about the relevant commands and parameters by the processing unit 17. The order of performing the relevant task is the same for the ECG expert subassembly 17c1, for the foetus monitoring expert subassembly 17c2 and for the EEG expert subassembly 17c3, therefore a general discussion will be provided below.

As the first step of a task determination process by the user or stewardess, the user or the stewardess applies the data input platform of the operator unit 23 or the stewardess monitor 17e to enter the relevant human check-up group, consisting of the health care subassembly associated with the medical/diagnostic check-up of the relevant organ as well as of the related task-specific medical/diagnostic procedure programmed package. Entering is carried out by means of a menu system designed for the system programmed running on the system of the processing unit 17, and then instructions are manually issued there. In the second step, the operations and/or the input data executed in the menu system are supplied from the data input platform of the operator unit 23 and the stewardess monitor 17e to the processing unit 17, where the latter performs the following functions with the contribution of the system programmed:
Translating the instructions and/or configuration parameters representing the input data.
Transforming the translated instructions and/or configuration parameters to a form corresponding to the IT specifics of the addressed on-board health care centre 17c, then forwarding them to the IT input of the relevant unit.
Transforming the translated instructions and/or configuration parameters to a form which the user is able to understand, forwarding them to the IT input of the stewardess monitor 17e and to the monitor subassembly of the operator unit 23, respectively.
The operator unit 23 and the stewardess monitor 17e, respectively, displays the data received to the user and the stewardess, respectively. Therefore, the involved parties can control the execution of the relevant task.

In the third step, in the course of processing, the on-board health-care centre 17c interprets the instructions and/or configuration parameter data vector received in the second step the heading of the instructions and/or configuration parameter data vector posted to it The heading includes the destination of the data vector, i.e. the ECG expert subassembly 17c1, the foetus monitoring expert subassembly 17c2 and the EEG expert subassembly 17c3. In addition, in a compatible way with the characteristics of the human test group identified in the heading, it examines the instructions and/or configuration parameter data vector from a syntactic and semantic aspect, and performs the following functions on the basis of the results of the examination.
In the case of a correct parameter data vector:
It transfers the instructions and/or configuration parameter data vector to the IT input of the health care subassembly of the addressed and coordinated human test group.
It informs the processing unit 17 that the instructions and/or configuration parameter data vector have been accepted by the on-board health-care centre 17c.
Furthermore, the processing unit 17 edits a report and forwards it to the operator unit 23 and the stewardess monitor 17e, respectively, in order to inform the user and the stewardess, respectively.

In the case of an incorrect parameter data vector:
It compiles an error data vector on the defects and shortfalls discovered in the instructions and/or configuration parameter data vector.
It informs the processing unit 17 on the content of the edited error data vector.
On the basis of the content of the error data vector, the processing unit 17 then edits a report and forwards it to the operator unit 23 and the stewardess monitor 17e in order to inform the user and the stewardess, respectively.

In the fourth step, in the case of a correct parameter data vector, the health care subassembly, i.e. the ECG expert subassembly 17c1, the foetus monitoring expert subassembly 17c2 and the EEG expert subassembly 17c3, associated with the addressed human test group performs the commands and instructions on the basis of the instructions and/or configuration parameter data vector examined and posted by the on-board health centre 17c.

The health care diagnostic work of the ECG expert subassembly 17c1, foetus monitoring expert subassembly 17c2 and EEG expert subassembly 17c3 is coordinated from the medical centre 48. If necessary, the actual health care diagnostic data of the examined user are supplied on-line or in a quasi on-line mode to the medical centre 48, where the operator directs the health care diagnostic database received from the relevant user to the IT input of its own expert system compatible with the relevant health care diagnostic task, in order to be analysed on a higher level than by the on-board health care centre 17c and its expert subassemblies. Once the analysis is carried out, a decision is made about the configuration of the parameter vector that determines the work of the on-board health care centre 17c and its expert subassemblies. The medical centre 48 is in IT contact with the regional control unit 35, therefore the technical and health care diagnostic facilities of the on-board health care centre 17c and its expert subassemblies carrying out on-board health care diagnostics are accessible to the operator, who, under the co-ordination of the regional control unit 35, posts the parameter vector he has generated to the relevant processing unit 17 and through it to the on-board health care centre 17c and its expert subassemblies, which process it in the way already discussed, and then automatically execute the health care diagnostic tests identified therein.

Optionally, a medical camera 17e5 is associated with the on-board centre 17c. The tasks of the camera involve the medical and security related visual observation of the passengers and the crew. The digital pictures can be taken on the basis of a strategy for both continuous and discrete time image sampling. The co-ordination of its work can be carried out by the on-board health care centre 17c, the medical centre 48, the operator unit 42 or optionally also by the processing unit 17. It also is possible to design an embodiment which is independent of the traffic control system of the discussed unit, in this case the camera is directly attached to the IT system of the vehicle.

The technical diagnostic test of the on-board health care centre 17c, the ECG expert subassembly 17c1, the foetus monitoring expert subassembly 17c2 and the EEG expert subassembly 17c3 can be performed in two ways. In the first case, the technical diagnostic testing of the on-board health care centre 17c, the ECG expert (17c1), the foetus monitoring expert subassembly 17c2, and the EEG expert subassembly 17c3 is carried out by the on-board diagnostic unit 17a In the other case, the technical diagnostic test of the ECG expert subassembly 17c1, foetus monitoring expert subassembly 17c2 and EEG expert subassembly 17c3 is carried out by the on-board health care centre 17c on its own, using the task specific diagnostic protocol system working under the supervision of its system programmed. In both cases, the operation of the system is identical with the diagnostic procedure to be described later on regarding the on-board diagnostic unit 17a.

The health care reports drawn up by the on-board health care centre 17c and its expert subassemblies are posted, and they are received by the medical centre 48, the operator unit 23, the stewardess monitor 17e and the user. The medical centre 48 receives the actual health care diagnostics data of the user subjected to health care diagnostics in an on-line or quasi on-line configuration (on the basis of the critical rate of periodically posted health care diagnostic results and on the basis of that of the performed health care diagnostic results, in an on-line switched mode). The above mentioned health care diagnostic database transport is carried out automatically in the case of all users linked to the on-board health care centre 17c and to its expert subassemblies. The processing unit 17, the regional control unit 35 and the communication centre 45 are responsible for the discussed IT transport. The health care reports prepared by the on-board health care centre 17c and its expert subassemblies and/or by the medical centre 48 and its expert subassemblies are further posted to all the medical and health care centres identified by the users and the operator. This is carried out if necessary on an IT network assigned to this task.

The establishment of the relevant IT contact between the diagnostised user and the medical centre 48 is carried out in a way already described for the traffic control system.

It is an important circumstance that all the reports distributed between the traffic control units and subassemblies have been digitally signed This ensures the immunity of the message and an unambiguous identification of the sender. Of course, a different identification, encrypting and coding procedure may also be applied.

In the case of the reports prepared for the operator unit 23, the stewardess monitor 17e and the user, respectively, because these units are the own devices of the object centre 2, the reports sent to each other are not confirmed with a digital signature. In the case of aircraft the display unit designed for the user is preferably fitted in the seat back of the passenger sitting in front, and furthermore the stewardess monitor 17e is nothing else than a workstation attached to the on-board system in a permanent or provisional way. The system programmed of the relevant workstations has a graphic platform operation system and text editor, respectively, with the graphic platform suitably designed for the purpose. Hence, the processing centre 17, the operator unit 23, the stewardess monitor 17e, the on-board health care centre 17c, the ECG expert subassembly 17c1, the foetus monitoring expert subassembly 17c2 and the EEG expert subassembly 17c3 and furthermore the display unit designed for the user constitute a quasi-closed computer network, because the IT network is open towards the regional control unit 35. In the IT network, communication is based on protocols well known in computer networks, consequently it will not be detailed.

The process covering the syntactic and semantic analysis of the instructions identified in the electronic documents and in the internal IT contacts, respectively, is carried out automatically when interpreting the instructions both between the subassemblies of the object centre 2 and between the object centre 2 and other units of the traffic control system and/or the data vector which co-ordinates some task specific process and. In the first step of the procedure, an instructive report is supplied to an IT input of the processing unit 17. The relevant report may come from a subassembly of the object centre 2 or from a different external unit which is part of the traffic control system.

In the second step, the processing unit 17 performs the first-level testing of the relevant report, which is the first level syntactic analysis of the report heading. In this test, the identity of the unit targeted by the instruction and/or the configuration parameter data vector is determined, and on the basis of the result obtained in the previous point, the syntactic test of the instructions and/or the configuration parameter data vector is carried out on the basis of the static technical and IT characteristics of the targeted unit. If on the basis of the first level test the syntactic analysis of the heading is qualified as unsatisfactory, the processing unit 17 plots an error vector and includes it in a report, then plots a repair vector on the basis of the relevant error vector, and then posts the relevant error vector and repair vector report to the unit that has turned to it with the request. If on the basis of the first level test the syntactic analysis of the heading is qualified as satisfactory, it posts the latter to the IT input of the targeted unit.

In the third step, the targeted unit carries out the following tasks:
Performing the semantic testing of the instructions and/or configuration parameter data vector on the basis of their dynamic technical and IT characteristics. Under the system programmed of the relevant targeted unit, it is possible to have a simultaneous operation of various procedures and protocols. The precondition of executing the received instructions and/or configuration parameter data vector is that they should be able to be integrated with the currently running procedures and protocols.
If the qualification of the test is satisfactory, the processing unit 17 is informed on the result of the relevant test and on the continuing of the task, it carries out the task determined by the instructions and/or configuration parameter data vector, and informs the user and the appointed persons/institutions on the results modelled by the modified procedure and protocol, as specified in the instructions and/or configuration parameter data vector and in accordance with the associated standard procedure.
If the qualification of the test is unsatisfactory, it plots an error vector, plots a repair vector on the basis of the relevant error vector, and informs the processing unit 17 in a report on the relevant error vector and repair vector.

For the stewardess monitor 17e, in an environment where a radio frequency contact is permitted, preferably wireless communication is provided. The communication is of the same character as the standard bluetooth technology or a different well-known radio frequency protocol. It is to be emphasised that its application in aviation is possible only through a radio frequency that has been licensed in the given system by the authorities.

The on-board diagnostic unit 17a is an important part of the object centre 2. The task of this unit is to check and to supervise the operations and the operating quality of the object centre 2 based on diagnostic procedures carried out at discrete times according to the higher level diagnostic reports of the regional diagnostic unit 35a and also by relying on the parameters set in advance on the platform of the operator unit 23. In a railway implementation, naturally this applies only to the systems and sub-systems installed there.

The units subjected to the diagnostic procedure are the following: the processing unit 17, the satellite-based navigation receiver 18, the identity code generator 21, the radio transceiver 19, the satellite radio transceiver 20a, the satellite co-ordinate transmitter 20b, the diagnostic unit 22a of the aircraft, the autopilot coupling unit 22b, the data acquisition unit 22c, the on-board telephone exchange 24, and the on-board health care centre 17c as well as the matched ECG expert subassembly 17c1, the foetus monitoring expert subassembly 17c2 and the EEG expert subassembly 17c3.

The on-board diagnostic unit 17a is a purpose-oriented computer network, fitted with its own separate storing capacity and target-oriented peripherals. Due to the technical differences in the units to be diagnosed, each unit subjected to diagnostic procedure is associated with a separate diagnostic procedure package. Under the control of the processing unit 17, the on-board diagnostic unit 17a prepares reports at discrete times and in a continuous mode of operation for the regional diagnostic unit 35a, in view of the system of units subjected to diagnostic procedure. On the basis of the analysis of the diagnostic reports prepared for it, the regional diagnostic unit 35a issues appropriate control instructions to the on-board diagnostic unit 17a, corresponding to the units subjected to the diagnostic procedure and to the type of the relevant vehicle, to select the diagnostic procedure to be applied and the to set the parameters of the diagnostic procedure to be applied.

In the traffic control system, in order to ensure diagnostic compatibility, on integrating the relevant aircraft, the object centre 2 issues a report to the regional diagnostic unit 35a about the programmed packages of the diagnostic procedure installed on the on-board diagnostic unit 17a and about the computer technology resources available to the on-board diagnostic unit 17a.

The operation of the diagnostic procedure is the following. After switching on the on-board diagnostic unit 17a, at discrete times and under the control of the diagnostic system programmed, standard diagnostic procedures are run. Next the diagnostic system programmed of the on-board diagnostic unit 17a issues instructions to carry out the diagnostic qualification procedures on the basis of the previous diagnostic results supplied by the diagnostic procedures and by relying on the commands of the regional diagnostic unit 35a. The above mentioned diagnostic process includes the inviting of a diagnostic procedure in the diagnostic procedure package associated with the units subjected to a diagnostic procedure, by using appropriate parameters. If necessary, the on-board diagnostic unit 17a has its own internal clock.

The invited diagnostic procedures perform the technical diagnostic qualification of the unit under their supervision and furthermore prepare a report about the diagnostic qualification procedure applied, as well as about the result of diagnostic qualification, for the diagnostic system programmed.

The diagnostic system programmed of the on-board diagnostic unit 17a does the following on the basis of the reports of the invited diagnostic procedures. It evaluates the diagnostic reports received about the diagnostic procedures, relative to the units subjected to diagnostic procedures, and then draws up the global diagnostic qualification of units subjected to a diagnostic procedure. On the basis of the diagnostic reports and the overall diagnostic qualification carried out by itself, it prepares a report about the diagnostic qualification procedure and about the result of diagnostic qualification for the processing unit 17, which report includes the diagnostic qualification, and furthermore for the regional control unit 35, which report includes the diagnostic qualification, the name of the diagnostic procedure or diagnostic strategy, eventual related diagnostic measuring results and the time of diagnostic qualification.

If the diagnostic result of a diagnostised unit has been qualified as unsatisfactory, on the basis of the diagnostic reports drawn up by the on-board diagnostic unit 17a, the diagnostic procedure programmed package installed on the on-board diagnostic unit 17a, and the computer technology resources available to the on-board diagnostic unit 17a, the regional diagnostic unit 35a compiles a diagnostic strategy for the on-board diagnostic unit 17a to carry out the diagnostic test of the relevant unit,. In case the supervision of the traffic control system is missing, the on-board diagnostic unit 17a proceeds according to a standard pre-programmed strategy.

On the basis of a diagnostic strategy edited by the regional diagnostic unit 35a, the on-board diagnostic unit 17a carries out the diagnostic test of the relevant system, edits its temporary diagnostic qualification and in the way and with the substance mentioned above, draws up a report about the given procedure for the processing unit 17 and the regional diagnostic unit 35a, which on the basis of the diagnostic report mentioned above the regional diagnostic unit 35a performs the final diagnostic qualification of the relevant unit, about which it prepares an informative report for the processing unit 17.

During the time of traffic control supervision, the regional diagnostic unit 35a—on the basis of its own decision, by making use of the diagnostic measuring results received in earlier reports and by relying on the standard data existing in the central databases 34—makes a proposal to the on-board diagnostic unit 17a to run diagnostic procedures and to draw up the associated diagnostic reports. On the basis of examining the diagnostic measuring results received in the reports, the regional diagnostic unit 35a may make a proposal to the aircraft crew, in relation to operating the aircraft in mid-air.

If according to the final diagnostic qualification result, the relevant unit is not functionable, the on-board diagnostic unit 17a makes a proposal to the processing unit 17, on the basis of a proposal from the regional control unit 35, about the further operation of the relevant unit.

If the on-board diagnostic unit 17a judges the operation or the reliability of operations of any unit under its supervision to be critical, it draws up an information report about the relevant event for the on-board voice generator 17d and for the graphic platform of the operator unit 23. The informative report includes the identifier of the on-board diagnostic unit 17a, that of the procedure that reveals the hazard, that of the diagnostised subassembly, the value of the critical parameter vector and the degree of risk level. On the basis of the parameter vector featuring in the report read in, the on-board voice generator 17d and the operator unit 23 identify and assign the database supporting the fulfilment of the task and read it in. Then notify the processing unit 17 and request the splitting of the user's audio frequency data channel assigned to the relevant task. After that the processing unit 17 has given its confirmation and the requested audio frequency data channel has been split the on-board voice generator 17d performs its task.

A further important part of the object centre 2 is the space-information unit 17b. The standard scale 3D digital copy of the traffic map and the associated databases are located in the space-information database of the space-information unit 17b. The transformation, display and certain aviation safety, navigation and database handling operations associated with the above mentioned databases are carried out by the space-information unit 17b according to the following.

The task of handling the various map-based databases can be split into the following two partial tasks: the procedure carried out in the plane X,Y, which ensures that information is provided about the relevant vehicle for the on-board operator, and furthermore the procedure carried out in plane X,Z, which is primarily required in the case of flying objects, and which ensures that information is provided about the actual overground altitude of the relevant flying object for the on-board operator.

The data obtained this way, can be displayed on the graphic platform of the operator unit 23. The displayed map-oriented databases are the following:
the actual 3D geographic or 3D aviation map,
the actual meteorological map, which is updated by the regional control unit 35 after registering with the traffic control system and on an ongoing basis later on, and
the system of the actual dangerous or prohibited air spaces, which system is updated by the regional control unit 35 after registration with the traffic control system and on an ongoing basis later on,
the timeline database (primary database) of the uncompensated and compensated co-ordinate data.

The orientation of the map details discussed is always carried out according to the direction of movement of the relevant object centre 2. The space-information unit 17b determines the relevant direction from the timeline of the compensated and uncompensated co-ordinate data located in its own database. The centre of the displayed maps is represented by the actual co-ordinate data of the object centre 2. This is provided by the space-information unit 17b on the basis of the compensated and uncompensated co-ordinate data in its own database. The scale of the displayed maps is specified on the basis of the parameters identified on the operator unit 23.

The task of the relevant procedure is the correct and time-proportionate mathematical modelling of the geographic co-ordinate of the 3D route plans received by the space-information unit 17b, which handles the mathematically modelled and correct and time proportionate route plan (geographic co-ordinates) compatibly and simultaneously with the various map-based databases. The relevant model is stored in the space-information database of the space-information unit 17b for a time interval corresponding to its dynamism.

The space-information unit 17b carries out the mathematical modelling of the static and dynamic route. In the first step of the procedure, the processing unit 17 instructs the space-information unit 17b to carry out the task. The set of parameters determining the traffic route may come from two different sources, i.e. from the static traffic route plan in the space-information database of the space-information unit 17b, and from the dynamic traffic route plan located in the space information database of the space information unit 17b and compiled and posted by the regional space information unit 37 of the regional control centre 4 responsible for the relevant traffic zone.

In the second step, the space information unit 17b carries out with the correct time parameters the 3D and mathematical modelling of the relevant traffic route plan corresponding to the geographic co-ordinates. In the third step the traffic route plan edited in the second point, together with the geographic co-ordinates and correct time parameters, is integrated into the 3D map databases subjected to an updating process, and furthermore at the user's request the processing unit 17 displays it on the graphic platform of the operator unit 23.

The route modification procedure is carried out by the space-information unit 17b, and the tasks of the procedure are the following: the mathematical modelling of the dynamic traffic route plan compiled and posted by the regional space-information unit 37 of the regional control centre 4 responsible for the relevant traffic zone, and the integration of said plan into the space-information database of the space-information unit 17b. In the first step of the procedure, the processing unit 17 instructs the space-information unit 17b to carry out the relevant task The set of parameters determining the traffic route are in this case the set of parameters in the space-information database of the space-information unit 17b, which determine the dynamic traffic route plan compiled and posted by the regional space-information database 37. The second and third steps are identical with the second and third steps described in the mathematical modelling procedure of the static and dynamic route.

The virtual artificial horizon modelling procedure reads in the space-information model of the geometry, of the relevant vehicle from the database of the space-information unit 17b, as well as the co-ordinate vectors associated with the identical times. By making use of the vectors and space-information database read in, it carries out the compensating calculation of the relevant task, and then posts the edited spatial position vector to the processing unit 17 for further processing.

The space-information unit 17b includes a space-information database with the following information.
The geographic database of the digital 3D aviation map and geographic map, respectively.
The updated dynamic digital meteorological map.
The system of updated hazardous objects and restricted airspaces.
In an optional case, the space-information model of the relevant vehicle's geometry.
The 3D long-term co-ordinate and speed timeline of the relevant vehicle with values compensated by the satellite-based navigation compensator unit 41 of the regional control centre 4, or in an optional case by the visual satellite-based navigation compensator unit 41a of the visual processing centre 5, or with uncompensated values coming directly from the satellite-based navigation receiver 18. In an optional case, when there are several satellite-based navigation antennas 18a and several satellite-based navigation receivers 14 operating in parallel, the involved co-ordinate vectors and the associated spatial position vector timeline calculated by the space-information unit 17b and the regional space-information unit 37.
The mathematical model of the dynamic traffic route plan posted by the regional space-information unit 37 of the regional control centre 4 or of the traffic control system.
The mathematical model of the static traffic route plan integrated previously by the regional space-information unit 37 of the regional control centre 4 or of the traffic control system.
The space-information traffic technology database of the traffic junctions involved in the static traffic plan, e.g. airports and naval ports, which is filled up when integrating the relevant object centre 2 into a traffic control system.
The actual traffic data of the relevant regional traffic zone, i.e. the identity code (public key) of the aircraft in the relevant regional zone, the static route plan of the aircraft in the relevant regional zone, the actual meteorological map databases, the traffic data of the landing sites, airports and standby airports identified in the route plan of the relevant aircraft, the dynamic route modification system of the aircraft in the relevant regional zone and, as regards the co-ordinate timelines, the database of the co-ordinate timeline characterising the past situation

Consequently, the space-information database will include planning conditions data of such kind that must or should be taken into consideration in performing the control and communication tasks.

The geographical database of the digital 3D aviation map is filled up on a basic level prior to installing the object centre 2. In the course of the operations, further updating oriented loading operations can be carried out by the regional control unit 35 and by the operator, respectively. In this case the regional control unit 35 is informed on the new database at the time of the (first) registration procedure of the object centre 2 of the relevant vehicle after installation. The filling up of the other partial databases is carried out by the regional control unit 35 and the processing unit 17, respectively.

In a railway implementation, primarily a 2D oriented database is applied. Regarding function, this database is split into two parts:
Static database: this includes the railway routes and branches in a 2D space-information model.
Dynamic database: this includes the actual switching position of the switches fitted at the railway branchings, and the actual switching position of the railway signal system fitted at railway junctions and at other related background sites.

Other important parts of the object centre 2 are the on-board health care centre 17cand its subassemblies, which carry out the following tasks: independent and simultaneous control and supervision of the health care quality of the user(s), who can be the passengers, the stewardesses and the crew, audio frequency support of the user(s) in accordance with their momentary health care diagnostic statuses, storing of the timeline of the related health care diagnostic measuring results in the health care database, display of higher priority health care diagnostic results provided by the medical centre 48, and automatic adaptation of the health care diagnostic instructions that co-ordinate the work of the on-board health care centre 17cand its expert subassemblies through the medical centre 48.

By setting up the system it is possible to transfer on-line the actual health care diagnostic data of the user, on the basis of the advice of the user itself or by a different person on-board or by the medical centre 48, to the medical centre 48 for providing assistance.

For carrying out the health care tasks, the following are linked to the on-board health care centre 17c: the system of health care diagnostic expert subassemblies, the ECG expert subassembly 17c1, the foetus monitoring expert subassembly 17c2 and the EEG expert subassembly 17c3, the stewardess monitor 17e, and furthermore the users themselves are also linked in an IT manner either directly or indirectly, through the on-board telephone exchange 24, to the on-board health care centre 17c. The IT link of the user is provided by the specific health care diagnostic measuring peripherals of the relevant diagnostic test, which said peripherals are on the appropriate body surface of the user or if necessary within their bodies. The peripherals are connected to the on-board health care centre 17c through wires, or by means of a radio communication procedure permitted by the authority to be used on board of the relevant vehicle, e.g. by bluetooth technology. In the case of wire contact, the IT interfaces are located in accordance with the type of vehicle, for example in the seat back of the passenger sitting in front or in the seat of the passenger.

The health care unit may have three types of designs: a partial embodiment, an integrated but separate embodiment and an integrated embodiment In the partial embodiment, the on-board health care centre 17cand the system of the associated health care expert subassemblies constitute separate hardware units. As regards the operation of the system, it is a target-oriented computer network with separate and joint background store capacities of appropriate size managed by the system programmes of the on-board health care centre 17c, the ECG expert subassembly 17c1, the foetus monitoring expert subassembly 17c2, the EEG expert subassembly 17c3 and the, the stewardess monitor 17e. The on-board health care centre 17c and the associated expert subassemblies preferably have their own system programmes and a health care basic diagnostic procedure and protocol programmed package working under the supervision of the relevant system programme. In this embodiment, the central co-ordination of the work of the discussed medical diagnostic computer network is carried out by the on-board health care centre 17c.

In the integrated but separate embodiment, the system of the on-board health care centre 17c and the associated health care expert subassemblies represent a single hardware unit In this design, the health care unit is an independent target-oriented computer, with its own background store capacity of appropriate size, its own system programme, and a health care basic diagnostic procedure and protocol programme package working under the supervision of the relevant system programme and providing a software based modelling of the subassemblies listed above along with their diagnostic task systems.

The integrated and the partial embodiments permit the setting up of a health care diagnostic centre which is independent of the traffic control system and is centrally supervised and controlled by the medical centre 48.

In the integrated embodiment, the on-board health care centre 17c, the associated health care expert subassemblies and furthermore the system of the human diagnostic procedures and protocols associated with the expert subassemblies are featured in an integrated way in the system of the processing unit 17. This means that the on-board health care centre 17c and the system of the associated health care expert subassemblies and furthermore the related procedures and protocols represent task-specific and independent procedure systems which are in reality integrated under the system programme of the processing unit 17.

Hereinafter, in discussing the health care unit and its subassemblies, no distinction will be made between the partial, the integrated but separate and the integrated embodiments.

The on-board health care centre 17c has a complex task system, and basically carries out the co-ordination of the work of the associated health care expert subassemblies, the signal preparation of the health care diagnostics measuring signals received by the health care expert subassemblies and the co-ordination of the work of the health care database. Furthermore, relying on the work of the stewardess monitor 17e, it provides a high-level and user-friendly communication between the user and the health care expert subassemblies. The relevant task system is tackled with independent and parallel processing associated with the user(s).

The task system of the on-board health care centre 17c is the following:
Redirection of the transport of pre-processed and diagnostic signals and databases to the related expert subassembly.
Syntactic and semantic analysis and qualification of the instructions and/or configuration parameter determining the health care tests in a human test group specific way.
Digitisation and pre-processing of the signals received from the health care peripherals.
Health care oriented control of the on-board voice generator 17d.
Reception of the instructions and reports from the medical centre 48 and their posting to the related expert subassembly and the user, respectively.
Health care diagnostic control of the regional voice generator 35e.

In the given system design, the on-line analogue timeline of health care diagnostic measuring results is supplied from the measurement-specific health care peripherals associated with the on-board health care centre 17c to the on-board health care centre 17c, where they are put through expert subassembly specific digitisation and pre-processing.

Next the on-board health care centre 17c, in a selective and task-specific way, redirects the relevant signal database to the places or to the IT inputs of the units below:
Under the co-ordination of the processing unit 17, to the medical centre 48.
To the health care expert subassembly responsible for the relevant health care diagnostic test, for health care diagnostic analysis.
To the health care diagnostic database handled by it. In the given database, the following data are stored assigned to each other: name and identifier code of the user, time of the test, the digitised and signal pre-processed partial database, health care diagnostic results, conclusions and proposals for warnings in text form, and identifier of the health care expert subassembly carrying out the relevant diagnostic procedure and the health care diagnostic procedure and protocol. The database may also include the static textual database of the on-board voice generator 17d.

Next, the health care expert subassemblies, after the health care diagnostic tests carried out by them and following the health care diagnostic evaluation of the results, edit a report about the tests for the on-board health care centre 17c, which prepares informative reports suitably specified for the destinations determined on prescribing the diagnostic tasks and posts them via the processing unit The destination can be a user, the medical centre 48 and any institute or private individual.

The system programme of the on-board health care centre 17c performs a syntactic and semantic analysis on the instructions and/or configuration parameter data vector determining the health care tests for said programme and received from the users or even from the medical centre 48 by means of the stewardess monitor 17e and prepares their qualification in a human check-up group specific way. In a partial embodiment the relevant task system may be transferred to the task system of the health care subassembly associated with the relevant human check-up group. The semantic analysis covers the questions whether the requested health care diagnostics and the parameter vector determining the same correspond to the characteristics of the active diagnostic procedures in the system of the addressed human check-up groups and to their health care priority, and furthermore whether the requested health care diagnostics and the parameter vector determining the same correspond to the health care peripherals attached to the health care expert subassembly performing the relevant test.

In case a wrong parameter data vector is read in, a draws up a report about the characteristics of the revealed error, plots an error data vector and then posts it to the processing unit 17, and if the description of the relevant task was delivered directly, then also to the user having prescribed and determined the relevant health care test, together with the report mentioned above. This is displayed on the stewardess monitor 17e. Next, prepares a report about the event and transfers it to the health care diagnostic database handled by it The task of the digitisation and signal pre-processing is to supply a digital based and appropriate quality health care diagnostic measuring timeline database to the ECG expert subassembly 17c1, the foetus monitoring expert subassembly 17c2 and the EEG expert subassembly 17c3. The relevant health care diagnostic measurement timeline database, in real time or quasi real time, is put through diagnostic processing in the given health care expert subassemblies. The parameters that determine the operations of the analogue-digital converting and digital signal pre-processing procedures are specified when the health care expert subassemblies are attached to the on-board health care centre 17c, they are quasi static parameters.

It is an important requirement to be met by the on-board health care centre 17cthat that it should be able to permit the discussed IT, signal forwarding and switching, analogue-digital conversion and digital signal pre-processing tasks in a parallel way and with independent processings, up to the limit inherent in the design of the system, . In case a requested task exceeding the above mentioned limit is prescribed, the on-board health care centre 17c sets up a priority sequence, then grading, sequencing and performing the above mentioned tasks accordingly. The regulation on setting up the priority sequence is a system-dependent quasi-static parameter, whose input takes place when it is integrated into the system.

Under the system programme of the ECG expert subassembly 17c1, foetus monitoring expert subassembly 17c2 and EEG expert subassembly 17c3, various health care diagnostic procedures and protocols can be operated. The signal pre-processing requirement of these units may result in parameter vectors deviating from those of the digital signal pre-processing procedure integrated under the system programme of the on-board health care centre 17c, which automatically assigns the pre-programmed parameter vector to the health care expert subassembly and to the active health care diagnostic procedure and diagnostic protocol running under its system programme.

The on-board health care centre 17calso performs the health care oriented control of the on-board voice-generator 17d. The related textual databases are located in the health care diagnostic database handled by it After carrying out the health care diagnostics requested by the user, the health care expert subassembly responsible for the relevant test prepares a report, which includes also the address of the file determining the textual messages intended for the user. Then, the on-board health care centre 17c encloses the address of the file in the health care diagnostic database assigned to the relevant task and the actual prescription of the task in a report and forwards them to the on board voice generator 17d. The on-board voice generator reads in, interprets and carries out the task according to the determining parameter vector. The textual information appears through the loudspeaker assigned to the user or on the stewardess monitor 17e or if necessary with other persons whom the on-board health-care centre 17c considers to be involved.

If the procedure above relies on the database of the processing unit 17, the procedure takes place as follows. In case the on-board health care centre 17c retains the health care diagnostic results of the user diagnosed by it to be critical on the basis of the report from any health care expert subassembly integrated into its system, it draws up an informative report on the relevant event for the on-board voice generator 17d.

The informative report includes the identifiers of the on-board health care centre 17c, the diagnosed user and diagnosed human organ, the vector value of the critical parameter and the degree of risk level. On the basis of the parameter vector featuring in the report read in the on-board voice generator 17d identifies and assigns the database supporting the execution of the task and reads it in. Next, it notifies the processing unit 17 and requests the splitting of the audio frequency data channel of the user assigned to the task After that the processing unit 17 has given its confirmation and the requested audio frequency data channel has been split, the on-board voice generator 17d performs its task.

In connection with the active health care diagnostic tests under its co-ordination, the on-board health care centre 17c has the following additional tasks:
receiving the instruction parameter vectors which come from the medical centre 48 and co-ordinate the health care diagnostic work of the on-board health care centre 17c and its expert subassemblies and managing their adaptation for the expert subassemblies,
receiving, the reports edited by the health care expert units located in the medical centre 48 and of higher diagnostic priority than the health care diagnostic work of the on-board health care centre 17c and its expert subassemblies, and forwarding them to the user and stewardesses, respectively, through the stewardess monitor 17e,
receiving the reports from the group of physicians on duty at the medical lab 48d of the medical centre 48 and forwarding them to the user and stewardesses, respectively, via the stewardess monitor 17e.

The ECG expert subassembly 17c1, the foetus monitoring expert subassembly 17c2 and the EEG expert subassembly 17c3, in the aspect of computer technology, are prepared for the health care diagnostic monitoring of several users simultaneously and independently. Their tasks and the preparation of their work are carried out by the on-board health care centre 17c and if necessary by the processing unit 17 itself.

The task of the on-board voice generator 17d is the audio frequency conversion of the textual database data determined by the associated units. In the course of its operations, it receives instructions to carry out a certain given task, which is determined by the finding unit, when it specifies the address of the database and file that store the textual message sought. Next, the on-board voice generator 17d produces the required audio frequency message, and its IT switching for the appropriate user is carried out by the processing unit 17.

The satellite-based navigation receiver 18 has a multifarious task. On the one hand, at discrete times it takes the reading of the database broadcast by the positioning satellites 6 within its sight. On the basis of the readings, it determines the aircraft's uncompensated 3D spatial co-ordinates. Next, it informs the processing unit 17 in a report on the constructed spatial co-ordinate data. The report includes the uncompensated co-ordinate data, the identifier code of the satellites subjected to reading, and the measuring results of the satellites subjected to reading. The launching of the satellite reading procedure is performed under the co-ordination of the processing unit 17, where the starting time is logged.

It is possible to design a satellite-based navigation receiver 18 fitted with a plurality of satellite-based navigation antennas 18a, where the IT contact between the linked satellite antennas and the satellite-based navigation receiver 18 can be of wire or wireless type (even bluetooth system). If necessary, the satellite-based navigation receiver 18 calculates the required co-ordinate data vectors at discrete times on an ongoing basis, by applying simultaneous data processing and antenna reading. The data vectors calculated provide an opportunity for the processing unit 17 and the regional control unit 35 as well as the regional space-information unit 37 to produce a mathematical model of the spatial position of the vehicle, on the basis of the geometric space-information model, as a stiff body model of the relevant vehicle.

This task may also be resolved by a plurality of satellite-based navigation receivers operating in parallel and independently, and handled by the processing unit 17. The major criterion is to take the reading of the different satellite based navigation receivers 18 at identical times.

The radio transceiver 19 and the satellite radio transceiver 20a are two independent systems operating in parallel. Depending on their configuration, they can be of multinorm type and also telecommunication radios. In the telecommunication case, in order to support the transport and logistics task, the relevant radio can be optionally prepared for the technical handling of the bluetooth approach. Their work is coordinated by the processing unit 17. Their task is to create an IT contact between the object centre 2, the regional control centre 4, other object centres 2 and in an optional case the databases prepared for this task and compatible with the traffic control system. The communication route between the radio transceiver 19 and the traffic control system from the direction of the object centre 2 is the following: radio transceiver 19, radio re-transmitter unit 3, IT unit 36, regional control unit 35, its units and databases, again the IT unit 36 and then finally the control device 32.

The communication route between the satellite radio transceiver 2a and the traffic control system from the direction of the object centre 2 is the following: satellite radio transceiver 20, re-transmitter satellite 7a, stationary satellite transceiver 8, IT unit 36, regional control unit 35, its units and database, IT unit 36 and finally control device 32.

The order of radio communication between the object centre 2 and the regional control unit 35 is the following. With the contribution of the radio transceiver 19 or the satellite radio transceiver 20a, the processing unit 17, or in the case of initiating a response or information forwarding, the regional control unit 35, requests a channel from the IT unit 36 through an organising channel. The IT unit 36 selects a currently available channel, and under the control of the regional control unit 35, instructs the radio transceiver 19 or the satellite radio transceiver 20a to tune to the relevant channel. Now radio communication can be carried out The specific feature of the relevant radio communication is that it is customised, i.e. the relevant information channel is opened only between the sender and the receiver.

The radiotechnical satellite-based co-ordinate determination by the satellite co-ordinate transmitter 20b represents a less accurate technology than the satellite-based approach, therefore it operates as an auxiliary unit.

It is an important circumstance that when the measurement is combined with a satellite-based radar approach, the accuracy could reach a quasi-arbitrary fineness, and hence in the given case even a number one priority satellite-based spotting system can be established. In this case the satellite-based navigation receiver 18 will have secondary priority.

The operation of the transmitter is coordinated by the processing unit 17. On the basis of the transmitted data, the network of the spotting satellites 7b is able to provide an approximate 2D identification of the geographic position of the relevant object Formed into a report, the co-ordinate data and identity code associated with the relevant object centre 2 are transmitted by the spotting satellite network, via the stationary satellite-based transceiver network 8, to the regional control unit 35, where it is further processed.

The communication route of the satellite co-ordinate transmitter 20b is the following: satellite co-ordinate transmitter 20b, spotting satellite 7b, where the co-ordinate data sought are determined, stationary satellite transceiver 8, IT unit 36, regional control unit 35.

The identity code generator 21 is a specific peripheral, the operation of which is co-ordinated by the processing unit 17. It functions as follows. The processing unit 17 compiles the content of and prepares the material of the actual report posted to the regional control unit 35. Compiling and preparing are nothing else than collecting the reports received from the units, compiling the unit's own report, and compressing/encrypting according to the optimal distribution strategy, in addition to splitting to partial reports. In the next step, the processing unit 17 instructs the identity code generator 21 to sign digitally the relevant partial reports. The partial reports thus signed can be posted in accordance with the optimal distribution strategy.

The task of the operator unit 23 is to establish communication between the operator and the processing unit 17. It may have the following subassemblies: high resolution colour display, keyboard, IT interfaces and drives.

The following tasks can be carried out from the operator unit 23: registration with the traffic control system, displaying a flight clock, specifying the flight plan from the aircraft, different map display requests for the traffic control system, and displaying image information for the operator. The image displays can be different map displays, e.g. a navigation map, altitude map, meteorological map, or current dangerous and prohibited air spaces, and furthermore the aircraft's identity code in the navigation map, displaying the optimal glide path, presenting die traffic situation of an arbitrary zone, retrieving general traffic information and displaying the response for the operator, in addition to providing a visual and audible alarm for general warning and emergency purposes.

The task of the on-board telephone exchange 24 is to integrate the on-board GSM devices into the traffic control system or into the external and internal telecommunication network. The devices connected in this way, being integrated into on-board and off-board IT and telecommunication networks, can be operated in an unchanged way from the aspect of the user, making their system of services accessible.

It is essential for the operation of the system that when the GSM device is connected by wire to the object centre 2, it should automatically send its own phone number and identification vector, respectively—i.e. it starts a simulated GSM communication protocol—to the on-board telephone exchange 24, and furthermore after being integrated into the traffic control system, the on-board telephone exchange 24 blocks, as a confirmation of the integration, the radiofrequency broadcast of the GSM device's antenna It is possible to design a modification, in which, when the GSM device is connected through a wire, the GSM device independently prohibits either electronically or mechanically the radiofrequency broadcast of its own radioantenna.

It is an important circumstance that, in order to safeguard traffic security, after the GSM device is disconnected on-board, it continues blocking the radiofrequency broadcast of its own antenna, and then in the next step, it requests permission from the user to be linked via the antenna to the GSM network. The receiving of the permission and the reconnecting to the GSM network are indicated to the user.

Depending on the configuration, two variants of design are possible. The case of the communication executed within the traffic control system is the following.

After connecting the GSM device, the on-board simulated GSM communication is exclusively implemented through a wire-based IT contact between the GSM device and the on-board telephone exchange 24.

The GSM device is integrated into the traffic control system in the following way. In the first step, the relevant GSM device is connected at the installed wire-connection point, which in the case of aircraft is preferably fitted into the backrest or into the armrest, and this automatically launches the simulated GSM communication, i.e. it sends its own phone number and identification vector, respectively, to the on-board telephone exchange 24. The on-board telephone exchange 24 then dates the receipt of the personal phone number and identification vector from a given port links them with a logical tie to the identifier of the relevant port, and if it is the coordinator, issues a GSM antenna blocking command, and then it confirms the connection into the on-board system to the relevant GSM device.

In the second step, under the co-ordination of the processing centre 17, the on-board telephone exchange 24 prepares a report for the regional control unit 35, said report includes the phone number and the identification vector of the devices connected and the identity code of the relevant object centre 2.

In the third step, the regional control unit 35 stores the system of the logically linked identity codes and phone numbers in the GSM communication database. Next, through the IT unit 36, it informs the communication centres 45 linked with the given phone numbers about redirecting the relevant phone number to the traffic control system. The calls received from the connected communication centres 45 reach the relevant regional control centre 35. And finally, in a customised manner, the system of integrated GSM devices is confirmed to the relevant object centres 2.

When a call is initiated from the object centre 2, the device initiating the call sends the phone number of the device to be called to the on-board telephone exchange 24, which, with the assistance of the processing unit 17, prepares and posts a report to the relevant regional control unit 35. The report includes the identity code of the relevant aircraft, the phone number of the calling party and the phone number of the called party.

The IT unit 36 of the regional control unit 35 establishes the telephone communication with the communication centre 45 associated with the task on the basis of the report received, or in the case of the called device being linked to an object centre 2, with the on-board telephone exchange 24 of the relevant object centre 2. The optimal radio retransmitter unit 3 and the stationary satellite transceiver 8 for the fulfillment of the relevant task is selected by the regional control unit 35 with the assistance of the control device 32.

When the call is not initiated from the object centre 2, the process takes place in a similar way but in a reversed logical sequence.

In case the communication is not carried out in the traffic control system, the simulated GSM communication protocol is set up as follows. In the first step, the on-board telephone exchange 24 blocked the radiofrequency broadcast of the relevant GSM device after connection, or the latter was blocked mechanically. After linking the GSM device, the on-board simulated GSM communication is exclusively implemented through the IT contact between the GSM device and the on-board telephone exchange 24. It is an important circumstance that primarily the wire communication is preferred in aviation, but radiotechnology based communication may also be set up using the frequency permitted by the authority.

The on-board telephone exchange 24 does the following. In the first step—after the diagnostic test of the IT contact—it dates the receipt of the GSM device's own phone number and the identification vector, respectively, from the given port, linking them logically to the identifier of the given port In the second step, it submits a request to the communication unit 24a of the on-board telephone exchange to assign one of the communication channels made suitable for implementing a simulated GSM communication to the relevant task The communication unit 24a of the on-board telephone exchange assigns the relevant communication channel, confirms it to the on-board telephone exchange 24, and furthermore posts the logical identification code of the assigned channel. In the third step, on the basis of the logical identifier code of the assigned channel, the dynamic database of the communication channel assigned to this task within the communication unit 24a of the on-board telephone exchange is loaded up with the telephone number and identification vector of the given GSM device. The communication unit 24a of the on-board telephone exchange carries out the adaptation of the given communication channel with the new telephone number and identification vector, i.e. the integration of the given simulated channel into the external communication and telecommunication network, respectively. In the fourth step, with a data processing running in parallel with the third step, it logically links the identifier of the port established in the first step with the identifier of the communication channel appointed for the task in the second step.

On the side of the GSM device, the simulated GSM communication protocol handles the GSM device as a workstation, no radiocommunication data processing and radiotechnology communication take place in its system, and furthermore the computer technology co-operation of the GSM device and the on-board telephone exchange 24 is done by the system programmes of the above mentioned objects. In the given protocol, the data pre-processing units of the GSM device are used, and then at this point the data channel is branched to the wire link. In the case of a conventional mode of operation, the data channel passing through the above mentioned point is guided to the units of the GSM device that generate radio communication.

It is an important circumstance that by the on-board application of the given simulated GSM communication protocol, the on-board telephone exchange 24, in the case of any GSM device fitted to its network, is able to interconnect them on-line in an information technology manner, while using the own phone numbers of the GSM devices.

It is also an important circumstance that when the given simulated GSM communicated protocol is adapted in the conventional wire type telecommunication network, wire communication can be conducted by GSM devices prepared for this task, and at he same time retaining the service system of GSM devices.

The task of the communication unit 24a of the on-board telephone exchange is to implement satellite telephony and simulated GSM communication, respectively, among the on-board GSM devices and the installed communication terminals used by the passengers and the crew, and between other communication centres having similar characteristics and the already installed conventional communication centres. The technical characteristic is that it is suitable even for a multinorm system satellite telephony and GSM communication implementation, and that the telephone numbers and identification vectors of the communication channels handled by it—and made suitable for simulated GSM communication—represent a dynamic database. These parameter vectors are loaded or overwritten by the on-board GSM devices, under co-ordination from the protocol that carries out the simulated GSM communication.

The task of the diagnostic unit 22a of the vehicle is to control and supervise the operation and operational quality of the various technical equipment of the vehicle. The operational principle of the unit is identical with the operation of the on-board diagnostic unit 17a It is a special service rendered by the system that in case it detects a fault, it instructs the data acquisition unit 22c to retransmit the primary database on-line (as discussed for the relevant unit).

In case the diagnostic unit 22a of the vehicle judges the operation or the reliability of the operation of any unit or technical unit under its supervision to be critical, it draws up a notification report about the relevant event for the on-board voice generator 17dThe notification report includes the identifier of the vehicle's diagnostic unit 22a and that of the process having revealed the danger, the identifier of the diagnostised subassembly and technical unit, the value of the critical parameter vector and the degree of risk level.

On the basis of the parameter vector featuring in the report read in, the on-board voice generator 17didentifies and assigns the database supporting the execution of the task and reads it in. Next, it notifies the processing unit 17 and requests for itself the splitting of the user audiofrequency data channel assigned to the relevant task After that the processing unit 17 has given its confirmation and the requested audio frequency data channel has been split, the on-board voice generator 17d performs its task.

Through the autopilot coupling unit 22b, the autopilot of the vehicle co-operates with the traffic control system. This co-operation means that the dynamic route plan provided for it by the regional control unit 35, the regional space-information unit 37 and the processing unit 17 is followed. It is a requirement to be met by the autopilot of the relevant vehicle that it should be able to receive the system of regulation parameters received as a command signal directly for it from the processing unit 17 via the autopilot coupling unit 22b acting as an IT interface.

The data acquisition unit 22c is an integral part of the larger aircraft and ships, but its use has not yet become common in small plane aviation. If there is an on-board data recording unit (black box) on the relevant vehicle, its fitting to the traffic control system is carried out simultaneously with registration In this case it is the task of the object centre 2 to transfer the data recorded by the black box in the form of reports to the actual regional control unit 35, at discrete times determined by the processing unit 17. If there is no black box on the relevant aircraft, the data acquisition unit 22c of the aircraft serves in the traffic control system for data registration tasks not carried out by the on-board unit 2.

The data collected by the data acquisition unit 22c comprise the measurements made by the conventional instruments, the commands issued by the operators, the reports communicated by the processing unit 17, by the on-board health care centre 17c and by the diagnostic units 22a, as well as external and internal radio communications. The tasks of the data acquisition unit 22c include the creation and short time storing of the primary database of the collected information.

The data acquisition unit 22c of the aircraft collects the data intermediated by the peripherals carrying out data acquisition, prepares the primary database, and carries out the compressing as well as joint short-term storage of the databases. In a continuous mode of operation, at discrete times, the processing unit 17 issues commands to the data acquisition unit 22c for reading out the edited and compressed primary database and transferring it to its own IT output. The processing unit 17 forwards the edited and compressed database to the related database of the regional control unit 35.

Main Control Centre 12

The main control centre 12 shown in FIG. 5 consists of the following units: control device 32, central identity code generator 32a, IT centre 32b, central diagnostic unit 32c, space-information unit 33, traffic situation monitoring unit 33a and central database 34. It is not necessary to implement the main control centre 12 as an independent unit or on a hardware basis.

The units of independent configuration working under the supervision of the main control centre 12 can be suitable for sending and receiving asynchronous messages (after sending a message, the relevant object does not wait for the response, but carries out further operations), and they can be capable of handling competitions within the object (be able to receive reports from a different object while working on processing the previous one as well).

The units working under the supervision of the main control centre 12 are software-hardware systems suitable for parallel data processing. The operation of the relevant software-hardware systems can be modelled or replaced by a software package prepared for the relevant system of tasks. It is possible to design a variation in which the relevant units are integrated under the software system of the main control centre 12, via a software package that models and substitutes the task system belonging to them.

The functions of the main control centre 12 may also be performed by the software and hardware modules implemented on the computer network consisting of regional control centres 4.

The task system of the control device 32 is the following:
Co-ordinating the work of the regional control centres 4 under its supervision. Breaking down the actual and planned global traffic tasks to regional traffic zones, and assigning the regional control centres 4 associated with the relevant tasks.
Controlling the handling of traffic control tasks reaching beyond the area of regional traffic control tasks and taking place in the border zone of regional traffic zones, based on the work of the space-information unit 33.
Extending the regional optimal IT communication strategy to a global-level, global optimal IT communication strategy. This task is carried out on the basis of the reports received from the regional control centres 4 about the regional optimal IT communication strategy of the relevant traffic zone. The resolving process of optimising is the same as the procedure to be discussed below in relation of planning and implementing the regional optimal communication strategy.
Reconciling the digital clock signal of the regional control centers 4 in a continuous mode of operation, at discrete times. (If the GPS detailing procedure preferred by the traffic control system is applied by all objects integrated into the network, this step is not required).
Assisting the work of the regional control centres 4, and furthermore in case they break down, replacing the faulty units on a reduced mode of operation basis, or transferring this work to the competence of an identical unit within a different regional control centre 4.

Transferring the actual tasks to the different regional centers 4 and assisting their work mean the following:
Compensating the satellite-based co-ordinates associated with the co-ordinates of the vehicles monitored within the traffic zone of the faulty regional control centre 4, i.e. taking over the task of the satellite-based navigation compensator unit 4]. This is carried out by the control device 32, based on the central database 34.
The space-information unit 33 takes over and carries out the dynamic planning and handling of the route of vehicles monitored in the traffic zone of the faulty regional control centre 4. This means that the tasks of the regional space-information unit 37 are taken over. To resolve this task, the database relative to the task are located in the database of the space-information unit 33 and in the central database 34.
The regional diagnostic unit 35a of the regional control centre 4 appointed by the control device 32 takes over and carries out the diagnostic testing of the vehicles monitored in the traffic zone of the faulty regional control centre 4.
The regional traffic situation monitoring unit 38 of the regional control centre 4 assigned by the control device 32 takes over and carries out the monitoring of the traffic situation of vehicles monitored in the traffic zone of the faulty regional control centre 4.
The work of the visual processing centres 5 in the traffic zone of the faulty regional control centre 4 is taken over and performed by the photogrammetric unit 39 and the external status monitoring unit 40 of the regional control centre 4 assigned by the control device 32.

The assignment of the regional control centres 4 is decided on the basis of personal and forecast workload associated with the relevant system of tasks. The related tasks are calculated and posted by the central diagnostic unit 32c of the relevant regional control centre 4.

The technical diagnostic test of the system of regional control centres 4 is carried out by the central diagnostic unit 32c. The control device 32 makes its related decisions on the basis of interpreting the diagnostic reports of the central diagnostic unit 32c and the diagnostic reports drawn up by the regional diagnostic unit 35a associated with the actual regional control centre 4.

It is closely associated with the optimal performing of diagnostics is to extend the regional optimal IT communication strategy to a global level, global optimal IT communication strategy. The optimal IT communication strategy is handled jointly with the task control and task splitting optimisation problem.

It is closely associated with resolving the task redirecting tasks discussed above is inform the communication centres 45 fitted to the faulty regional control centres 4 about redirecting the related IT communication. The target IT centres appointed for redirecting will be the communication centres 45 fitted to the regional control centre 4 subjected to redirecting. The relevant notification reports are drawn up by the control device 32.

The central identity code generator 32a is a specific peripheral, the operation of which is co-ordinated by the control device 32, which compiles the content of and prepares the material of the actual report In the next step, upon the instructions of the control device 32, the central identity code generator 32a prepares the digital signature of the relevant report The reports so signed can be posted by the IT centre 32b.

The task of the IT centre 32b is to establish an IT contact between the control device 32 and the related regional control units 35. According to the configuration, the relevant contact can be provided by a terrestrial installation network or by a network comprising the retransmitter satellites 7a. In a railway implementation, the configuration is adjusted to the communication procedure applied there.

The task of the central diagnostic unit 32c is the diagnostic supervision of units making up the main control centre 12, and the diagnostic supervision of the regional control centres 4 integrated into the system of the main control centre 12.

The diagnostic supervision of the units making up the main control centre 12 means the supervision of the control device 32, the IT centre 32b, the space-information unit 33, the traffic situation monitoring unit 33a and the central database 34. The diagnostic tests cover the system of programmes and procedures in association with the relevant unit as well as diagnostic testing of the hardware.

In the course of diagnostically supervising the system of the regional control centres 4, the central diagnostic unit 32c makes a decision on a proposal about the technical status and functionality of the regional control centres 4, on the basis of the diagnostic reports sent by the associated regional diagnostic units 35a. The main control centre 12 makes its decisions on the basis of a proposal related to the relevant diagnostic results.

The task of the space-information unit 33 is the coordinated global extension of traffic organisation tasks handled in a regional way within the system of the regional control centres 4. In a railway implementation, it is adjusted to the techniques applied within the system of the object centres 2 and the regional control centres 4.

In the course of a global level dynamic matching process of the flight plan, a dynamic route planning is performed, organised by the relevant regional control centres 4. The regional control centres 4 in the traffic control system carry out the relevant work in a continuous mode of operation, at discrete times. The task of the space-information unit 33 is the global-level dynamic extension of the above mentioned regional dynamic route planning tasks. As the first step of this process, the control device 32 receives the static traffic plans and the priority system of the registered vehicles from the regional control centres 4 fitted to the traffic control system. These plans are redirected to the space-information unit 33.

In the second step, the space-information unit 33 performs a preliminary global traffic plan matching and coordinating task This task comprises the tackling of the following partial tasks:
A selection process to determine the traffic plans requiring global planning and the tasks that can be resolved by regional traffic organisation.
Preparing the regional control centre 4 network level plan of the tasks requiring global traffic planning.
Drawing up the preliminary global level traffic plan of the tasks requiring global traffic planning.
Providing customised information to the relevant regional control centres 4 on the regional route matching and planning tasks, on the system of traffic plans returned to the centre's own scope and on the system of global traffic plans involving the regional scope, and furthermore a request for tackling the given task.

In the third step, the regional centres 4 carry out the following task:
They integrate the traffic plans returned to their competence into the system of relevant regional traffic plans.
On the basis of the preliminary traffic plan drawn up by the space-information unit 33, they integrate the traffic plans involving their competence into the system of relevant regional transport plans.
They inform the control device 32 on the regional level acceptance of the global traffic plans involving the space-information unit 33, on the basis of its own regional traffic plans, and make a proposal on a regional level replanning of the global traffic plans and on a global integration of a new plan. At that time information is given on the draft traffic plan elaborated by the centre's own regional space-information unit 37 involving the own regional zone of the relevant global traffic plan.

In the fourth step, the space-information unit 33
acknowledges the regional and global traffic plan system accepted by the regional control centres 4;
regarding the system of global traffic plans about which the related regional control centre 4 has suggested a modification, performs a traffic plan elaboration again and informs the system of involved regional control centres 4 about the new preliminary traffic plan. Now an iteration process is launched, with a feedback to the third step, thereby providing a central plan approved by the regional control centres 4.

The space-information unit 33 includes a central space-information database, which comprises:
The system of global static route plans and related priorities.
A system of regional static route plans and related priorities.
A system of global dynamic route plans featuring as a proposal.
A system of regional dynamic route plans featuring as a proposal.
A system of dynamic route plans integrated into the traffic control system in a global way.
A system of dynamic route plans integrated into the traffic control system in a regional way, by the regional control unit 35 responsible for the relevant zone.
A global 3D map.
The global and regional dangerous and prohibited geographic zones and their determining parameters.
The long-term data line of the co-ordinate data of the vehicles integrated into the traffic control system in a global and regional way.
The global geographic zone's meteorological map subjected to an updating oriented loading.
The system of standard traffic routes and their parameters involving the global traffic control zone.
The timeline of short-term co-ordinate data of the global traffic routes supplied by the regional land traffic manager centre 46, and the mathematical model of the route covered.
The system of regional space-information databases of the regional control centres 4 under its supervision.

The performance of the global traffic safety tasks also is also included in the responsibility of the space-information unit 33. The regional level handling of the traffic control tasks is the task of the regional control unit 35 in charge of the work of the relevant regional zone. It is an important circumstance that the traffic zones are not confined by sharp boundaries. There is a double traffic control activity in a predetermined zone along the given border lines, in order to ensure the safety of performing traffic organisation tasks. After that the relevant vehicle arrives in the border zone, two traffic control systems operating in parallel carry out co-ordinated organisation tasks, namely the regional control centre 4 responsible for the relevant traffic zone and the main control centre 12.

The co-operation can be divided into two separate system of tasks:
The planning and matching process of dynamic traffic plans takes place in an automatic and continuous way in the case of both systems. For each route associated a global transport task performing vehicle, the planning and matching process is carried out in a global way, disregarding the traffic zones.
The performance of the traffic safety tasks associated with the traffic control tasks within the border zone of regional zones is carried out in the case of all vehicles moving in or accidentally entering the border zone of regional zones, regardless of the global or regional level of the traffic plan. The performing of this task system is co-ordinated by the traffic situation monitoring unit 33a, and its work is supported by the space-information unit 33.

The task of the traffic situation monitoring unit 33a is the co-ordination of traffic safety tasks associated with the traffic control tasks. In a railway implementation, it is adjusted to the techniques applied in the system of object centres 2 and regional control centres 4.

The system of traffic safety tasks includes the automatic execution of the global route deviation procedure, the global dangerous altitude and its forecast automatic procedure in the case of aircraft, the automatic estimation of the remaining travelling time until the tuning points, and the automatic monitoring of global hazardous approaches.

In the case of vehicles participating in global transport, the protocol system associated with the relevant task system is executed by the air situation monitoring unit 33a during the full period of the traffic task.

In the border zone of regional zones, in the case of vehicles participating in a regional traffic task or entering this border zone accidentally, performing the execution of the task system carried out in the following way:

If a vehicle arrives in a traffic border zone, the traffic situation monitoring unit 33a as a second traffic control system co-ordinates and conducts the system of procedures above, in parallel with the regional control centre 4 carrying out a regional control and in a continuous mode of operation.

If the traffic route deviates from the one dynamically planned to such degree that it reaches or violates the boundaries of dynamically planned traffic zone, or a vehicle not integrated into the traffic control system is involved, the traffic situation monitoring unit 33a performs the task system of the second traffic control system and furthermore when the vehicle enters a new traffic zone, it transfers the appropriate traffic control tasks to the regional control centre 4 responsible for the relevant zone.

The execution of the procedures related to the tasks listed, is identical with the execution of the tasks discussed in relation to the regional air situation monitoring unit 38 of the regional control centre 4.

The task of the central database 34 is to support the performing of the global traffic control tasks. The partial databases of the database are as follows:
The technical-technological database of the vehicles of which the traffic control system is aware.
The customised actual technical-technological database of the vehicles registered at least once with the traffic control system.
The technical-technological database of the global IT network of the traffic control system.
The system of the regional databases 35b of the regional control centres 4 working under the supervision of the traffic control system.

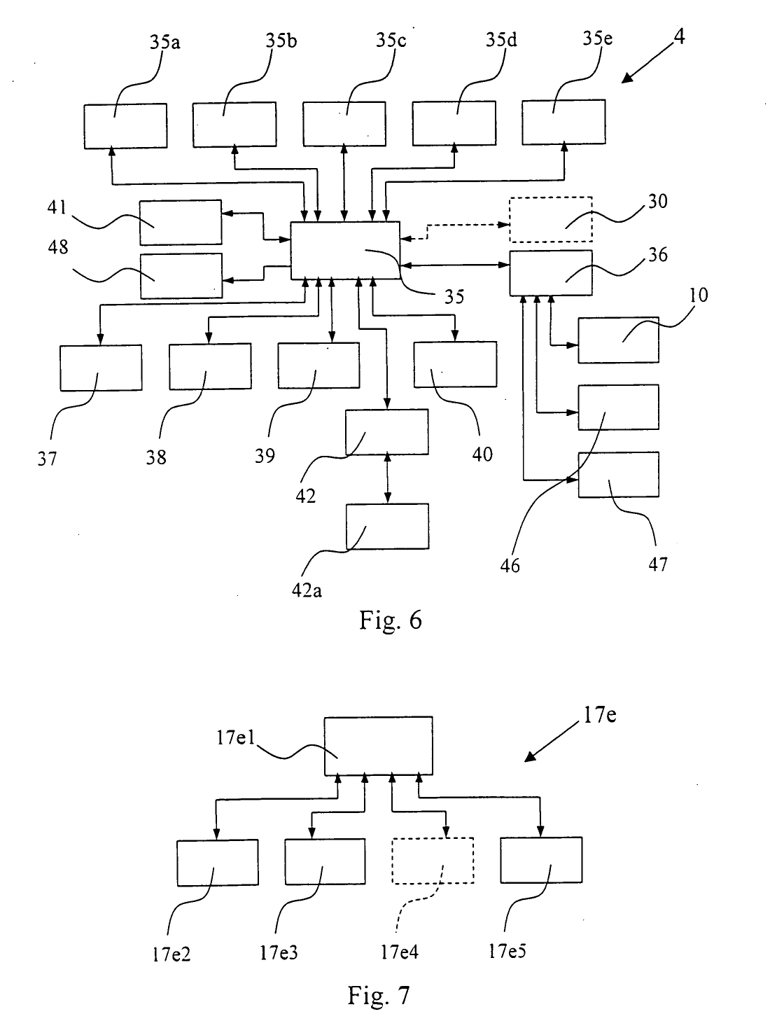

Regional Control Centre 4
The basic task of the regional control centre 4 shown in FIG. 6 is to perform the tasks which regard the control and supervision of the vehicles and fleets in the relevant regional zone and require external co-ordination.

The regional control centre 4 includes the regional control unit 35, the regional diagnostic unit 35a, the regional database 35b, the event logging unit 35c, the regional identity code generator 35d, the regional voice generator 35e, the IT unit 36, the regional space-information unit 37, the regional traffic situation monitoring unit 38, the photogrammetric unit 39, the external status monitoring unit 40, the satellite-based navigation compensator unit 41, the operator unit 42, the 3D virtual studio 42a, the regional signal improving unit 10, the regional land traffic manager centre 46, the regional information centre 47, and the medical centre 48.

Units working under the supervision of the regional control unit 35 are preferably software-hardware systems suitable for parallel data processing. The operation of the relevant software-hardware systems can be modelled or replaced by a software package prepared for the relevant system of tasks. It is possible to design a variation, in which the regional diagnostic unit 35a and/or the database 35b and/or the event logging unit 35c and/or the regional identity code generator 35d and/or the regional voice generator 35e and/or the IT unit 36 and/or the regional space-information unit 37 and/or the regional traffic situation monitoring unit 38 and/or the photogrammetric unit 39 and/or the external status monitoring unit 40 and/or the satellite-based navigation compensator unit 41 are integrated under the software system of the regional control unit 35 via the software package modelling or substituting the appropriate task system.

The independently configured units working under the supervision of the regional control unit 35 can be suitable for sending and receiving asynchronous messages (the relevant object does not wait for the response after sending a message, but carries out further operations) and they can also be suitable for handling competition within the object (can receive reports from a different object while working on processing the previous one).

If necessary it is possible to design a variation, where the regional control centre 4 optionally integrates the full configuration of the visual processing centre 5. If necessary, the units included in the visual processing centre 5 can constitute, under the supervision of the regional control unit 35, either independent information processing units or, according to the integrated design, a software package modelling and substituting the work of the given units and integrated into the software system of the regional control unit 35.

One of the tasks of the regional control unit 35 is to plan and implement the regional optimal IT communication strategy. In the case of a GSM-based communication, the relevant task is performed by the communication unit 45 and its associated units.

The different units included in the object centre 2 provide different types of information to the processing unit 17 and the regional control unit 35. The order of IT communication between the processing unit 17 and the regional control unit 35 requires an optimal communication strategy due to the type, size and priority of the relevant information and as a result of the IT workload of the traffic control system. The planning of the above mentioned communication strategy is the task of the regional control unit 3 5, about which the relevant processing units 17 are informed in the form of customised reports. These reports are posted by the actual regional control unit 35 in a continuous mode at discrete times to the processing unit 17 of the relevant object centre 2, said processing unit interprets it as a number one priority instruction. It will from now on perform IT communication on this basis. Hence, a customised and optimised IT communication is carried out by the traffic control system, within the system of the object centres 2.

The regional diagnostic unit 35a working under the supervision of the regional control unit 35 diagnoses in a continuous mode at discrete times the IT subsystem of the traffic control system. The regional control unit 35 optimises in a continuous mode at discrete times the IT communication strategy between the object centres 2 under its control and the databases and database operators accessible directly to the object centres 2 and/or the medical centres 48 and/or the regional land traffic manager centre 46 and/or the regional information centre 47 and itself. In the course of this process, it takes into consideration the following factors:
the type, size and priority of the data of the database transports planned by the regional control unit 35 and in progress on the IT network,
the computer technology and IT resources of the object centres 2 under its control and/or the databases and database operators and/or the medical centres 48 and/or the regional land traffic manager centre 46 and/or the regional information centre 47, about which the report describing the resources are sent by the processing unit 17 to the regional database 35b when registering with the traffic control system and when it changes, respectively (e.g. infrastructure development, the fact-finding report of the diagnostic unit controlling the work of the relevant unit),
the momentary and planned traffic situation on the basis of the database of the regional space-information unit 37,
the systems of installed and stationary radio retransmitter units 3, retransmitter satellites 7a and stationary satellite-based transceivers 8, in view of their IT workload, IT communication forecast and technical-technological data.
The time-shifting parameter characterising the IT communication established between the objects of the traffic control system. It is an important circumstance that there are regulation and control tasks between certain objects of the traffic control system, for example between the regional traffic situation monitoring unit 38 and the autopilot fitted to the object centre 2. Some of the regulating and control tasks of the traffic control system can be considered as a time-shifted regulating network. The performing of the above mentioned regulation and control tasks is based on the value of the time-shifted parameter.

From the aspect of the IT network, an optimal communication strategy means the strategy of a report communication route between a given object centre 2 and the actual regional control unit 35, and/or the on-line report communication route between a given object centre 2 and other object centres 2, and/or a report communication route between the databases becoming directly accessible to the object centres 2 and the database operators and/or the report communication route between the medical centres 48 and/or the regional land traffic manager centre 46 and/or an on-line report communication route between the regional information centre 47.

From the aspect of the regional control centre 4, the discussed strategy comprises first the combined/parallel and/or partial optimal communication strategy of the system of radio retransmitter units 3 working under the control of the regional control centre 4, the system of retransmitter satellites 7a and the system of stationary satellite-based transceivers 8, second the combined parallel and/or partial optimal communication strategy of the information technology resources available to the regional control centre 4 and third, according to the size and type of the files intended to be communicated by the actors and objects of the traffic control system, the selection of the compressing procedure and/or compressing rate and its compressing parameter and/or the selection of the applied and coding procedure.

It is possible to design a variation in which in the given strategy the combined/parallel and/or partial optimal communication strategy of the IT resources available to the radio retransmitter units 3, the retransmitter satellites 7a and the stationary satellite transceiver 8 appear also in the given strategy. Integrating the strategy of the above mentioned systems into the optimal communication strategy of the traffic control system is implemented in the first case through reports sent by the relevant systems to the regional control unit 35 and to the control device 32 (the traffic control system processes and adapts the relevant communication strategies), while in the second case joint optimal communication strategies are elaborated on the basis of joint work. The elaboration of the joint optimal distribution strategy from the aspect of the traffic control system is carried out by the regional control unit 35 and by the control device 32, respectively.

In case the number one priority optimal communication strategy posted by the regional control unit 35 cannot be applied to the file intended to be communicated, or there is no traffic control supervision, the discussed strategy is on the one hand the combined/parallel and/or partial application optimal communication strategy of the IT resources available to the object centre 2, i.e. the plan for splitting the work of the radio transceiver 19 and satellite-based radio transceiver 20, and on the other, according to the size and type of the files intended to be communicated, the selection and adjustment of the compressing procedure and/or the compressing rate, and die selection of the applied encoding procedure. In case the number one priority optimal communication strategy posted by the regional control unit 35 can be applied to the file intended to be communicated, the processing unit 17 follows this.

From the aspect of a given visual processing centre 5, the discussed strategy is logically identical with the procedure discussed in the case of the object centre 2.

On the basis of the test result of the IT contact, the optimal communication strategy of the traffic control system includes the surveying of the parameter of the time shift created in the IT communication between the objects in the network. A time shift parameter appears between the sending of the reports and the receiving of the response. In the case of certain tasks, e.g. object tracking, diagnostic regulation, and traffic control regulation, the traffic control system constitutes a time shifting regulation network. The regional control unit 35 applies the time-shift parameters during the co-ordination of regulation tasks, in the mathematical models used.

It is also the task of the regional control unit 35 to keep in touch with the external IT networks. Via the workstations linked to the external IT network, the external user is able to communicate with the traffic control system. The communication and display tasks between the workstations and the regional control unit 35 are carried out by a web page browser compatible with the traffic control system.

The browser to be used must be able to read the digital signatures of the traffic control system, be aware of the traffic control system's data compression procedures applied for external data and, in the case of a special user, be prepared for decoding the encrypting procedures applied by the traffic control system for an external IT network.

The regional control unit 35 makes arrangements if a request comes from the network regarding the visual tracking of a given vehicle. In case at the time of receiving the request, the relevant vehicle is under visual tracking, and there is no prohibiting instruction, an automatic web page presentation is implemented.

If, at the time of receiving the request, the relevant vehicle is not under visual tracking, in the first step the regional control unit 35 examines whether the request received can be met, i.e. on the one hand it makes a decision on appointing the visual processing centre 5 which performs the visual monitoring of the relevant vehicle, and on the other it examines the actual capacity in relation to the relevant task of the appointed visual processing centre i. Third, it examines the priority system of visual monitoring tasks carried out currently in the system of the appointed visual processing centre 5. In the second step, on the basis of a fuzzy logic, it makes a decision on performing the prescribed task. This is carried out on the basis of the actual co-ordinate data in the database of the regional space-information unit 37 and according to the technical-technological database in the regional database 35b of the visual processing centre 5. In the third step, in case the traffic and technical-technological conditions of the request are met, it prepares the task, and furthermore in a report it carries out the requesting of the appointed visual processing centre 5 for the relevant task in a report In the fourth step, the visual processing centre 5 appointed to carry out the task posts the digital image database associated with the requested task and formed into a report or an on-line report to the regional control unit 35. In the fifth step, the regional control unit 35 posts the image database in the form of a report or on-line report to the workstation which provided the request and on the other hand posts it to those units in its system which have been identified in the prescription of the task and are associated with the processing of the given database, and which units will perform the other necessary operations. Such a unit can be the photogrammetric unit 39 and the external status monitoring unit 40 as well as the 3D virtual studio 42a and the regional information centre 47.

In addition, a request may come from the network to display a given report in the associated web page. These reports can cover the following:
Presenting the vehicles under the control of the traffic control system on the web page, including the system of traffic plans integrated into the traffic control system, read out from the database of the regional space-information unit 37 and posted on a customised basis, the system of momentary co-ordinates, co-ordinate timelines and co-ordinate forecasts, as well as the speed co-ordinate timeline and speed co-ordinate forecasts of the objects under the control of the traffic control system, read out from the database of the regional space-information unit 37 and posted on a customised basis, and the public list of passengers, read out from the regional database 35b and posted on a customised basis.
The execution of tasks in association with the 3D aviation and task-specific traffic maps of an arbitrary geographic zone, and within this on the one hand the presentation of an arbitrary geographic zone in 2D and/or 3D manner, and on the other the presentation of traffic plans in a geographic 2D and/or 3D manner, read out from the database of the regional space-information unit 37 and posted on a customised basis.
Presenting the system of the dangerous or prohibited air spaces of an arbitrary geographic zone and/or the system of traffic junctions in an arbitrary geographic zone, read out from the database of the regional space-information unit 37 and posted on a customised basis.
Presenting the current traffic of an arbitrary geographic zone at a given moment, read out from the database of the regional space-information unit 37 and posted on a customised basis.
Presenting the meteorological map and meteorological data of an arbitrary geographic zone, read out from the database of the regional space information unit 37 and posted on a customised basis.
Presenting an arbitrary vehicle under the control of and known to the traffic control system, read out from the regional database 35b and posted on a customised basis.

The execution of the tasks discussed in the points above is carried out in the following way:

In the first step, the request received from the workstation in the external IT network fitted to the traffic control system and edited by the web page browser compatible with the system is supplied to the regional control centre 35. In the second step, the regional control unit 35 instructs the unit responsible for resolving the relevant task and the operator programme of the related database, respectively, to compile the result database associated with the given task. In the third step, on the one hand, the given unit and the database operator programme associated with the given database, after performing the task informs the regional control unit 35 about the execution of the task, and that the partial database sought is ready, respectively, and on the other hand, posts the latter in the form of a report via the contribution of the regional control unit 35 to the workstation that has made the request.

The request discussed above and concerning the tasks relative to maintaining contact with the external IT networks and/or to visual tracking, may not only come from the IT networks connected to the traffic control system, but also from any object centre 2. It is an important circumstance that the processing unit 17 of the object centres 2 is prepared for the on-board take over of the web tasks compatible with the traffic control system. The execution of the task received from the object centres 2 is identical with the discussion above, but in this case the customised reports are received through an IT channel of the object centre 2.

A new service rendered by the traffic control system according to the invention is the support of visual monitoring tasks. The co-ordination of the accomplishment of the task on a regional level is the task of the regional control unit 35, while the preparatory tasks are carried out by the visual processing centres 5.

Appointing the object centres 2 waiting for visual tracking can be started on the basis of two different requests, i.e. on the basis of a request initiated by the workstations in the IT network connected to the traffic control system, and on the basis of automatic vehicle appointing carried out on the basis of the decision made by the regional control unit 35.

In the first step, the regional control unit 35, in a continuous mode of operation and at discrete times, draws up a case study about the system of object centres 2 subject to monitoring.

In the case study, on the one hand, it compiles the system of the object centres 2 which are in the visual monitoring zone modelled by a visual processing centre 5, visually detectable through the application of the resources in the given system. On the other hand, it instructs the visual processing centre 5 selected for performing the visual monitoring task in the previous point to carry out a digital image sampling. The signal pre-processing unit 26 and the visual tracking unit 30 are responsible for performing the task of sampling. The visual processing unit 25 issues a report to the regional control unit 35 about the image display quality of the objects associated with the object centres 2 and modelled as suitable for monitoring.

In the second step, the regional control unit 35, on the basis of the image display quality report edited in the previous point, selects the system of objects that can be visually monitored. In the third step, on the one hand, it compiles a primary visual display priority sequence from the system of objects that can be visually monitored and are in fact under monitoring, and on the other hand, it compiles a secondary visual display priority sequence on the basis of the reports made by the regional traffic situation monitoring unit 38 and external status monitoring unit 40 of the regional control centre 4.

In the fourth step, on the one hand, in a continuous mode and at discrete times, and in view of the system of visual processing centres 5 it determines the actual appearance priority sequence in a customised way, according to the primary and secondary display priority sequences. The priority sequence of actual display can also be considered to be the appointing of the object centres 2 waiting for visual tracking. On the other hand, in a report, it requests the visual processing centres 5 assigned to the actual display priority sequence to carry out the relevant task, and posts the databases necessary for carrying out the tasks thus prescribed, i.e. it posts on-line the coordinate timeline of the selected object and its speed co-ordinate timeline as well as the forecasts of the listed timelines. The visual object tracking task is carried out by the visual tracking units 30 operating under the coordination of the given visual processing centres 5.

On the basis of the appointment of the object centres 2 waiting for visual tracking, the given regional control unit 35 makes a first-level decision in the following issues:
The rate of magnification to be applied to the relevant vehicle by the visual processing centre 5 assigned to the task. In the case of a request from the IT network, it takes as a basis the magnification parameter specified there. In the case of an automatic assignment, it takes as a basis a magnification parameter corresponding at least to the following: the type of visual monitoring tasks and/or the type of vehicle and/or the actual coordinate and/or actual speed co-ordinate data of the relevant vehicle and/or the actual meteorological situation and/or the results of the case study described above.
The first-level light/picture imaging spectrum parameter of the imaging to be applied to the relevant vehicle.

When the request is received from the IT network, it takes as a basis the imaging frequency parameter specified there. In the case of an automatic assignment, it takes as a basis an imaging frequency parameter corresponding to the following: the type of visual monitoring task and/or the type of vehicle and/or the actual co-ordinate and/or actual speed co-ordinate data of the relevant vehicle and/or the actual meteorological situation and/or the results of the case study described above.
Appointing the visual detector and identifier units working under the supervision of the visual processing centre 5 coordinating the execution of the given task, and the appointing of the visual identifier unit 11a. This is carried out on the basis of the regional database 35b.

The lowest appropriate magnification parameter thus determined and the imaging frequency parameter represent the first-level modelling of the visual tracking task

If necessary, the regional control unit 35 may instruct the object centre 2 to make its co-ordinate reports more frequent By means of the object centres 2 installed on-board, the vehicles operating under the control of the traffic control system transfer their satellite-based co-ordinate data for the regional control unit 35 in a continuous mode, at discrete times and in an equidistant manner. However, the frequency of the reports is not a static parameter, consequently its adjustment involving the actual object centre 2 and carried out on a customised basis is the responsibility of the regional control unit 35.

As the first step of adjusting the report-frequency parameter, on a customised basis and in a continuous mode of operation and at discrete times, the regional control unit 35 optimises the IT communication order of the traffic control system In the second step, on a customised basis, it examines the frequency parameter of coordinate reports.

The system of examined traffic situations and the related tasks are the following:
The relevant vehicle is in a landing or takeoff process or moving in or out. Now the regional control unit 35 carries out automatic appointing on the basis of the customised dynamic traffic plan and the short-term timeline of the actual co-ordinate data. In the course of this process, it relies on the database of the regional space-information unit 37.
The process is the same if the relevant vehicle carries out a system task, e.g. system flight in the zone of a geographic point.
Reasons driven by the actual traffic situation may also justify the modification of the frequency of reports. These reasons can be the following: dangerous approaches can be forecast and/or approaching of hazardous or prohibited geographic zone can be forecast and/or a significant deviation from the dynamically planned traffic route occurs and/or the aircraft is set to a landing or takeoff direction and/or satellite-based co-ordinate support is required for the visual tracking task of the vehicle and/or a special event other than the cases above is registered with the external status monitoring unit 40.

In the third step, the priorities of the frequency parameter of the co-ordinate reports of the object centres 2 examined in the second step are analysed on a customised basis.

In the fourth step, on the basis of the optimal communication strategy edited in the previous points and/or the frequency parameter of co-ordinate reports and/or the priority sequence of communicating the co-ordinate reports, the object centres 2 are reprogrammed on a customised basis.

The IT communication between the regional control unit 35, the object centre 2, the control device 32 and the IT networks attached to the traffic control system is carried out in the form of reports (electronic documents). The editing and the compilation of the relevant document packages is the task of the regional control unit 35.

The preparatory tasks carried out by the regional control unit 35 prior to posting are the following: planning an optimal communication strategy on a customised basis for the object centres 2, applying a data compression procedure to the relevant electronic documents, applying an encrypting and encoding procedure to the relevant partial electronic documents, and family the instructing of the regional identity code generator 35d to generate digital signatures.

It is an important circumstance that the regional control unit 35 may carry out direct IT connection on an on-line basis between arbitrary object centres 2, by converting the optimal communication strategy in association with the relevant task.

The report of the electronic document attached on a customised basis to the object centres 2 includes the customised digital signature and the public key associated with the regional control unit 35, the name of the compressing procedure applied to the relevant electronic document and the extent of compressing the name of the encrypting and encoding procedure applied to the relevant electronic document, and the compressed and encrypted document itself. Next, the report associated with the electronic document is posted according to the optimal communication strategy.

The regional control unit 35 is also responsible for serving the main control centre 12. Within this, the central space-information database of the space-information unit 35 associated with the main control centre 12 is served in a report like manner. This serving process is carried out in a continuous mode of operation at discrete times. In addition, the results of the regional traffic monitoring elaborated by the regional control centre 4 in charge of the relevant traffic zone for the vehicles carrying out the global transport task are also forwarded in reports to the main control centre 12 which carries out parallel data processing on them.

The regional control unit 35 also serves the object centres 2 in the following way. The co-ordinate data compensated by the satellite-based navigation compensator unit 41 and the visual satellite-based navigation compensator unit 41a are supplied in a report-like fashion to the object centre 2 which posts and/or requests the relevant co-ordinate data. The data are read out from the database of the regional space-information unit 37 in an automatic mode. The diagnostic results provided by the regional diagnostic unit 35a and the associated reports are forwarded to the object centre 2 which has submitted the diagnostic report The editing and posting of the associated reports are carried out in an automatic mode. The diagnostic results and/or the image diagnostics or image data are also forwarded after they are provided by the external status monitoring unit 40 and the visual processing centre 5, respectively. This is done in an automatic mode. Furthermore, the regional control unit caters automatically for adjusting the digital clocks for the units and objects of the traffic control system, especially the object centres 2, the regional signal improving units 10 and the visual processing centres 5, where in the traffic control system a GPS-based time adjustment prevails with a number one priority. In automatic mode it forwards the dynamic traffic plan report drawn up on a customised basis by the regional space-information unit 37 for the given object centre 2. The related database operators compile the digital 3D map database of the arbitrary zone, the database of the traffic plan, the database of the digital actual meteorological data and digital traffic map and the databases associated with the actual traffic situation and then automatically forward them to the requesting object centre 2. The regional control unit 35 furthermore provides access to the databases of the regional land traffic manager centre 46 integrated into the traffic control system and/or the regional information centre 47 and/or the medical centre 48. In addition, it makes sure that a contact is established between the GSM device fitted to the on-board telephone exchange 24 of an object centre 2 and the called telephone number, through the communication centre 45 fitted to the traffic control system.

The vehicles operating under the control of the traffic control system draw up short-period reports at certain intervals for the network of respective spotting satellites 7b. If the supervision of the traffic control system is interrupted, at the command of the processing unit 17 of the object centre 2, a report is posted including the following: the secondary database produced and compressed by the data acquisition unit 22c, the digital signature of the secondary database, and the public key of the object centre 2. This report is transmitted in a continuous mode, at discrete times. On the other hand, the object centre 2 sets to a continuous mode the operation of the satellite co-ordinate transmitter 20b.

The report drawn up by the network of spotting satellites 7b for the regional control unit 35 responsible for the given traffic zone includes the co-ordinate data constructed by them and the secondary database featuring in the report prepared for it On the basis of the report drawn up for it by the spotting satellite network 7b, and furthermore on the basis of the 3D co-ordinate data, supplementing the measuring procedures with radar measurements as well, the regional control unit 35has information about the co-ordinate data and actual technical status of the vehicle associated with the given object centre 2. If, on the basis of the signals of the satellite coordinate signal transmitter 20b, the regional control unit 35 considers the co-ordinate data calculated by the network of spotting satellites 7b in accordance with their accuracy and reliability to be of higher priority than the data calculated and forwarded by the satellite-based navigation receiver 18 of the object centre 2, it co-ordinates the traffic monitoring and the associated tasks on the basis of these data.

The regional control unit 35 organises the updating oriented loading of the space-information database of the space-information unit object 17b. After integration of the given object centre 2 into the traffic control system, the regional control unit 35 performs automatically the updating oriented loading of the relevant database.

The databases subjected to updating oriented loading are the system of dangerous and prohibited zones, the standby airports or naval ports required in the traffic plan, high resolution 3D or other databases, the actual data of landing guidance or lead-in systems associated with the given airport or naval port, the database of take-off and landing airports or departure and arrival naval ports, meteorological map databases, and an arbitrary database requested by the given object centre 2 and compiled by the regional land traffic manager centre 46 and the regional information centre 47.

In the first step of the updating oriented loading, a request for launching the updating procedure is received from the requesting object centre or the procedure is launched automatically after integration into the traffic control system. In the second step, with the assistance of the regional space-information unit 37, the requested database related to the route plan integrated into the traffic control system of the requesting object centre 2 and corresponding to the priority of the type and consignment of the vehicle, as well as matched to the technical-technological opportunities of the given object centre 2 is compiled. In the third step, the updating oriented database compiled by the regional control unit 35 is posted in a report and on a customised basis to the requesting object centre 2.

Automatic map loading and data updating to the object centres 2 are carried out under the supervision of the regional control unit 35. An automatic map downloading process is started in case:
The dynamic traffic plan of the relevant vehicle is notably different from the previously submitted static traffic plan. In this case, it is an automatic task to download the actual data and the 2D -3D map of the changed landing site and/or destination naval port, and/or the 2D -3D map and databases of the bypass traffic junctions.
The relevant vehicle, due to a deviation from the dynamic route plan, approaches a dangerous or prohibited zone. Now it is an automatic task to download the actual data and 2D -3D map of the approached dangerous or prohibited zone and/or the 2D -3D map and databases of the bypass traffic junctions.
An emergency arises in the engineering/technical system of the relevant vehicle.

When an emergency occurs, the procedure is launched by the following:
the on-board diagnostic unit 17a in the system of the relevant object centre 2 or the diagnostic unit 22a of the vehicle,
the regional diagnostic unit 35a of the regional control centre 4 responsible for the safety of the relevant vehicle,
the actual meteorological situation modelled with the contribution of the regional control unit 35 and the actual regional space-information unit 37, and
the report from the operator of the given object centre 2.

In this case, regarding aircraft and ships, the regional control unit 35, assisted by the actual regional space-information unit 37, seeks a provisional landing site or naval port on the basis of the standard data of the relevant vehicle and the actual meteorological data, and furthermore directs the dynamic traffic plan towards the relevant landing site and naval port, respectively. Now the automatic loading task comprises the downloading of the actual data and the 3D map of the assigned landing site and naval port, respectively.

The process of downloading the map is the following. In a continuous mode and at discrete times, the regional space-information unit 37 mathematically models the deviation of static and actual dynamic traffic plan. In case the deviation involves the data featuring in the static plan about the landing site and the destination port, respectively, it automatically starts the given map downloading and data updating process. Now the database to be modelled is the actual database of the landing site featuring in the dynamic plan and the actual database of the destination port.

The diagnostic test of the IT contact between the object centres 2 and the regional control unit 35 is carried out also by the processing unit 17 and the regional control unit 35. The related diagnostic procedures are started automatically, and they are run in a continuous mode at discrete times. The task of the process is to test diagnostically the IT relationship between the regional control centre 4 and the object centres 2 as well as between the other objects of the traffic control system.

The regional control unit 35 examines the integrity of the reports received from the processing unit 17, the visual processing centre 5, the regional signal improving unit 10, the control device 32, the regional land traffic manager centre 46, the regional information centre 47 and the medical centre 48. The reports received from the processing unit 17 are posted with a digital signature. It furthermore examines the IT diagnostics report returned in response by the units listed above to the electronic documents testing the IT relationship and posted by it previously. In this process, the substance of the response report and its return within the time limit are observed.

If, on the basis of the test result, the regional control unit 35 judges the IT contact to be unsatisfactory or interrupted, it launches the following procedures:
attempting, by means of a report message, to set to a maximum the frequency of the satellite-based co-ordinate reports of the relevant object centre 2;
attempting to instruct the involved object centre 2 in a report to set the satellite co-ordinate transmitter 20b to a continuous mode;
informing all involved regional land traffic manager centres 46, the regional information centre 47, the involved air traffic control centres and the regional control centre 4. The regional control centre 4 automatically informs the aircraft within the given regional control zone about the event, the identity code of the relevant aircraft, the co-ordinate timeline relying on the latest data, and/or the speed co-ordinate timeline and/or the timeline of co-ordinate and speed co-ordinate forecasts and furthermore about the mathematical model of the dynamically matched route plan associated with the given object centre 2;
informing all users, units and centres fitted to its network about the appearance of IT contact problems involving them.

The regional control unit 35 performs the processing of the primary database intermediated by the data acquisition unit 22c of the object centres 2. In the course of this process, on the one hand, the diagnostic partial database of the database posted by the data acquisition unit 22c is sent to the IT input of the regional diagnostic unit 35a, and on the other hand, the whole database is redirected for storage to the regional database 35b.

The regional control unit 35 is prepared for a reduced mode substitution of the tasks of the units it includes under its supervision, and also for assisting them on a reduced basis. If the relevant unit has an excessive workload, it requests the regional unit 35 to carry out some of its tasks on a reduced basis. Now the regional control unit 35 reports the appearance of the problem to the main control centre 12, and performs the substitution of the unit in a reduced mode. On the basis of the report from the regional diagnostic unit 35a, the regional control unit 35 may make a decision also about the non-functionally of the relevant unit In this case it reports the appearance of a problem to the main control centre 12 and performs the substitution of the relevant unit in a reduced mode.

In both cases above, the main control centre 12 makes a decision on whether to leave the reduced mode substitution to be handled by the given regional control unit 35 or to transfer the tasks of the unit to the joint scope of the identical unit or various units of a different regional control centre 4 or to integrate the tasks of the unit into the task system of its own units.

The regional control unit 35 performs the regional level syntactic and semantic analysis of the instructions identified in the electronic documents handled by the regional control centre 4 or in the internal IT contacts. Regarding the syllabus and logics, the procedure is identical with that described for the object centre 2.

The regional diagnostic unit 35a is a purpose-oriented computer fitted with its own appropriate size background storage capacity and target-oriented peripherals. The unit has two separate groups of tasks.

The first group of tasks is the system of procedures diagnosing the proper systems. The units involved in the diagnostic procedure are the following: the regional control unit 35, the regional database 35b, the regional identity code generator 35d, the IT unit 36, the regional space-information unit 37, the regional traffic situation monitoring unit 38, the photogrammetric unit 39, the external status monitoring unit 40, the satellite-based navigation compensator unit 41, the 3D virtual studio 42a and the regional signal improving unit 10.

Because of the technical difference of the units to be diagnosed, each unit subjected to a diagnostic procedure is associated with a separate diagnostic package of procedures and/or diagnostic signal detectors. Under the supervision of the regional control unit 35, the regional diagnostic unit 35a draws up and issues reports in a continuous mode and at discrete times for the control device 32. In the case of assisting the work of regional control centres 4 and in case they break down, the procedure followed by the control device 32 starts on the basis of the given diagnostic reports. The operation of the diagnostic procedure is identical with the procedure described in discussing the on-board diagnostic unit 17a.

It is integral part of the group of tasks to examine and prepare a forecast about the IT workload of the units subjected to a diagnostic procedure, and furthermore to examine the task resolving workload and its forecast. The control device 32 relies on the results so obtained when programming task-splitting problems within its responsibility.

The other group of tasks comprises the system of procedures that diagnose the vehicles and their object centres 2 integrated into the traffic control system. On the basis of analysing the diagnostic reports drawn up for the regional diagnostic unit 35a by the vehicle diagnostic units 22a of the object centres 2 fitted to the traffic control system, the regional diagnostic unit 35a issues control instructions corresponding to the units subjected to a diagnostic procedure and to the type of the relevant vehicle to the on-board diagnostic unit 17a regarding the selection of a diagnostic procedure to be applied and concerning the adjustment of the parameters of the diagnostic procedure to be applied.

The operation of the diagnostic process is identical with the process discussed for the on-board diagnostic unit 17a.

If the extent of diagnosed fault reaches a critical value, the regional diagnostic unit 35a instructs the regional traffic situation monitoring unit 38 to select a provisional landing site automatically and to effect automatic guidance.

If the regional diagnostic unit 35a judges the operation or the operational reliability of any unit under its supervision to be critical, it draws up a notification report about the given event for the regional voice generator 35e. The notification report includes the identifier of the active task group and danger detection procedure of the regional diagnostic unit 35a, the identifier of the diagnosed system, unit, subassembly and equipment, respectively, the vector value of the critical parameter and the degree of risk level.

On the basis of the parameter vector featuring in the report read in, the regional voice generator 35e identifies and assigns the database that will support the performing of the task and reads it in. Next, it notifies the regional control unit 35 and requests the splitting of the audiofrequency data channel of the user fitted to the processing unit 17 of the object centre 2 assigned to the relevant task After that the processing unit 17 has given its conformation and the requested audio frequency data channel has been split, the regional voice generator 35e performs its task.

An important part of the regional control centre 4 is the regional database 35b, which consists of the following partial databases.
The technical-technological database of the regional IT network of the traffic control system, which database includes the technical-technological data of the network consisting of the radio retransmitter units 3, the technical-technological data of the network consisting of the retransmitter satellites 7a and the technical-technological data of the network consisting of the stationary satellite-based transceivers 8.
The technical-technological database of the vehicle supporting the visual monitoring and traffic situation monitoring task, which database includes the traffic technology and technical database of the vehicles known to the traffic control system as well as the traffic technology-visual monitoring 3D database of the relevant vehicles.
The technical-technological database supporting the diagnostic tasks of the vehicles, which database includes the system of diagnostic procedures associated with the technical systems of the vehicles known to the traffic control system, the system of diagnostic procedures available to the diagnostic units 22a of the vehicles under the supervision of the traffic control system, and the diagnostic history of the vehicles registered with and being under the supervision of the traffic control system.
The technical-technological database supporting the diagnostic tasks of the object centre 2 network, which database includes the system of diagnostic procedures associated with the object centre 2 and known to the traffic control system, the system of diagnostic procedures available to the on-board diagnostic units 17a of the vehicles under the supervision of the traffic control system, and the diagnostic history of the object centres 2 registered with and working under the supervision of the traffic control system.
The database of technical-technological and geographical installation parameters of the visual processing centres 5 working under the supervision of the regional control centre 4, which database includes the system of procedures handled by the visual processing unit 25, the computer technology capacity of the units within the system of the visual processing centre 5, and the technical-technological, regulation and control technology database of the visual detector and identifier unit 11 and the visual identifier unit 1 la, and their geographical installation database.
The technical-technological traffic and traffic engineering database of the system of traffic junctions, such as airports and naval ports, within the monitoring zone of the regional control centre 4.
The type, the consignment, the freight characteristics and the passenger list of the vehicles using a route that crosses the relevant traffic zone.
The system of primary and secondary databases intermediated by the data acquisition units 22c.
The substance of the reports sent by the traffic zone signal improving unit 9 and the regional signal improving unit 10.
The system of resources of the object centres 2 working under the supervision of the regional control centre 4 and located in the given communication zone, with special regard to the system of hardware support procedures and to those systems that assist the various diagnostic activities and the work of the given object centre 2.
The system of partial databases supporting the regional voice generator 35e, i.e. the relevant database of the object centres 2, the textual database supporting the work of the regional diagnostic unit 35a and the textual database supporting the tasks of the regional traffic situation monitoring unit 38.

If necessary, it is possible to design a variation, in which the regional database 35b includes the database of the regional space-information unit 37 and vice versa, the database of the regional space-information unit 37 includes the regional database 35b.

The event logging unit 35c is a database that registers the regional level chronology of the reports received from different units. The database is loaded by the regional control unit 35 on the basis of the reports received by it The information stored in the database is the following:
The system of reports supplied by the data acquisition unit 22c from the different object centres 2, the system of diagnostic reports supplied by the diagnostic unit 22a and the diagnostic unit 27 of the vehicle, and the system of tasks accomplished by the processing unit 17.
The system of diagnostic reports supplied by the diagnostic unit 27 from the traffic manager system associated with the regional control centre 4, and the system of tasks received in the form of requests from the IT network associated with the traffic control system.
The system of tasks accomplished by the regional control centre 4.
The system of tasks accomplished by the visual processing centre 5.

The regional identity code generator 35d is a specific peripheral, the operation of which is coordinated by the control device 32, which compiles the content of and prepares the material of the report issued to the regional control unit 35. In the next step, the regional control unit 35 instructs the regional identity code generator 35d to sign the relevant report digitally. The reports thus signed can be posted by the IT centre 32b.

The task of the regional voice generator 35e is the audiofrequency conversion of its textual database determined by the associated units. In the course of the its operations, the unit receives instructions from a unit working under the supervision of the regional control unit 35 to carry out the relevant task The task is determined by the search unit, and it includes the address of the database and file that store the textual message sought Next, the regional voice generator 35e produces the required audio frequency message, and its IT switching for the appropriate user is performed by the IT unit 36 working under the supervision of the regional control unit 35 and also by the processing unit 17.

The task of the IT unit 36 is to co-ordinate the IT communication between the regional control unit 35 and the units connected to it on an IT basis. Part of the IT communication between the discussed units is carried out through the communication centre 45.

Through the communication centre 45, the regional control unit 35 is in an IT contact with the following units: the operator unit 42, the 3D virtual studio 42a, the regional signal improving unit 10, the regional land traffic manager centre 46, the regional information centre 47, the medical centre 48, the visual processing centre 5 and the IT centre 32b, with which IT communication may be established also by integrating a network comprising the retransmitter satellites 7a.

The system of IT networks integrated by means of the IT unit 36 is the following:
The system of regional IT centres 47 integrated into the traffic control system.
Land fleet management centres compatible with the traffic control system.
Land-based IT communication of the control device 32, if installed.
IT network communicating through the network of stationary satellite transceivers 8 of the retransmitter satellites 7a.
IT network comprising the radio retransmitter units 3.
Land-based IT network comprising the regional signal improving units 10.
Land-based IT network comprising the visual processing centres 5.
IT contact between the units comprising the regional control centre 4.
The exchanges of the various telephone networks.

The regional space-information database of the regional space-information unit 37 includes the following data.
The system of the mathematical models of the dynamic traffic plans of the vehicles registered with the traffic control system, in the case of an aircraft, the flight plan.
The system of the mathematical models of the static traffic plans of the vehicles registered with the traffic control system.
Regarding the vehicles located in the monitoring zone of the regional control centre 4, the long-term timeline of co-ordinate data compensated by the satellite-based navigation compensator unit 41, the short-term timeline of uncompensated co-ordinate data and as its attachment, the identity code of the satellites subjected to reading and the system of measuring results associated in pairs with the satellites subjected to reading, as well as the long-term timeline of co-ordinate data transmitted by the radar unit 43.
The 3D spatial position timelines of the vehicles located in the monitoring zone of the regional control centre 4.
The regional 2D -3D aircraft and traffic map.
The dangerous and prohibited airspaces and traffic junctions of the regional geographical zone.
The space-information traffic technology database of the system of traffic junctions, e.g. airports and naval ports within the monitoring zone of the regional control centre 4.
The regional geographical zone's meteorological map updated by updating oriented loading processes.
The system of standard traffic routes and their parameters involving the given regional traffic zone.
The co-ordinate and speed co-ordinate timeline of vehicles registered by the regional land traffic manager centre 46 and the mathematical model of routes covered.

In the various transport implementations, this database is compatible with that of the space-information unit 17b of the object centre 2, but it is expanded on a regional level.

The regional space-information unit 37 carries out the space-information modelling of the system of routes, and in a railway implementation, only the analysis of the time-proportionate nature of the route is performed. The task of the process is the correct and time-proportionate space-information modelling of the geographic co-ordinate of 2D -3D route plans received by the regional space-information unit 37, which handles the system of time-proportionate route plans mathematically modelled with the correct geographic co-ordinates jointly with the updated map-based databases located in the database of the regional space-information unit.

The regional space-information unit 37 participates in the dynamic route planning in the following way. Regarding the routes involving the given regional control centre 4, it makes a proposal to the space-information unit 33 operating under the supervision of the control device 32, concerning the routes to be handled on a global basis. The given proposal means an appropriate route plan even for the given regional control centre 4, which route plan can be integrated into the communication zone of the given transport zone.

The process of dynamic route planning corresponds to executing, in a continuous mode and at discrete times, the procedure discussed in connection with the regional level matching process of the flight plan. Hence, the system of relevant routes is always dynamically matched and updated in the traffic control system on the basis of the joint iteration activities of the regional space-information unit 37 and the space-information unit 33.

If the dynamically planned traffic route of the given vehicle clashes with the actual meteorological database, the regional space-information unit 37 instructs the regional traffic situation monitoring unit 38 to select automatically a provisional landing site and to ensure automatic guidance. Clashing means that in view of the type of the relevant vehicle, the actual and dynamically planned route involves such a meteorological zone that is considered as a prohibited airspace by the traffic control system. In case the regional space-information unit 37 does not have an opportunity to carry out the dynamic planning of a route bypassing the relevant area, it launches the above mentioned process.

The drawing up of an updating oriented loading report is of extreme importance from the aspect of improving traffic safety. Each object centre 2 automatically receives the loading database after registration and following the matching of its traffic plan. The automatic loading is coordinated by the regional control unit 35 and it is carried out by the regional space-information unit 37.

In the first step, the regional control unit 35 receives the registration report of the relevant vehicle, and then the regional space-information unit 37 and the space-information unit 33 perform the integration of the traffic plan associated with the given vehicle into the traffic control system.

In the second step, on the basis of the traffic plan associated with the given vehicle and integrated into the traffic control system, the regional control unit 35 compiles the database having the following substance.
The dangerous object system and actual determining parameters of the zones involved in the traffic plan.
The system of limited and prohibited airspaces in the zones involved in the traffic plan, and its actual determining parameters.
The actual meteorological plans (with the correct geographic co-ordinates) of the zones involved in the traffic plan.
In the case of aircraft and ships, the local traffic systems and specifics of the standby airports and naval ports.

In the third step, the compiled database is posted on a customised basis with the assistance of the regional control unit 35 for the object centre 2 of the vehicle intending to register with the traffic control system.

By means of the regional space information unit 37 it is also possible to post the actual traffic situation of an arbitrary traffic zone in a report like manner. In the first step of this process, the procedure associated with the given task can be launched by an instruction specified on the platform of the operator unit 23 of an object centre 2, on the basis of a request formulated in an automatic way by the processing unit 17 of an object centre 2, or on the basis of a request received from a workstation connected to the traffic control system, respectively. The request is received by the actual regional control unit 35.

In the second step, the regional control unit 35 instructs the regional space-information unit 37 under its supervision to generate on the basis of its database, by means of the operator software of the database, the database of the compensated actual co-ordinate data of the traffic zone identified in the task In the third step, the regional control unit 35, on the basis of the database compiled by the regional space-information unit 37, prepares the relevant report and forwards it to the object having prescribed the task, via the IT unit 36.

Posting the envisaged traffic situation of an arbitrary traffic zone is carried out in a similar way. In the first step, the process can be launched by instructions specified on the platform of the operator unit 23 of an object centre 2, or on the basis of a request received from a workstation attached to the traffic control system. The request is received by the actual regional control unit 35.

In the second step, the regional control unit 35 instructs the regional space-information unit 37 under its supervision to produce, on the basis of its database, the mathematical model of the static traffic plan system of the traffic zone identified in the task. In the third step, the regional control unit 35, on the basis of the database compiled by the regional space-information unit 37, draws up the relevant report and forwards it via the IT unit 36 to the object having prescribed the task.

As the first step of the regional level matching of the flight plan, the regional control unit 35 receives the static traffic plans and the system of their priorities. These plans are redirected to the regional space-information unit 37. In the second step, the plan system is forwarded to the control device 32, which subjects said system of plans to preliminary processing. In the third step, the control device 32 informs the regional control unit 35 on the regional route matching and planning tasks, and on the system of traffic plans returned to the proper competence of the given regional control centre 4, and furthermore on the system of global traffic plans involving the regional competence.

In the fourth step, the regional space-information unit 37 executes the integration of the traffic plans returned to its competence into the system of given regional traffic plans, and on the basis of the preliminary traffic plan system drawn up by the space-information unit 33 and involving its competence, performs the integration of the transport plans into the system of given regional transport plans. Thereafter, it informs the control device 32 on the basis of the system of own regional transport plans and proposes the regional level acceptance or regional level reorganization of the global traffic plans involving it and the global integration of the new plan. Then, it provides information on the draft traffic plan involving the own regional zone of the given global traffic plan and set up by its own regional space-information unit 37.

In the fifth step, the regional space-information unit 37 issues a report to the control device 32 on the tasks carried out Afterwards it co-operates again with the space-information unit 33 on the regional and global integration process of the given plan system. At the end of the iteration process discussed in association with the control device 32, a traffic plan system, integrated into the traffic control system is generated.

The regional space-information unit 37 informs the space-information unit 33 in a continuous mode and at discrete times on the system of actual data in its own regional traffic zone. The frequency of loading the various data, i.e. the frequency of drawing up a report is coordinated by the control device 32. The co-ordination is carried out on the basis of the reports drawn up for the regional control unit 35 by the control device 32.

Optionally, the 3D spatial situation timeline of the vehicles subjected to a monitoring test is produced by the regional space information unit 37. For carrying out the relevant task, the traffic control system uses a plurality satellite-based navigation receivers 18 and a plurality of satellite-based navigation antennas on the vehicle. The fulfillment of the task on a regional level is logically identical with the procedure described for the space-information unit 17b of the object centre 2. The 3D spatial situation timelines of the vehicles subjected to a monitoring test are stored on a regional level in the database of the regional space-information unit 37.

The task of the regional traffic situation monitoring unit 38 is to co-ordinate the traffic safety tasks of the vehicles under the supervision of the traffic control system in the regional traffic zone. This is ensured by a system of procedures conducted in a continuous mode and at discrete times.

The procedures are carried out in a similar way by the object centres 2 within their own competence, but in the case of aircraft under the supervision of traffic control, a parallel execution of task supervised by the regional control unit 35 represents a calculation of higher priority.

The fulfillment of the tasks is supported by the following databases and units: the regional database 35b, the database of the regional space-information unit 37, and—supporting the fulfillment of the tasks of the automatic selection of a provisional landing site and automatic guidance, a diagnostic report relative to the given vehicle and drawn up by the regional diagnostic unit 35a, a monitoring report applying to the given vehicle and drawn up by the external status monitoring unit 40, and additionally, the database of the regional space-information unit.

In the first step of the preparation process, the regional traffic situation monitoring unit 38 reads the coordinate database relating to the vehicles into the database of the regional space-information unit. In the second step, from the requested database, for the object centres 2 on a customised basis, the long-term 3D co-ordinate timeline forecast of the vehicle associated with the given object centre 2 and the long-term 3D speed co-ordinate timeline forecast are produced. In the third step, the procedures described below and carried out by the regional traffic situation monitoring unit 38 are launched.

In a process relating to route deviations, not used in a railway implementation, as the first step, the regional traffic situation monitoring unit 38 requests the regional space-information unit 37 to do the following:
Determine, on a customised basis, the distance between the actual co-ordinate data associated with the given object centre 2 and the associated dynamic traffic route plan at a given moment of time.
Determine, on a customised basis, the distance between the long-term 3D co-ordinate and speed co-ordinate timeline forecast associated with the given object centre 2 and the associated dynamic traffic route plan at a given time-proportionate moment of time.
Report those above to the regional traffic situation monitoring unit 38.

In the second step, on the basis of the results obtained:
Inform and alarm the relevant object centre 2 on the result of a forecast about approaching the given dangerous or prohibited geographic zones.
In the case of danger, it alarms the regional space-information unit 37 to minimise the deviation, i.e. to carry out immediately the dynamic route planning task. The task is performed in accordance with the technical-
technological characteristics of the related vehicle. In this case the system does not wait till the starting time of the next actual route planning process. It is an important circumstance that the regional control unit 35 coordinating the task can instruct directly the autopilot to follow a dynamic route that prevents dangerous deviations from the route. In case the degree of deviation from the route reaches a critical value, the procedure launches the automatic selection of a provisional landing site and automatic guidance.
In case the results edited in the first step reach a critical level, it draws up a notification report about the event to the object centre 2 and the regional voice generator 35e. The notification report includes the identifier of the danger detection procedure, the value of the given parameter and the degree of risk level. The object centre 2 displays the substance of the notification report on the graphic platform of the operator unit 23. If it is unable to support the relevant event with an appropriate audio frequency, the processing unit 17 and the IT unit 36 provide a free joint IT channel between the addressed user and the regional voice generator 35e, which—on the basis of the parameter vector featuring in the report read in—identifies and assigns the database that supports the execution of the task and reads it in.

In the first step of an automatic procedure to be carried out in the case of approaching a dangerous or prohibited geographic zone, the regional traffic situation monitoring unit 38 requests the regional space-information unit 37 to do the following:
Determine, on a customised basis, the distance to dangerous or prohibited geographic zones located in the zone of the actual co-ordinate data associated with the given object centre 2.
Determine the distance to the dangerous and prohibited geographic zones located in the zone of the long-term 3D co-ordinate timeline forecast data associated with the given object centre 2.

In the second step, on the basis of the results:
It informs and alarms the given object centre 2 about the result of the forecasts for the approaches to the given dangerous or prohibited geographical zones.
In the case of danger, it alarms the regional space-information unit 37 to carry out immediately the dynamic route planning task. The task is performed according to the technical specifics of the related vehicle. In this case the system does not wait till the launching time of the next actual route's planning process. The actual object centre 2 is informed on the results.
If necessary, the regional voice generator 35e is started up in a way already discussed.

In the course of the process relative to the automatic estimation of the remaining travelling time until the turning points, in the railway implementation of which the turning point is the railway junction or switch, in the first step the regional traffic situation monitoring unit 38 requests the regional space-information unit 37 to carry out, on a customised basis, the estimation of remaining travelling time until the next turning point in the associated dynamic traffic route plan is reached according to the actual co-ordinate data associated with the given object centre 2.

In the second step, on the basis of the results, it informs the object centre 2 on the result of the forecasts for the remaining time forecast until the turning point and, in the case of danger, it alarms the regional space-information unit 37 to carry out the dynamic route planning task immediately. In this case the system does not wait till the starting time of the next actual route planning process. In addition, if necessary, it starts up the regional voice generator 35e in a way already discussed.

In the course of a process relative to the automatic control of the landing and takeoff direction or, in the case of ships, the incoming direction, which is not used in railway implementation, in the first step, the regional traffic situation monitoring unit 38 requests the regional space-information unit 37 to do the following:
Prepare, on a customised basis, the space-information mathematical standard model of the relevant vehicle related to the given task, on the basis of the actual dynamic transport route plan valid up to the gate of the traffic junction, of the actual technical-technological database supporting the monitoring task of the traffic situation for the vehicle, of the space-information traffic technology database of the destination and departure traffic junctions and of the actual meteorological situation.
Execute the dynamic route planning task by making use of the space-information mathematical standard model the actual meteorological situation, the actual co-ordinate and speed co-ordinate and/or the co-ordinate and speed co-ordinate forecasts, and the actual technical-technological database regarding the vehicle and supporting the traffic situation monitoring task.

In the given case, the task of dynamic route planning represents the tracking task of the edited (plotted) space-information mathematical standard model.

In the second step, the regional traffic situation monitoring unit 38, on the basis of the results, informs the given object centre 2 about reaching the incoming or outgoing point, and about the edited (plotted) space-information mathematical standard model. In addition, it provides continuous information about the draft route dynamically plotted by it, and if necessary, it starts up the regional voice generator 35e in a way already discussed. It is able to handle this task also on the basis of the proper resources of the object centre 2. In this case, however, there is no dynamic traffic route planning, but traffic control is carried out on the basis of a standard space information mathematical model.

The regional control unit 35 is able to carry out the automatic monitoring of dangerous approaches only for the vehicles under the supervision of the traffic control system. If there is no traffic control supervision, the object centres 2 of the relevant vehicles enter automatic on-line communication. The IT network so established between the object centres 2 ensures the execution of the tasks arising. In the first step, the regional traffic situation monitoring unit 38, on the basis of the long-term 3D co-ordinate timeline forecasts and long-term 3D speed coordinate timeline forecasts involving the relevant regional traffic zone, models the momentary distance between vehicles in the given regional zone, and the long-term and short-term forecasts for the relative distances.

In the second step, on the basis of the data from the first step and according to the preparation procedure of the regional traffic situation monitoring unit 38, the procedures of the regional traffic situation monitoring unit 38 relative to route deviations, approaching dangerous or prohibited zones and dangerous altitude are initiated.

In the third step, on the basis of the results, the regional traffic situation monitoring unit 38 informs and alarms, respectively, the involved object centres 2 about dangerous approaches and about the result of their forecast, and furthermore in the case of a dangerous approach or its forecast, it alarms the regional space-information unit 37 to carry out a dynamic route planning process. It is an important circumstance that the regional control unit 35 co-ordinating the task can instruct the autopilot directly to follow a dynamic route which avoids a dangerous approach If the degrees of dangerous approaches for certain vehicles reach the critical value, concerning the relevant vehicles, the process for the automatic selection of a provisional landing site and automatic guidance is launched. Furthermore, the actual object centre 2 is informed on the results. In addition, if necessary, the regional voice generator 35e is started up in the way already discussed.

Of course, if in the given zone only the vehicles under the supervision of the traffic control system and performing its co-ordinating instructions are present, dangerous approaches are impossible to arise. The avoiding of dangerous approaches is ensured by a continuous and dynamic traffic route planning. In executing this task, the long-term timeline of co-ordinate data supplied by the radar unit 43 and stored in the database of the regional space information unit 37 is taken into consideration regarding the vehicles not necessarily integrated into the traffic control system.

In the first step of the automatic process relative to a dangerous altitude and its forecast, the regional traffic situation monitoring unit 38 requests the regional space information unit 37 to determine, on a customised basis, the distance between the actual co-ordinate data associated with the given object centre 2 and its normal projection onto the 3D map, and to determine, on a customised basis, the distance between the long-term 3D coordinate timeline forecast data associated with the given object centre 2 and its normal projection onto the 3D map.

In the second step, the regional traffic situation monitoring unit 38, on the basis of the results, informs or alarms, the given object centre 2 about the result of the dangerous altitude forecast and furthermore, in the case of danger, it alarms the regional space-information unit 37 to carry out the dynamic route planning task immediately. This task is carried out in accordance with the technical and technological specifics of the related vehicle. In this case the system does not wait till the starting time of the next actual route planning process.

If the dangerous altitude or its forecast reaches the critical value, the procedure starts up the process relative to the automatic selection of a provisional landing site and automatic guidance. Furthermore it provides information about the results for the actual object centre 2 and if necessary, it starts up the regional voice generator 35e in the way already discussed.

The starting of executing the process relative to the automatic selection of a provisional landing site and automatic guidance can be carried out automatically on the basis of instructions from the regional diagnostic unit 35a, instructions from the external status monitoring unit 40, instructions from the regional space-information unit 37, instructions from the process relative to route deviations, instructions from the process of automatic monitoring of dangerous approaches and instructions from the automatic process relative to dangerous altitude and its forecast. The execution of the process can be started furthermore on the basis of the on-board operator's request on the platform of the operator unit 23 of the object centre 2.

In the first step of the process, a request made in a way described above is received by the regional traffic situation monitoring unit 38 of the actual regional control centre 4, to start the execution of the task.

In the second step, the regional space-information unit 37 plans and selects the possible landing areas, assigning priority categories to them, on the basis of the database of the regional space-information unit, the regional database 35b, the actual soil quality and surface relief data received from the regional information centre 47 as well as in accordance with the results of the preparation process. The area having the highest priority category is selected for continuing the task.

In the third step, relative to the area selected in the previous point, it conducts the procedure relative to the automatic control of landing and takeoff direction, and, in the case of ships, of incoming direction. If necessary, it starts up the regional voice generator 35e in the way already discussed.

It is an important circumstance that the regional control unit 35 co-ordinating the task can instruct the autopilot directly to carry out the relevant task immediately.

The photogrammetric unit 39, which is not necessarily part of the system, carries out the visual detection of the vehicles not integrated into the traffic control system, and the estimation of the 3D co-ordinates of the vehicles in the visual detection zone of the given visual processing centre 5. The fulfillment of the task of the 3D co-ordinate estimation procedure is based on a co-operation between the photogrammetric unit 39 and the 3D virtual studio 42a.

The fulfillment of the task is supported by the database stored in the regional database 35b, concerning the technical-technological and geographical installation data of the visual detector and identifier unit 11 and the visual identifier unit 11a. It is possible to install the visual processing centre in a mobile version, the visual zone of which is not necessarily supported by radar control. In this case the photogrammetric service supplements the 3D coordinate determination of the visually detectable vehicles.

In the first step of the operation of the photogrammetric unit 39, the regional control unit 35 reads the digital images representing the result of visual discrete image samplings provided by the visual detector and identifier units 11 into the 3D virtual studio 42a. In the 3D virtual studio 42a, the operator carries out the image marking, thereby establishing a photogrammetric database.

In the second step, the regional control unit 35 reads the photogrammetric database provided by the 3D virtual studio 42a into the IT input of the photogrammetric unit 39, as well as the names of the visual detector and identifier units 11 having supplied the photogrammetric digital image databases.

In the third step, from the regional database 35b, the photogrammetric unit 39 reads in the technical-technological and geographic installation database of the visual detector and identifier units 11 having supplied the image databases.

In the fourth step, the photogrammetric unit 39 performs the photogrammetric calculations. As a result of the calculations, the calculated 3D coordinate data of the relevant vehicle from the geographical installation base-points of the visual detector and identifier units 11 that have supplied the image databases are obtained.

In the fifth step, the photogrammetric unit 39 forwards the calculated results to the regional control unit 35, which forwards it to the operator unit 42 for graphic display, to the workstations requiring the parameters, and furthermore to the regional space-information unit 37 and the space-information unit 33, which integrate the coordinate data of the given vehicle into the dynamic database of the real traffic situation.

From the aspect of technical design, it is preferable to set up the space-information unit 33 and the 3D virtual studio 42a in a combined configuration.

The external status monitoring unit 40 is not necessarily part of the traffic control system. The task of the unit is to examine the visually observable technical-technological status of the vehicle under the supervision of the traffic control system and in the visual monitoring zone of the visual processing centre 5, and to carry out visual object identification.

Starting the process relative to the examining of the visually observable technical-technological status can be done in two ways. On the one hand, in an automatic way on the basis of the discussion of visual tracking, in view of the priority sequence featuring there, and on the other, in a manual way, on the basis of a request received from a workstation operating in an IT network connected to the traffic control system. The workstation may also be the operator unit of the units included in the traffic control system.

The regional control unit 35 has the above mentioned process relative to the assigning of the object centres 2 waiting for visual tracking automatically carried out. In the first step featuring there, the vehicles that can be visually monitored become selected. On the basis of the given decision, if in the process the priority level of the given vehicle is appropriate and if there is available computer technology capacity for executing the given task, the following process is carried out automatically.

In the first step, on the basis of the discussion above, the given vehicle for the visual monitoring task is assigned.

In the second step, the procedure discussed in relation to the first-level modelling of the visual tracking task takes place automatically.

In the third step, the digital video information provided by the visual processing centre 5 and selected automatically in the previous procedures in relation to executing the given task is forwarded for further processing to the external status monitoring unit 40.

In the fourth step, the external status monitoring unit 40 does the following:
On a space-information basis (3D or 2D ), it models and produces the optimal visual external status 3D (2D ) database of the given vehicle relative to the given traffic situation, on the basis of the regional database 35b, the long-term timeline of compensated co-ordinate data reading from the database of the regional space-information unit 37, and the geographic co-ordinate data of the installation of the visual detector and identifier unit 11 or the visual identifier unit 11a supporting the given task and the dynamic traffic plan associated with the given vehicle. This is done by 3D modelling, then forwarding the given 3D model to the 3D virtual studio 42a.
As a safety function, simultaneously with the other parts of the procedure, it runs the visual object identification procedure. In case the identified type of the given vehicle and the type in the traffic plan are found to be identical, it accepts the result of the following procedure points.
It examines the distance between the 3D, or 2D visual diagnostic sampling database provided by the visual detector and identifier unit 11 or the visual identifier unit 11a, and the 3D, 2D image database of the optimal visual external status constructed as above. This is carried out through a 3D and 2D shape detection procedure.
It compiles the following reports: on the basis of the given distance it issues a report to the regional control unit 35 and transmits on-line the visual diagnostic sampling database to the 3D virtual studio 42a. Now the operator can examine 3D images directly.

If the extent of the visually diagnostised defect reaches a critical value, the external status monitoring unit 40 instructs the regional traffic situation monitoring unit 38 to select automatically a provisional landing site and to carry out an automatic guidance process.

Finally, the regional control unit 35 informs the given vehicle and the traffic manager centres in the given traffic zone in a report about the given visual monitoring results.

Starting the visual object detection process can be carried out in two ways.

The process is launched automatically if in the zone of a visual processing centre 5 the radar unit 43 linked through the radar interface unit 29 detects a vehicle not integrated in the traffic control system. In this case the regional control unit 35 starts the examination of the visually observable technical-technological status. The procedure of visual object identification is an integral part of the process, hence it starts automatically. It considers the co-ordinates supplied by the radar unit 43 as the co-ordinate data of the given vehicle. These co-ordinates are in the database of the space-information unit 37.

The process is started manually on the basis of a request received from a workstation operating in an IT network integrated into the traffic control system. This workstation can be an operator unit of the units included in the traffic control system. In this case, the regional control unit 35 launches the automatic procedure discussed above.

In the course of the unit's operations, in the first step, the procedure relative to the examining of the visually observable technical-technological status carries out the primary modelling of the visual examination of the given vehicle.

In the second step, the visual diagnostic sampling database provided by the visual detector and identifier unit 11 is compared on the basis of a pre-determined detection strategy with the visual monitoring 3D database relative to the vehicles and located in the regional database 35b. It accepts the mathematical model of the highest probability vehicle as a solution of the given task.

In the third step, it sends reports to the regional control unit 35 and furthermore transfers the visual diagnostic sampling database to the 3D virtual studio 42a.

The task of the satellite-based navigation compensator unit 41 is to compensate the satellite-based coordinate data transferred by the object centres 2, which are integrated into the traffic control system and located in the given traffic zone.

In the first step of the compensating procedure, it instructs the regional space-information unit 37 to read in the last read and not yet compensated co-ordinate data located in its database and the associated parameters. In the second step, it instructs the regional database 35b to read in the compensation process associated data of the satellites subjected to reading by the traffic zone signal improving unit 9 and the network of regional signal improving units 10. The database operator programme considers the basic sampling time of data as the measuring time of the not yet compensated co-ordinate data. In the third step, it carries out the compensating of the coordinates in question, forwarding them to the database of the regional space-information unit 37.

The regional control unit 35 posts the compensated co-ordinate data to the object centre 2 which has requested the performing of the task

A further task of the satellite-based navigation compensator unit 41 is to generate a uniform GPS time on the level of the regional control centre 4. This has been discussed in reference to the object centre 2.

The task of the operator unit 42 is to display the traffic processes taking place in the traffic system of the regional control centre 4 and in the traffic zone under its supervision, to the operator personnel. In the case of an automatic regional control centre 4, it is not necessary to set this up. From the operator unit 42, each procedure can be initiated manually and can be tracked from there.

The 3D virtual studio 42a is part of the operator unit 42. Its task is the 3D displaying of the intermediated 3D digital image information on the basis of the digital image information provided by the visual detector and identifier units 11 of the visual processing centres 5, as well as the supporting of the photogrammetric unit 39.

The 3D virtual studio 42a includes a stereo image monitor or stereo goggles, a mono image providing monitor and a 3D mouse. For performing the tasks of the 3D virtual studio 42a, in the first step the regional control unit 35 reads the digital images supplied by the visual detector and identifier units 11 into the 3D virtual studio 42a. In the second step, the operator of the 3D virtual studio 42a, on the basis of visual discrete image sampling missions, by means of the 3D mouse, performs the 3D assigning of an arbitrary point on the platform of the actual vehicle. The relevant assigning operation can also be carried out by means of automatic assigning. In the third step, the photogrammetric database plotted on the basis of the assignment is forwarded to the photogrammetric unit 39.

The regional signal improving units 10 constitute a network covering the regional traffic zone. Their task is to take the reading of the positioning satellites 6 covered by them, and to forward the data as reports in a continuous mode and at discrete times through the communication centre 45 to the regional control centre 4 responsible for the relevant traffic zone. In the regional control centre 4, on the basis of the signals of the regional signal improving units 10, the satellite-based position determination data can be made more accurate by prior art methods. An important part of the regional signal improving unit 10 is the identity code generator connected to the unit, which generator supplies each report prepared by the unit with the digital signature of the given unit, as well as a digital clock.

The report comprises the names of the satellites subjected to reading, the information provided by the satellites subjected to reading, the time of reading, the digital signature of the electronic document and the public key of the regional signal improving unit 10. The substance of the report is stored in the regional database 35b. The operation of the digital clock is carried out by the regional centre 4 responsible for the given area The regional land traffic manager centre 46 is a centre operating on its own and is integrated into the traffic control system, which is aware of the actual geographical co-ordinate data and traffic plan of the vehicles handled by it, the consignment and the characteristics thereof, as well as of the passenger list.

In a continuous mode, at discrete times, through the communication centre 45, the regional land traffic manager centre 46 redirects the actual co-ordinate data of the vehicles subjected to monitoring to the regional control centre 4 responsible for the given zone and through it to the main control centre 12. On the basis of the data, the regional control centre 4 and the main control centre 12 perform calculations regarding those parameters of the relevant vehicles that are under their traffic control supervision.

The regional information centre 47 connects different IT networks into the traffic control system. These are, for example:
other control systems, databases and information centre interface nodes of airports and naval ports, through which centres the traffic control system has an overall view of the envisaged and real traffic of the objects;
a data channel of the air and land fleet directed to transporters;
meteorological information and database centres.

The task of the stewardess monitor 17e shown in FIG. 7 is to determine the user's health care diagnostic test by the stewardess or by the user itself. The units of the stewardess monitor 17e work as follows.

The central unit 17e1 is responsible for coordinating the work of the subassemblies and furthermore for their IT connection to the on-board health care centre 17c. Preferably, the operational system supports the determination of the health care diagnostic tasks being feasible on it, with a graphic platform and a menu system. By the IT interface, the on-board health care centre 17c and the stewardess monitor 17e constitute a computer network, in which the stewardess monitor 17e is preferably featured as a %workstation having its own operational system. However, such a system can also be designed in which the stewardess monitor 17e is a terminal without its own operational system. Its electric and IT supply is provided in a parallel mode by the power supply and IT interface 17e3.

The stewardess monitor 17e includes the operator unit 17e2 consisting of the monitor subassembly and the keyboard subassembly.

Integrated into and fitted in the stewardess monitor 17e is the power supply and IT interface 17e3, which has a battery section of preferably removable design. The charging of this battery section is carried out through a separate adapter.

The stewardess monitor 17e includes an optional radio subassembly 17e4, the task of which is to ensure the wireless communication of the on-board health care centre 17c directly or through the processing unit 17. The type of communication provided by it is identical with the standard bluetooth technology, or with any other standard wireless local communication network solution Its work is co-ordinated by the central unit 17e1.

The stewardess monitor 17e can be of mobile design, for example a GSM device size target-oriented computer with its own graphic platform and task-oriented system programme. Furthermore, the stewardess monitor 17e may be fitted into the user's seat.

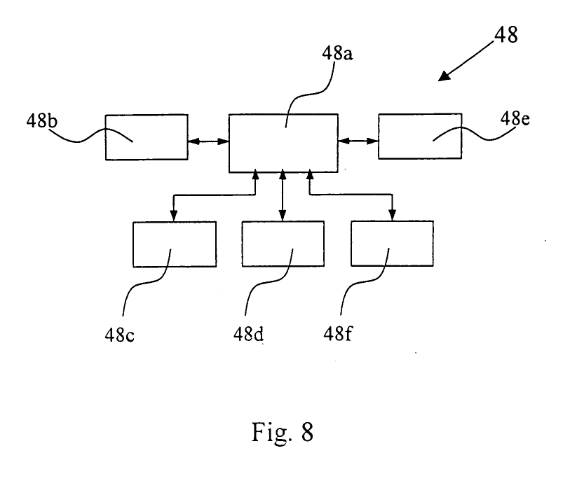

The medical centre 48 shown in FIG. 8 includes the central unit 48a, the IT unit 48b, the system of health care expert units 48c, the medical lab 48d, the identity code generator 48e and the health care database 48f.

The task system of the medical centre 48 is the following:
Loading the health care database 48f.
Performing the health care diagnostic test of the health care diagnostic measuring results received on-line and located in the health care database 48f, which diagnostic test has a higher priority than the examinations carried out by the on-board health care centre 17c and its expert subassemblies.
Co-ordinating the health care diagnostic work of the on-board health care centre 17c and its expert subassemblies on the basis of the results of the health care diagnostic models.
On-line posting of the health care diagnostic instructions and advice of physicians and technicians working in the medical lab 48d, to the user in trouble and to the involved stewardesses, respectively.

The IT unit 48b is responsible for establishing the IT contacts assigned to the task and for posting the reports. The object centre 2 posts on-line the measuring result database measured and produced by the on-board health-care centre 17c integrated into its system, to the medical centre 48, as well as the health care diagnostic results generated by the on-board health care centre 17c and its expert subassemblies.

The medical centre 48 performs the regional level storage of the health care diagnostic measuring results and forecasts provided by the on-board health care centre 17c and its expert subassemblies integrated into its system, in the health care database 48f. The loading process takes place automatically, and its process is coordinated by the system programme of the central unit 48a.

On the basis of the health care diagnostic results mentioned above, the health care diagnostic systems located in the medical centre 48 and capable of higher level health care diagnostic tests than the on-board health care centre 17c and its expert subassemblies can perform other higher level health care diagnostic tests. The relevant tests can be carried out by the technicians and physicians at the medical centre 48.

On the basis of the test results, the following activities can take place:
In an automatic way, in the form of reports, the medical centre 48 can co-ordinate the health care diagnostic work of the on-board health care centre 17c and its expert subassemblies.
The doctors in the medical centre 48 can provide verbal information and assistance to the user in trouble, to the stewardess and to the crew.
They can provide information to other health care institutions compelled to receive the user in trouble, about the momentary health data of the user.

The system of the health care expert units 48c consists of subassemblies in harmony with the health care diagnostic tests carried out at the medical centre 48. The subassemblies carry out their work on the basis of the health care diagnostic measuring results located in the health care database 48f and received on line, thereby supporting the work of physicians an technicians working in the medical lab 48d. The on-board health care centre 17c determining the task and posting the databases subjects the given static and dynamic databases before posting to signal preprocessing, through digitalised and expert units. This is coordinated by the system programme of the central unit 48a, and is carried out by the system of health care expert units 48c. The optimising of the IT flow of associated databases waiting for the tests is carried out by the IT unit 48b.

On the basis of the results by the health care diagnostic models, the medical centre 48, in view of the diagnostic results of the on-board health care centre 17c and its expert subassemblies, co-ordinates the health care diagnostic work of the on-board health care centre 17c and its expert subassemblies in the form of customised reports. The modelling and generating of the parameter vector coordinating the work of diagnostic procedures operating in the system of the on-board health care centre 17c and its expert subassemblies are carried out by the task-specific procedure system working under the system programme of the central unit 48a , in co-operation with the diagnostic system programme of the related health care expert unit, followed by drawing up an informative report for the physicians and technicians working at the medical lab 48d. The posting of the IT tasks and reports related to the co-ordination is carried out by the central unit 48a . The instructions co-ordinating the work of the on-board health care centre 17cand its expert subassemblies are supplied, by means of the identity code generator 48e, with digital signature. Hence, the correctness of instruction reports received can be repeatedly ensured and controlled.

For those skilled in the art, it is obvious that the embodiments described above may only be considered as examples, and different versions and changes can be designed within the range of protection identified by the claims of the invention Of course, the elements of the control system according to the invention are not to be necessarily implemented as independent units and furthermore on a hardware basis, but their functions may also be performed by a software or by hardware modules implemented on an appropriate computer network. The satellite-based navigation data applied in the inventive control system for example may come from a GPS, GALILEO or GLONASS system. Furthermore, the communication applied in the system can be satellite-based as well as GSM combined telephonic communication.

The control system according to the invention, provided that it is used for traffic control is suitable not only for organising the traffic of aircraft or ships, but also that of trains or other vehicles.

Furthermore, the system and method according to the invention can not only be applied to traffic control but also in all cases when objects are to be controlled on a regional or central level. The objects may include without being limited to, for example manufacturing units and production lines, business departments, (parts of) buildings, or persons, when the plant units, business units, building complexes and groups of persons, respectively, correspond to the regions or zones. In such cases the main control centres can supervise for example plant(s), business organisations, (parts of) settlements, and a larger group of persons, for example the workers of a plant In these cases, the object plans can be, for example, manufacturing/production/process control plans, building-operational plans, and human organisation/health care/lifestyle plans. The plans can be furthermore any plans related to the given objects, for example development or lifecycle plans. Through the application of the system and method according to the invention, an appropriate control and communication suitable for all objects can be implemented with the main control centre and the regional control centres, in view of all necessary circumstances.

In the listed generalities, the units making up the control and communication system and their tasks are logically identical with those determined in the classic traffic control model. It is an important circumstance that the control and communication system handles the following general objects and the associated task system as well as the already discussed traffic control and monitoring task system of tasks, with a transparency among the task systems. Furthermore generalities used by way of example without aiming at being exhaustive shall be described below.

The object centre 2 may carry out the monitoring test and control of the production and logistics processes of manufacturing units and production lines, business departments and (parts of) buildings. In a generalisation related to persons, the object centre 2 may carry out the monitoring investigation and control of the logistic processes associated with the human resources requirement, health requirement and social-societal requirement of persons.

The processing unit 17 is still the central unit of the object centre 2 in the discussed generalities. Its task is to organise the work and IT communication of the units under its supervision, compiling the databases of updating oriented loading operations corresponding to the general versions discussed and the organisation of, as well as the co-ordination of loadings, the diagnostic test of the IT relationship between the object centre 2 and the regional control unit 35, and the performing of traffic situation monitoring tasks integrated into its task system.

The task of the on-board diagnostic unit 17a corresponds in the case of all general objects to the adapted task system of the already discussed unit, i.e. to the technical diagnostic test of the object centre 2 and its subassemblies.

The task of the space-information unit 17b is the space-information modelling of the status space associated with the given object, and furthermore the modelling of the movement of the object in the status space, on the basis of the co-ordinate appearing in the status space, the speed co-ordinate appearing in the status space, as well as the co-ordinate and speed co-ordinate forecasts appearing in the status space. The given task system is implemented on the basis of the static and dynamic route modelling in the status space as well as by relying on the route modification protocol. A status space corresponding to the object, for example in the case of the manufacturing units and production lines, may correspond to the process control status space of production, in the case of business departments the status space of the economic environment of the object, in the case of (parts of) a building the related logistics status space and/or the mechanical status space, and in the case of persons the social and philosophical status space surrounding the individual.

The task system of the on-board health care centre 17c and its expert subassemblies is identical in the discussed generalities with the task systems already described; this carries out the health care check-up of persons in the objects and its control

The task of the satellite-based navigation receiver 18 is to determine the co-ordinate data of the object in the status space on the basis of a measuring process carried out by itself, that is in accordance with an internal measuring process.

The task of the satellite co-ordinate transmitter 20b is to support the external side measurability of the object's status space co-ordinate data, i.e. to support an external measuring process. An external measuring process, according to the default, has a secondary priority, security enhancing role. However, it is important that the external measuring processes can work more efficiently under certain circumstances than the internal measuring processes, therefore they can have a number one priority as well.

The task of the identity code generator 21 in the case of all objects corresponds to the adapted tasks of the unit as discussed above. The applied encrypting algorithms and encrypting levels are adjusted to the object and to the IT and confidentiality system of requirements of the associated status space.

In the case of all objects, the task system of the diagnostic unit 22a corresponds to the adapted task system of the already discussed unit, i.e. its task is to carry out technical/diagnostic tests corresponding to the given object In the case of the general cases listed, for example, in the case of manufacturing units and production lines, this corresponds to a technical diagnostics and/or process control diagnostics, in the case of business departments it corresponds to an economic IT diagnostics, in the case of (parts of) buildings it corresponds to the technical diagnostics and/or logistic process diagnostics and/or mechanical diagnostics and in the case of persons to a health care diagnostics and/psychiatric diagnostics.

The tasks of the autopilot coupling unit 22b, the data acquisition unit 22c and the on-board operator unit 23 correspond in the case of all objects to the adapted tasks of these units.

The autopilot serves for the automatic co-ordination of all objects in the general sense when they move in the associated status spaces and for the external control of it. It is an important circumstance that an object can be associated with more status spaces, where the related process control and supervision tasks are performed in a simultaneous and integrated way by the control and communication system. In the case of manufacturing units/production lines, the autopilot is a regulatory system that ensures external control side process control and/or automated process control and/or logistics process control, in the case of business departments the external control side regulation of the status space movement in the economic environment of the object and/or automated process control and/or logistics process control, and in the case of (parts of) buildings, this means an external control side regulation and/or an automated mechanical process control and/or a logistical process regulation and in the case of persons a health care process regulation and/or psychiatric process regulation and/or a task-related logistics regulation involving the relevant person.

On the level of the IT network, the radio retransmitter unit 3, the retransmitter satellite 7a, the stationary satellite-based transceiver 8, the radio transceiver 19, the satellite radio transceiver 20a and the communication centre 45 provide for IT communication between the object centres 2, the regional control centres 4, the visual processing centres 5, the regional land traffic manager centre 46, the regional information centre 47, the medical centre 48 and the main control centre 12. The design and application of the units included in the IT network are optional and adjusted to the given objects.

The visual processing centre 5 performs the monitoring testing and control of the production and logistics processes of the manufacturing units/production lines, business departments and (arts of) building in a direct way. In an abstraction associated with persons, it performs directly conducted monitoring tests and their control in relation to the tasks comprising the human resources requirement, health care requirement and social-societal requirement of persons.

The visual detector and identifier unit 1 1 and the visual identifier unit I la perform the tracking of changes based on the external side measuring process of the objects moving in the status space and their lifecycle experienced there. Their design and the nature of the parameters sampled by them are adjusted to the nature of the related object and status space.

Regarding the objects discussed, the task system of the visual processing unit 25 is logically identical with the task system discussed above concerning the unit. This co-ordinates the work of subassemblies supervised by it, ensures IT communication between subassemblies, prepares and receives reports from the higher level units of the control and communication system, processes them and then forwards the posted databases and/or commands to the appropriate units.

For the discussed objects, the task system of the diagnostic unit 27 is logically identical with the adapted task system of the unit as described above, i.e. it carries out the technical diagnostic testing of the subassemblies of the visual processing centre 5.

The IT centre 28, in the discussed objects also, carries out the organising and/or optimising of the IT communication between the subassemblies of the visual processing centre 5, and furthermore ensures that the visual processing centre 5 is connected in an IT sense to the IT system of the control and communication system.

The general task of the radar interface unit 29 is to connect the measuring systems associated with the object and already installed or to be fitted later in the control and communication system, said measuring systems are able to do an external side scanning of the status spaces associated with the object and also to determine the position of the object within the status space.

The task of the visual tracking unit 30 in the case of the discussed objects is logically identical with the adapted task system discussed above in connection with the unit. This carries out the control modelling of the tracking of the objects in the status space and/or the modelling of the sampling measuring process relative to the status space object and/or the modelling of the object detection process. In carrying out the relevant task, it can rely on the work of the regional control centre 4 and it can also carry out its function in an autonomous way. In addition, by means of the models handled by it and the regulation signals generated by it, the unit controls tie sampling strategy of the visual detector and identifier unit I 1 and the visual identifier unit 11a performing the sampling of the status space.

Based on the work of the IT connected and priority-wise subordinated object centres 2, the regional control centre 4 performs the monitoring test and the control of the indirect production and logistics processes of the manufacturing units/production lines, business departments or (parts of) buildings. In an embodiment associated with persons, it similarly carries out the monitoring test and supervision of indirect logistics processes associated with the human resources requirement, health care requirement and social-societal requirement tasks of persons.

The task of the regional control unit 35 is logically identical with the adapted task system discussed, i.e. to organise the work and IT communication of the units under its supervision and/or to compile the databases of the updating oriented loadings corresponding to the discussed versions and to organise and co-ordinate the database loading process of the units and objects under its supervision and/or to perform the diagnostic testing of the IT communication between itself and the object centres 2 and/or the units attached to it on an IT basis and the database handling information centres and/or to plan and supervise the regional optimal communication strategy and/or to keep contact with the external and connected IT networks and/or to prepare the visual tracking task and to assign the object centres 2 waiting for visual tracking and/or to prepare and edit the reports, to provide for the IT servicing of the main control centre 12, to assist the proper systems diagnosed by the regional diagnostic unit 35a and to substitute them, to process the primary database intermediated by the data acquisition unit 22c of the object centres 2 and to take over the task system of the faulty or overloaded units of the regional control centres 4 making up the control and communication system on a regional level, where the co-ordination of distribution of the given task is performed by the main control centre 12.

The task of the regional diagnostic unit 35a in the case of all objects corresponds to the adapted task system of the already discussed unit, i.e. on the one hand the technical diagnostic testing of the object centres 2 and its subassemblies integrated into the control and communication system and on the other the technical supervision and diagnostic testing of its own units.

In the case of all objects, the regional database 35b, the event logging unit 35c, the regional identity code generator 35d and the system of tasks of the IT unit 36 correspond to the adapted task system of the units already discussed.

The task of the regional space-information unit 37 in the case of all objects corresponds to the adapted system of tasks of the unit already discussed. The status space types of the objects regionally handled are identical with the status spaces discussed in the generalising of the space-information unit 17b. Its task comprises the updating oriented loading of the space-information database of the regional space-information unit and its handling, the space-information modelling of the system of regional object plans as matched to the objects and/or the dynamic route space-information modelling and planning of the system of regional object plans, and/or editing a report for the updating oriented loading of the space-information database of the object centres 2 of the objects under supervision as matched to the status space of the object and the performing the loadings on a customised basis and/or actually matched to the status space of arbitrary objects under control and communication supervision and/or the report-like posting of the traffic situation of the envisaged object route on a customised basis to the party which has requested the report and/or the regional level matching of the object plans of the objects under control.

On all object abstraction levels, the task of the regional traffic situation monitoring unit 38 corresponds to the adapted system of tasks of the unit already discussed. In the given task system, the regional traffic situation monitoring unit 38 carries out a regional expansion.

The photogrammetric unit 39 can be applied primarily in traffic control and in monitoring tasks; it has a role in processing the visually detectable objects and the associated status spaces.

In addition, the external status monitoring unit 40, the 3D virtual studio 42a and the main control centre 12 and subassemblies can be used appropriately in the case of the given objects.

1. A control and communication system comprising:
an object centre assigned to an object, a control centre in communication contact with the object centre, means for implementing communication between the object centre and the control centre and means providing information for controlling the object to the object centre and/or to the control centre,;
an object space-information database in the object centre, the database storing an object plan for the object, wherein the control of the object is adjusted to the object plan;
a regional control centre assigned to a given zone, the regional control centre having a regional space-information databases storing a regional plan compiled on the basis of the object plans of the objects assigned to the regional control centre;
a main control centre capable of co-ordinating the regional plans, the main control centre being in connection with, as well as organising, the operation of the regional control centres, wherein the main control centre has a central space-information database storing a central plan that covers the zones, and:
means of co-ordinating the regional plans forwarded from the regional control centres to the main control centre, a central plan approved by the regional control centres is prepared by the main control centre, wherein regional plans not requiring central planning are returned by the main control centre to the regional control centres, and the regional plans are updated at the regional control centres on the basis of the returned plans and the central plan, and the object plans are updated at the object centres on the basis of the regional plans.

2. The system according to claim 1, characterised wherein the object space-information database is updated when the object is assigned to the given regional control centre and furthermore regularly automatically on the basis of the regional space-information database.

3. The system according to claim 2, wherein the object centre comprises an operator unit suitable for manually retrieving the regional plans for the regional control centres, thereby updating the object space-information database.

4. The system according to claim 2, comprising one or more radar units, a visual detector and identifier unit or a visual identifier unit suitable for detecting/identifying objects in the zone, which units are controlled on the basis of positioning signals sent by the objects through a visual processing centre.

5. The system according to claim 4, wherein the visual processing centre comprises a visual tracking unit suitable for visual tracking of an appointed object.

6. The system according to claim 2, wherein the means for implementing communication is a retransmitter satellite or a radio retransmitter unit connected to a stationary satellite transceiver.

7. The system according to claim 1, wherein the object space-information database or the regional space-information database comprises information relating to conditions of control, said information being forwarded to the main control centre for co-ordinating the regional plans.

8. The system according to claim 7, wherein the object is a vehicle, and the object plan is a traffic plan, to which the travelling of the vehicle is adjusted, and the means for providing information about the control conditions comprise a regional land traffic manager centre located in the regional control centre as well as a regional information centre collecting information related to traffic and meteorological conditions.

9. The system according to claim 8, wherein the main control centre comprises a control device harmonising the operation of the regional control centres, a central identity code generator enabling the sending of encrypted reports, an IT centre enabling communication, a space-information unit suitable for drawing up the central plan, a traffic situation monitoring unit for observing the actual conditions of traffic and a central database storing technical data of the system.

10. The system according to claim 9, wherein the regional control centre comprises a regional control unit performing regional communication organisation and information processing tasks, a regional database storing regional technical data, an event logging unit, a regional identity code generator enabling the sending of encrypted reports, a regional voice generator, an IT unit enabling communication, a regional space-information unit performing regional traffic control tasks, a regional traffic situation monitoring unit for co-ordinating regional traffic safety tasks, a photogrammetric unit for detecting vehicles not covered by the control of the system, an external status monitoring unit for scanning and identifying vehicles controlled by the system, a satellite-based satellite navigation compensator unit for compensating uncompensated co-ordinate data, an operator unit and a 3D virtual studio for the visual tracking of traffic processes, a regional signal improving unit forwarding signals of positioning satellites to the regional control centre, a regional land traffic manager centre providing information about land traffic conditions, a regional information centre supplying data from external IT networks, and a medical centre co-ordinating regional health care tasks.

11. The system according to claim 10, wherein the object centre is an on-board centre comprising a processing unit carrying out information flow management and co-ordination tasks, an on-board space-information unit performing on-board traffic control functions, an on-board health care centre, an on-board voice generator, a stewardess monitor, a satellite-based navigation receiver or satellite-based navigation antenna, a radio transceiver and a satellite radio transceiver for enabling communication, a satellite co-ordinate transmitter providing information about the actual position, an on-board identity code generator enabling the sending of encrypted reports, an on-board operator unit enabling handling, an on-board telephone exchange having a communication unit, the telephone exchange enabling the use of GSM devices being on-board, an autopilot coupling unit and an on-board data acquisition unit.

12. The system according to claim 1, wherein the main control centre comprises a central diagnostic unit, the regional control centre comprises a regional diagnostic unit that regularly sends diagnostic reports to the central diagnostic unit, and the object centre comprises an object diagnostic unit that sends diagnostic reports on a regular basis to the regional diagnostic unit.

13. The system according to claim 1, wherein the regional control centres are interconnected through a computer network, and at least one part of the main control centre is implemented as a software module accessible on the computer network.

14. The system according to claim 1, wherein the object centres are interconnected through a computer network, and at least one part of the main control centre and the regional control centres is implemented as a software module accessible on the computer network.

15. The system according to claim 11, wherein the object centre, the regional control centre and the main control centre have a time parameter made accurate and uniform by the satellite-based navigation receiver.

16. A control and communication method for objects, wherein each object has an object centre comprising an object plan, and wherein the object plans are collected in a control centre and the control is carried out on the basis of a co-ordination of the plans via a communication contact between the objects and the control centre, the method comprising the steps of;
compiling a regional plan in a regional control centre assigned to a given zone, on the basis of the object plans of the objects assigned to a regional control centre,;
preparing a central plan covering the zones at a main control centre by coordinating the regional plans sent by the regional control centres to the main control centre, wherein the main control centre is capable of organising the operation of the regional control centres, said central plan is prepared on the basis of approvals of the regional control centres;;
updating the regional plans on the basis of the central plan at the regional control centres, updating the object plans on the basis of the regional plans at the object centres and adjusting the control of the objects to the object plan, wherein the approval of the central plan for each zone is implemented in a way that a regional part of the central plan, which is not suitable for the regional control centre, is replanned at the regional control centre, and then the replanned regional plan is forwarded to the main control centre for co-ordination with the other regional plans.

17. The method according to claim 16, wherein plans not requiring central planning are returned from the main control centre to the regional control centres and the regional plans are updated on the basis of the returned plans and the central plans.

18. The method according to claim 17, wherein the object plan is updated when the object is assigned to the given regional control centre and subsequently on a regular basis automatically.

19. The method according to claim 18, wherein by means of an operator unit of the object, the regional plan is retrieved from the regional control centre and thereby the object plan is updated.

20. The method according to claim 16, wherein information relating to planning conditions is collected at the object centre, at the regional control centre or at the main control centre, which information is used in preparing the central plan.

21. The method according to claim 16, wherein regular diagnostic reports are sent from the object centre to the regional control centre and from there regular diagnostic reports are sent to the main control centre and the control is carried out in view of the diagnostic reports.

22. The method according to claim 16, wherein by means of one or more radar unit, visual detector and identifier unit or visual identifier unit capable to detecting/identifying the objects in the zone, the object is visually tracked and monitored, which units are controlled on the basis of positioning signals sent by the objects.

23. The method according to claim 16, wherein the positions of objects are determined primarily by a positioning satellite and by satellite-based navigation receiver located at the object centre, and secondarily by a spotting satellite and by a satellite co-ordinate transmitter located at the object centre.

24. The method according to claim 23, wherein the positions of objects are primarily determined by means of the spotting satellite and the satellite co-ordinate transmitter.
